(19) United States
(12) Patent Application Publication
(10) Pub. No.: US 2012/0233631 A1
(43) Pub. Date: Sep. 13, 2012

(54) Processes and systems for creating and delivering granular idiomorphic media suitable for interstitial channels

(76) Inventor: David M. Geshwind, New York, NY (US)

(21) Appl. No.: 13/374,175

(22) Filed: Dec. 13, 2011

Related U.S. Application Data
(63) Continuation-in-part of application No. 12/930,392, filed on Jan. 4, 2011, now abandoned.
Application No. 12/930,392 is a continuation-in-part of application No. 12/151,146, filed on May 1, 2008, now abandoned.
Application No. 12/151,146 is a continuation-in-part of application No. 11/487,860, filed on Jul. 16, 2006, now abandoned.
Application No. 11/487,860 is a continuation of application No. 09/724,926, filed on Nov. 28, 2000, now Pat. No. 7,080,392.
Application No. 09/724,926 is a continuation-in-part of application No. 08/483,205, filed on Jun. 7, 1995, now Pat. No. 6,507,872.
Application No. 11/487,860 is a continuation-in-part of application No. 09/504,605, filed on Feb. 15, 2000, now abandoned.
Application No. 09/504,605 is a continuation-in-part of application No. 08/485,384, filed on Jun. 7, 1995, now Pat. No. 6,025,882.
Application No. 08/485,384 is a continuation-in-part of application No. 07/800,325, filed on Dec. 2, 1991.
(60) Provisional application No. 61/459,460, filed on Dec. 13, 2010.

(51) Int. Cl. H04N 21/431; H04N 21/2543; H04N 21/80

(52) U.S. Cl. 725/1; 725/32; 725/35

(57) ABSTRACT

Creation or modification of various media to a form that is suitable for delivery (e.g., display) during gaps (generally temporal) in an information display to, or interaction with, a human user. Media is prepared to be granular in nature; consisting of relatively many, relatively small, cognitively separable or stand-alone segments; and, is optionally also customized to user preferences.

### CROSS-REFERENCE TO RELATED APPLICATIONS

This application claims priority from Provisional U.S. Patent Application No. 61/459,460 filed Dec. 13, 2010.

This application is also a continuation-in-part of U.S. patent application Ser. No. 12/930,392 filed Jan. 4, 2011. U.S. patent application Ser. No. 12/930,392 is a continuation-in part of U.S. patent application Ser. No. 12/151,146 filed May 1, 2008.

U.S. Ser. No. 12/151,146 is currently a continuation-in part of U.S. patent application Ser. No. 11/487,860 filed Jul. 16, 2006 which is a continuation of U.S. patent application Ser. No. 09/724,926, filed Nov. 28, 2000 entitled “Process and Device for Multi-Level Television Program Abstraction,” filed Nov. 28, 2000, and issued Jul. 18, 2006 as U.S. Pat. No. 7,080,392, which itself is a continuation-in-part of U.S. patent application Ser. No. 08/483,205, filed Jun. 7, 1995, now issued as U.S. Pat. No. 6,507,872.

The instant application is also related to U.S. patent application Ser. No. 11/487,860 filed Jul. 16, 2006; U.S. patent application Ser. No. 10/341,758, filed Jan. 14, 2003; and, U.S. patent application Ser. No. 09/996,922, filed Oct. 31, 2002. U.S. patent application Ser. No. 11/487,860 is currently a continuation-in-part of U.S. patent application Ser. No. 09/504,605 filed Feb. 15, 2000 which was a continuation-in-part of U.S. patent application Ser. No. 08/485,384 filed Jun. 7, 1995 now issued as U.S. Pat. No. 6,025,882 and U.S. patent application Ser. No. 08/485,385 filed Jun. 7, 1995. U.S. patent application Ser. No. 09/724,926 was also a continuation-in-part of U.S. patent application Ser. No. 07/800,325 filed Dec. 2, 1991. Additional related applications are: U.S. patent application Ser. No. 09/996,922 filed Oct. 1, 2001, U.S. patent application Ser. No. 08/488,222 filed Jun. 7, 1995, and U.S. patent application Ser. No. 492,815 filed May 9, 1983 now issued as patent EU 0144352 B1. Additional related applications are provisional applications 61/283,871 files Dec. 10, 2009, 60/831,943 filed Jul. 18, 2006, 60/927,214 filed May 1, 2007, and 61/066,633 filed Feb. 21, 2008.

All the applications and patents referenced above are the sole invention of the instant inventor, are collectively referred to herein as “parent document(s)” and are hereby incorporated in their entirety by reference.

### COPYRIGHT NOTICE

This patent document contains material which is subject to copyright protection. The entire specification is copyright to applicant. The copyright owner has no objection to the facsimile reproduction by anyone of the patent document or the patent disclosure, as it appears in the Patent and Trademark Office patent file or records, but otherwise reserves all copyright rights whatsoever. In particular, the graphics, designs and text herein, in addition to any patent rights, are also covered by copyright and/or trademark. Permission to copy those materials is solely limited to their use in conjunction with the lawful distribution of this patent document and all other rights, including their publication, adaption, compilation, or other uses are reserved. No such use can be made without the written permission of the copyright holder and cannot be made with proper notice and compensation.

### BACKGROUND OF THE INVENTION

1. Field of the Invention

Generally, the instant invention relates to the creation or modification of various media for delivery and/or display to users.

2. Description of Related Art and Scope of Invention

For almost three decades Microsoft and Intel have functioned in a commercially successful if sometimes dysfunctional (for end users) symbiosis. The dominant computing machine in offices and for ‘personal’ computing is popularly known as a WINTEL machine because it runs some form of Microsoft's Windows operating system on hardware built around some model of Intel's microprocessor chip set—or some alternatively-sourced functional equivalent.

Both Intel and a nascent Microsoft were introduced into this partnership by their participation in the original IBM PC in 1981.

A typical early configuration consisted of an 8088 microprocessor, running at less than 5 MHz; 64 Kilobytes of RAM; mass storage that consisted of a one-sided single-density 5¼ inch floppy disk drive, often of 360 Kilobye capacity, which was capable of holding a bootable version of the DOS (Microsoft's Windows precursor) operating system and/or many entire applications; a monochrome (80 characters×25 lines) or 16-color (640 H×200 V pixels) monitor display; and, via third-party option, a 300 bits per second modem (equivalent to about 30 typewritten characters per second, not very different than human reading speed, and excruciatingly slow even for small low-resolution B&W graphics). All this was available at a price in the range of $3,000. Delays to boot such systems, launch applications, load/save files, and especially to up/download files via the modem, could take a minute or many minutes, with the user waiting for the generally single-threaded computer to again become available for user interaction. Nevertheless, the manner in which such systems operated was perceived of as extremely useful, fast and efficient compared to most other alternatives available at that time and price.

A typical contemporary configuration consists of an advanced multi-processor Intel chip (such as Core 2 or Core i5 with 2 or 4 core processors, with 4 or 8 MB cache), running in the neighborhood of 3 GHz; 2-8 Gigaytes of RAM; mass fixed storage in the Terabyte range, with removable optical storage in the Gigabyte range (with operating systems and applications nevertheless requiring multiple optical disks for delivery); a full-24-bit-color HDTV-resolution or better display; and, wired and wireless communication in the 10 Megabit per second range and up (capable of downloading an hour of video in about 20 minutes; or ‘streaming’ high-resolution moving color images and multimedia in real time). All this is available at a price in the range of less than $1,000 (and up). Delays to boot such systems, launch applications, load/save files, can still approach or exceed a minute, but can also be a matter of a few seconds; although up/download files via a network is at the mercy of server, information provider, and network delays, even if the local computer is up to the task. Even with multi-threaded, multi-windowed operating systems, the user often waits for the computer to again become available for the desired user interaction. However, delays of even a few seconds are now considered by many to be unacceptably frustrating.

Many programs and utilities currently exist that ‘get between’ the operating system and application programs, and/or monitor system operation. For example, some programs will trap the default cursor display and replace the usual arrow or hour glass with a different image. Other programs monitor the copy (often control-C) function and, if the text copied (or cut) is a URL, will pass the request on to a program that manages downloads. Other system programs, like the Windows task manager, monitor, prioritize, stop, or otherwise control the operation of a multiplicity of application programs, tasks or, even more basic, individual computing processes.

Other programs, such as web browsers, up/download and monitor web pages, images, videos and other media and web page components; and, often, display a progress bar, based on, and/or indicating to the user, some combination of the size of the file (which is not always available to the downloading program), the speed it is being downloaded, the percentage or absolute amount downloaded, and the expected time remaining to completion. Similarly, other programs monitor and/or display progress loading/saving or otherwise operating on data files.

Artificially intelligent programs and algorithms exist which are capable of monitoring system or user behavior, and ‘learning’ or adapting operation, based on a database of history and other information.

Those who practice the instant invention are those familiar with, and skilled in, arts such as: electrical, electronic, systems, computer, digital, communications (e.g., digital and analog communications network, telephone, audio, video, radio, television, broadcast, cable, etc.) and other related hardware and software engineering and/or design disciplines; computer science and software engineering; media technology; production, programming and editing of computer media, interactive media, multimedia, computer graphics and animation, video, audio and other media; interactive media and human interface design or HCl; artificial intelligence, neural networks, expert systems, fuzzy logic, etc.; image processing, sound processing, speech recognition and pattern recognition, etc; and other appropriate disciplines. Nevertheless, the inventive matter does not constitute these arts in and of themselves, and the details of these arts are within the public domain and the ken of those skilled in the arts.

The instant disclosure will not dwell on the details of system implementation as they relate to such arts in and of themselves but will, instead, focus on the novel designs of: systems, data structures, interfaces, processes, functions and program flows, etc., and the novel purposes for which these are utilized.

The instant application relies on the existence of well-known systems and components including, but not limited to: personal and other computers (and smart phones, PDAs, netbooks, eBook readers, and other mobile computing devices), and the system, development, and application software available for them; multimedia systems; systems used for the production and broadcasting, cablecasting, satellite delivery, or other means of distribution and/or delivery of analog and digital media including electronic text and graphics, radio/audio, television/video, multimedia and interactive media; the use of VBI, SAP and other optionally ‘piggybacked’ and/or synchronized signals; delivery of information via communications networks, including the internet, telephone and mobile broadband, broadcast, cablecast and satellite; delivery, and/or storage or recording on optical, magnetic and/or other information bearing media, of analog and digital signals, including computer, video and other media and information; settop boxes, advanced, digital and HDTV televisions, multimedia computers, and other consumer electronic devices including TiVo, Replay, the V-Chip, etc.; professional and home Intercast (VBI insertion/detection) equipment; digital video library and other multimedia access and search systems; and, other related devices and technologies; pop-up windows and similar adjunct displays, for presenting system information, help information, definitions, advertisements, etc., comprising text, graphics, audio/videos, interactivity, etc., keyed to file names, key words, links or otherwise, or even unbidden; and, those which may be substituted for, and/or combined with, any of the above; and/or will incorporate, combine or substitute new and/or modified versions of any such elements later developed. In fact, consumer devices now available, such as personal computers, smart phones, and other mobile digital devices, with little to no modification, provide all the necessary elements, except some additional software control functions, control programming, and appropriate content, to perform many of the embodiments as described herein; and, the necessary modifications and/or additions are within those skilled in the appropriate arts.

The intended scope of the instant invention also includes the combination with, or substitution by, other related technologies, now in existence or later developed, which may be combined with, or substituted for, elements of the instant invention.

### BRIEF DESCRIPTION OF DRAWINGS

FIG. 1 depicts the archetypal journalistic pyramidal story structure.

FIG. 2 depicts an example of ideomorphic media tailored to user interest.

FIG. 3 depicts media tailored to delay length.

FIG. 4, top, depicts an interactive media display; and, bottom, depicts an example of ‘string of beads’ granular video media with grain boundaries.

FIG. 5 depicts a text example of ‘string of beads’ granular media with grain boundaries—as text for interactive display or, in alternative embodiment, audio.

FIG. 6 depicts some example methods for encoding grain boundary information.

FIG. 7 depicts media display compared to system delay and, in particular, set-up/pay-off.

FIG. 8 depicts an example of algorithmic generation of granular content.

FIG. 9 depicts granular content with recaps.

FIG. 10 depicts amortized human effort and computer processing to produce idiomorphic and/or granular content and/or advertising.

FIG. 11 depicts typical handling of user information with respect to third parties.

FIG. 12 depicts alternative handling of user information with respect to third parties to enable secure and anonymous information exchange between end user and third party.

FIG. 13 depicts exchange of information between inventive service bureau, advertising client and end user.

FIG. 14 depicts a flow chart of granular operation in relation to system delay.

FIG. 15 depicts a system diagram of granular operation in relation to system delay.

FIG. 16 depicts embodiments of granular media player.

FIG. 17 depicts embodiments of granular meta-controller program.

FIG. 18 depicts additional, optional, functions of a granular control program.

FIG. 19 depicts a multi-user encryption/decryption scheme to reduce overhead.

FIG. 20 depicts an example of a multi-media pop-up window.

FIG. 21 depicts example pop-ups illustrating multiple uses, media and platforms.

FIG. 22 depicts the distribution of media via interstitial channels.

FIG. 23 depicts granularization of a pyramidally structured document.

FIG. 24 depicts granularization of email, tweet and personal information.

FIG. 25 depicts components of meta-media.

FIG. 26 depicts a diagram of social editing process for audience identification and media refinement.

### GENERAL DISCUSSION

Several of the major concepts in the instant invention have already been disclosed and taught in parent applications and/or patents. These include media that has been ‘abstracted’—including techniques of generating and/or associating with media, edit information and/or media segment tagging information for content, user interest or otherwise—for purposes including the optional presentation of alternative versions of media relating to content, user interest, time issues, or otherwise; and media and/or advertising that is ‘idiomorphic’ and has, thus, been selected and/or abstracted to coincide with the likely preferences of a particular user or group. The instant invention, in part, relates to the application of these and other techniques, including human/computer collaboration when performing such tasks, to provide media that has been optionally further processed, for example by granularization, for presentation via communication channels or information display opportunities which are ‘interstitial’ in nature. Such interstitial, agglutinatable or aggregatable opportunities include, for example periods of delay in computer operation, or network lag.

Further, the instant invention enables what amounts to an entirely new medium. By addressing a long-standing problem with a counter-intuitive solution, a business based on this technology will capture a completely untapped audience, equivalent—in the number of saleable advertising impressions—to 20 or more hours of top-rated prime-time television each and every day.

Such a business will provide a soon-to-become-indispensable service to virtually all Windows PC, Apple PC, Unix/Linux and other computer and/or operating system users; and, can also be migrated to users of smart phones and other mobile broadband devices (netbooks, iPads, iPod touches, eBook readers, etc.).

As industry giant INTEL points out in a recent study, “41 percent of adults said they are waiting for the computer to catch up with them and they are stressing out while waiting . . . that so-called Hourglass Syndrome is a collective term for the frustration that stressed computer users are facing as they watch the little hourglass spin while waiting for the program to open or a website to load . . . [and that t]he average computer user spends about 13 minutes per day waiting for their technology to catch up to them.”

While Intel promotes the buying of a new computer equipped with their new faster processor as the solution, the approach of the instant invention is to take advantage of these inevitable glitches (estimated to be between 40 and 100 per day, per user). The technology actually makes use of the delays by providing users with something engaging and relaxing to do during these pauses in productivity of a few seconds to a number of minutes.

In one embodiment, this potentially ubiquitous service will be offered free-of-charge to the public. Patented and patent-pending technology (see parent patents and applications) enables the service to take steps to make content individualized and uniquely personalized—a combination that will soon become well-loved to the public, and fully embedded in daily digital life.

However—like newspapers, radio, broadcast television, and Google before—this service will support itself by piggybacking paid advertising on the free content. Unlike those others, the advertising will be welcome. The same technology used to create custom content will also permit the delivery of advertising that the user will be interested in knowing about. A slogan descriptive of the customized content and advertising under consideration is:

### WE PROVIDE YOU WITH EVERYTHING YOU WANT—AND NOTHING ELSE (MORE).^{SM}

Advertising clients—the paying customers—will also receive a unique product. The inventive service will provide advertising that is micro-finely targeted, on an individual scale—something neither traditional media nor even Google can provide. Unlike Google or other internet-based ads, which are often crowded as many as 10 or more to a screen, these ads will capture the undivided attention of users. The ads will interactively offer incentives to those who are interested; and, will enable one-click electronic commerce. This package of features is the holy grail for advertisers—as if your television remote had a ‘buy it now’ button.^{SM} As such, these impressions will be more desirable to advertisers than print or television or standard internet impressions and, thus, will bring in higher fees, per impression, to any venture utilizing the instant technology.

Reasonable and conservative projections for income result in startling figures. Nevertheless, even if such projections overestimate by a factor of 10 the size of the expected audience, and overestimate by a factor of five the price the advertising service will command, such a venture will be taking in quite amazing revenues annually (with a wide profit margin) within a relatively short period.

Although it is expected that such a venture would experience exponential early growth, infrastructure and staffing will require only modest expansion. Increases in the customer base require only incremental increases in many budget items. Like a newspaper: once editorial staff and presses are in place, doubling circulation requires only buying more newsprint and hiring more trucks to deliver papers. While advertising income grows with circulation, major fixed costs do not.

Also unlike traditional media and Google, such a service will be protected from competition by patents (issued, pending, and in process). The patent protection also provides many benefits when planning an exit strategy.

This invention comprises an entirely new medium—or, at least, an entirely new untapped channel. In an age where audiences have become fragmented not only by five networks; not only by scores of cable channels; not only by TiVo and video-on-demand; but by, DVDs, Blueray, video games, mobile broadband and, especially, The Internet; the instant invention deals with an audience that is fragmented in an entirely new way.

The audience for the instant invention will be a mass audience, far larger than the most successful television networks. But that audience will be fragmented. They will be present for 20 seconds here, a minute there—during a commute on their smart phone, during work on their desktop, at home on their laptop.

Yet, that is just when and where they will need this service: whenever their computer freezes, on whatever machine they are using, for as long as it takes—and no longer. The instant invention will fill those awkward gaps without getting in the way. Turn those frustrating delays into engaging breaks. It will provide end-users with individually personalized programming they will love, and advertising that will also be welcome because it is also individualized and personal.

While Intel proposes that the user buys their faster computers to eliminate delays (the impossible dream) the instant invention instead takes the counterintuitive approach and makes lemonade from the inevitable delays of our lives.^{SM}

Based on Intel's own research, there is a captive audience that is equivalent to tens of hours of top-25 prime time television every day, in terms of impressions delivered—and even more in terms of effective impressions. The instant invention will provide to them a soon-to-become invaluable and ubiquitous service.

At the same time, other elements of the technology will provide, to the paying advertising customers, ultra-finely-targeted, interactive incentive, advertising, with built-in, one-click electronic commerce. Advertising impressions that are more cost effective—and far more effective, period—than with traditional media, and even than with other new media. And, thus, far more valuable, and which will, in turn, bring in truly astounding ad revenues if managed with appropriate business methods.

One appropriate approach is to adopt the ‘Google paradigm’ offering a (soon-to-be) indispensable ubiquitous service to the entire world of computer users—offer it for free—and support the business via paid advertising.

Like Twitter or Facebook, one can expect near exponential early growth with a new and useful digital service. Yet, such an operation will need only relatively modest increases in infrastructure and staff to support such growth. Such an operation will soon be capable of self-sufficient operation and able to self-finance growth.

### The Problem

For almost three decades INTEL and MICROSOFT have played a cooperative game of leapfrog that has, ostensibly, benefitted the public but—more directly—has benefitted these two computer industry giants.

The IBM-PC and its progeny have, far beyond all others, become the standard for home and business computing, with the combination of Microsoft's Windows operating system running on an Intel microprocessor being dubbed the Wintel machine.

Every few of years Intel releases a new, faster, more capable processor chip set to speed up computing for end-users, and eliminate frustrating delays. In response, Microsoft releases a more fully featured operating system that not only takes advantage of this increased computing power, but goes beyond to create a new generation of performance delays. (It is almost as if they were conspiring to make it necessary to buy new Intel processors and update to new versions of Windows with a viscous cycle of planned obsolescence.)

Recently, Intel has highlighted this problem with a just slightly tongue-in-cheek advertising campaign based on an entirely serious study of a very real problem. REUTERS news service reported on the study this past April 9:

Reuters

[symbol]

### Stressed by Slot Computers? You are not Alone

### Fri Apr. 9, 2010 11:01am EDT

NEW YORK (Reuters Life!)—Stressed by waiting for your computer to update information or download photos, music or videos? You could be suffering from Hourglass Syndrome.

A survey commissioned by Intel shows that 66 percent of computer users are at least somewhat stressed by slow-poke technology and 23 percent described themselves as very or extremely stressed.

“We found that 41 percent of adults said they are waiting for the computer to catch up with them and they are stressing out while waiting,” said Agnes Kwan, of Intel which develops processor technology, said [sic] referring to survey results.

Kwan added that so-called Hourglass Syndrome is a collective term for the frustration that stressed computer users are facing as they watch the little hourglass spin while waiting for the program to open or a website to load.

“In an extreme case, four percent of users said they had to wait one to three hours for the computer to catch up with them. (1) During that wait it would create stress for them if they have limited time to do the task,” she added. 1. It is unclear as to whether this is “one to three hours” per incident or, more likely, per day.

With the advent of Facebook and Twitter, as well as video and music websites, consumers are using computers for many more applications than they did just a few years ago. Some aging computers cannot keep pace as quickly as their owners would like, leading to stress and frustration.

The findings are based on a Harris poll for Intel of 2,315 people in the United States. The average computer user spends about 13 minutes per day waiting for their technology to catch up to them, which equates to up to three days a year just waiting, according to Intel.

(Reporting by Patricia Reaney, editing by Paul Casciato)

Intel's most recent advertising campaign cites this study to suggest that buying a new computer, containing one of their new generation of faster processor chips, is the answer to such delays. However, Microsoft has already announced a new operating system, “Windows 7” that is certain to include new features and programs (Internet Explorer, Microsoft Media Player, etc.) that not only use, but use up that new processor speed. Other application program companies (WordPerfect, Corel, Firefox, Adobe, AOL, etc.) will also come out with new versions that work ‘better’ but use more power. And, users more and more often demand that WINDOWS runs many programs at once, and that each program (web browsers in particular) keep many windows, tabs, files or documents open at once.

All of this is certain to make computer delays a part of life no matter how fast computer chips become. Just as certainly as music and video files have caused us to need first megabyte drives, then gigabyte drives, and recently terabyte drives. Whatever disk space and processing speed are provided to end-users, they always find ways to need more.

Even if local computer delays were not a problem, more and more of computing takes place over the Internet and via other networks. Delays due to network lag, and slow server computers at the ‘other’ end, are not under control of the end-user and cannot be overcome by faster computers at the client (user's) end. Whenever users surf the net, or use mobile broadband devices, they are frequently faced with delays waiting for web pages, videos and other media to arrive and/or for blocking ads to play out before they can have access to the content they want.

In addition, while Intel has brought attention to the problem as it relates to Windows machines, the problem is more or less present with machines running Apple, Unix/Linux and other operating systems (especially the network delays); and, even more so with smart phones and other mobile broadband devices (netbooks, iPod touches, iPads, eBook readers, etc.).

Taking all these machines into account there are perhaps 600 million such computing devices (representing 240 million individual users, many of whom own more than one such device) in the US alone. Of those 240 million, a substantial portion will likely become daily users of this service in the US; with perhaps four times that many beyond that worldwide.

While Intel wants us to believe that ever faster computers are the solution to an ever growing problem, the instant invention takes a different approach.

### The Solution

An earlier patent of this inventor related to making productive use of computer and/or network time while a user was otherwise engaged. The instant invention relates to making productive use of user time during periods when the computer and/or network is otherwise engaged and not available to the user.

While Intel wants you to buy a new machine, with a new faster Intel chip, to eliminate delays while working with your computer, the instant invention takes a counter-intuitive approach.

Intel's solution is only temporary in that new more fully featured application software, and new richer online media, will only serve to use up whatever additional speed Intel's new processors provide, requiring you to buy yet another new computer in a few years. And a new machine will do nothing to alleviate non-local delays while working online, via the internet and other networks.

Such delays are here to stay; and, the instant invention deals with the delays instead of trying to fruitlessly chase after them, like chasing after pests with stronger and stronger pesticides.

These delays, of anywhere from a few seconds to a minute or more, are not necessarily much of a problem except that they are perceived as a problem and frustrate users. The frustration, far more than the actual delay, is what upsets users and interferes with productivity and calm. A brief break now and then would actually be relaxing if only it could be perceived as a break from work instead of a blockage.

It is an object of the instant invention to offer a free media player program (in a business model not unlike the free .PDF reader from Adobe, or the free web browser from Firefox, or the free email programs from AOL, Google and the like) which can be easily downloaded and installed by any Windows user. (Other versions will be available for Apple and Unix/Linux users; and, for users of smart phones and other mobile broadband devices.)

This player program will reside below the surface, hidden, watching for when the system or application blocks out the user and displays the dreaded “hourglass” (or Apple “spinning pinwheel of doom” or equivalent on other systems, or in other delaying circumstances), or displays a progress bar. By monitoring user history and system behavior, our player will (often, but not always) be able to predict, with fair accuracy, how long a delay will be—anywhere from a few seconds to several minutes or more.

Stored on the user's system will be a library of brief programs—again ranging from 10 seconds or less to several minutes or more—which will optionally be pre-selected for each individual user based on their individual preferences for subject (technology, health, news, sports, arts and media, culture, comedy, literature, etc.) medium (text, image, audio, video) and other elements such as demographics (age, gender, income, political leanings, etc.), system configuration, etc.

Each time the system would show the annoying hourglass (or the equivalent, or a progress bar or similar condition, or otherwise be engaged in any delay of user/computer interaction, with or without visible indication) indicating a system delay, our player will, instead (or in addition to), pop up and display a short entertaining or informative “program bite.” These will optionally comprise for example, without limitation:
One (or more, depending on how long the system delay lasts) jokes from a late night comic's monologue.
One (or more, depending on how long the system delay lasts) news headline (downloaded and stored as background operations, while the user and system are performing other tasks).
The latest sports scores for the teams the user is specifically interested in (again, up to the minute, downloaded and stored as background operation, while the user and system are performing other tasks).
Short feature items, again selected based on the specific user's interests. These can range from hi-tech, to celebrity gossip, to life-style and entertaining, to child care, to extreme sports, to music, films, books, etc.
Short quiz questions. For example, a content partnership with Jeopardy! would permit us to offer answers/questions to the users; and, such a feature would be easily adjusted time-wise, asking question after question (or, in the case of Jeopardy! providing answer after answer) until the delay has ended.
A brief excerpt from an audio book, which is doled out in short segments during each system delay.
Or, even something productive, such as displaying and optionally permitting a reply to a recent email message.
Etc.

The possibilities are almost endless, turning dreaded delays into eagerly anticipated rewards for the user. And, since these breaks are short, well controlled, and use up what would otherwise be wasted time, employers (or the workaholic self-employed) will not mind (or even welcome) the taking of such mini breaks, as they do mind employees browsing the internet or playing video games while at work.

If a delay continues beyond the end of one “program bite” additional short programs are optionally concatenated until the delay is ended or some maximum limit is reached.

In an alternative embodiment, our ‘player’ will comprise a special browser, or add-on to, or plug-in for, a standard browser; and, the delays addressed will specifically (optionally, in addition to ‘hourglass’ type delays) be delays in web resources downloading. After the user clicks on a link, and a page (or other resource, such as a video) is downloading, while the user is waiting to see the requested information, a page (or other media resource) already downloaded or otherwise present on the system will be displayed, and comprise the content and/or advertising of the instant product/service. With updated or rich media pages, delays will optionally happen even after a page appears to have been completed. For example, elements of content (or advertisements) are ‘pushed’ or updated; or, a video, Flash movie, or other media may pause during playback while additional data is downloaded.

A truly unique element of this new service is that it is active and intelligent from the computer side, and requires no effort or thought on the part of the user.

Any typical user might, on any given day, visit www.nytimes.com for general news headlines, www.tmz.com for celebrity gossip, www.cnet.com for technology news, www.thebestgardeninginfo.com for gardening tips, www.nbc.com for Jay Leno's monologue, www.youtube.com for short viral videos, etc.

And, there is nothing to say that such a typical user will not continue to do so, say during a lunch break at work, or via iPhone on the commute home.

However, during the odd 20 second or 1 minute delay, caused by a network lag, or a database search, there is not the time to take such a detour. There is not the time to open a browser window, visit such a site, wait for ads to load, and find the item of interest. (Which will be exacerbated by network delay.) Nor, is it likely that the typical over-stressed user will even be able to put aside the mild frustration of the computer stalling, and focus on trying to make use of this unexpected unproductive moment.

Further frustration happens when, before the user finishes with the diversion, the hourglass disappears and it is time to return to the productive task at hand. Alternatively, the user becomes involved in the diversion, and minutes or longer pass while productivity suffers. This is exactly why many employers disable web browsing and other applications from work systems.

In contrast, our system contains a wealth of informative, entertaining media tidbits, pre-selected to be of interest to this particular user, and pre-measured to approximately fit the kind of system delay anticipated.

There is no cognitive load, no effort of any kind, required by the user.

The user makes a database query, for example. Then, instead of encountering a frustrating hourglass, the computer automatically presents the user with: an update of a baseball score, a monologue joke, an alert to a new book or film of interest, a news headline, etc. The brief diversion over, the user is presented with the computer again in a state ready for productivity. It is acknowledged that for certain users, or certain job types, the particular type of diversions offered will be selected to be less distracting. And for some, this service will not be deemed useful at all.

### A Product for End-Users

In addition to programming and distributing—free of charge—one or more specialized media players, browsers or other programs, the invention also addresses being in the media production business—or, optionally, the media re-purposing, editing and reformatting business.

Working with a myriad of media sources, media product will generally comprise, daily, thousands of short ‘media bites’ running from a few seconds to several minutes or more; and, especially, programs that can be cogently run for an arbitrary length of time and then cut as needed at (for example) 10, 20, 30, 40, 50, 60, 70, 80 or 90 seconds without confusion to the user. For example, a series of jokes from Jay Leno's or David Letterman's monologue can be stopped after 1, 2, 3, 4 or more jokes to fill a delay of an unknown length, when the system cannot predict with reasonable accuracy the expected length of the delay.

These sources will, optionally, without limitation, include:
Sources of general news (The New York Times, ABC, Reuters, etc.); celebrity gossip (e.g., TMZ); technology news (e.g., CNET); sports (e.g., ESPN); finance (e.g., CNBC); arts and entertainment (e.g., Rolling Stone); etc., etc., etc.: from print, radio, television and the Internet.
Sources of features from radio (e.g., NPR) television (e.g., documentary programs such as NOVA on PBS) and print (e.g., a myriad of specialty magazines, from Field and Stream, to Oprah, to the Economist); the Internet; etc.
Sources of entertainment, including late night talk shows (e.g., Leno, Letterman, Ferguson, Kimmel, Fallon, The Daily Show, The Colbert Report, etc.); film and television clips, promos, trailers and reviews; news/opinion shows on FOX, CNN, etc.; game shows such as Jeopardy! Wheel of Fortune, etc.; and so on.
Sources of short video entertainments and viral videos such as YouTube.
Sources of audio books and other materials that may be re-formatted into short segments that can be sequentially delivered during a series of breaks.
Etc.
   These items will be reviewed and edited by our staff and marked and/or edited for length; and/or are marked with content description tags and/or edited for diverse user interest. (See the related patents and applications for details, here and throughout the instant application.)

Optionally, a ‘user interest file’ for each user will be kept on our system (or theirs) and, by matching user interest to the content description tags, from the many thousands of items produced each day (or at some other interval more or less frequent or regular), a few score (more or less) of particular interest to a particular user will be sent to that user. Delivery will generally be via the internet to the user's system as a background job that will not interfere with productive work. This library of clips can also be delivered as an email; via the web; or even as a huge library on a CD or DVD (although, not necessarily with recent news headlines or other topical material), to those who are not generally connected to the internet on a regular basis, or to organizations (e.g., offices, schools, ISPs, etc.).

Then, when the system would normally display the hourglass (or a browser or other program, would display a progress bar, etc.), our player (or browser or other program) will pop up. Based on what program is causing the delay, what task it is performing, the size of a file being downloaded, etc., the player program will predict the length of the delay and, instead of the user just having the hourglass to watch, will provide the user with a text, graphic, audio and/or video program of the expected appropriate length, and whose content is selected to match the user's preference profile.

Alternatively, the user will be able to select a ‘channel’ of programming at any time. For example: sports highlights, news headlines, comedy, film/TV, quiz questions, etc. Or, the user will be able to create a custom mix of types of programming (e.g., 25% sports, 25% headlines, 50% comedy).

The user will not only not be frustrated by the delay, they will be engaged and refreshed by an interesting and/or entertaining bit of programming. They will then be ready to return to productive work better for the experience.

Thus, a provisionally apt trade name for such a venture is CTL+ALT+DELAY.™ {2}2. Ctl+Alt+Del (pronounced control-alt-delete) is the well known ultimate expression of a Windows user's frustration—the three-key combination that re-boots a permanently delayed, or frozen, WinTel machine. On the other hand to take control of your digital life and provide an alternative to frustrating system delays, we offer CTL+ALT+DELAY (pronounced control-alt-delay). Sounds familiar, but signals the solution to frustration, not the capitulation to it. So that is the name, at least until we can think of something catchier.

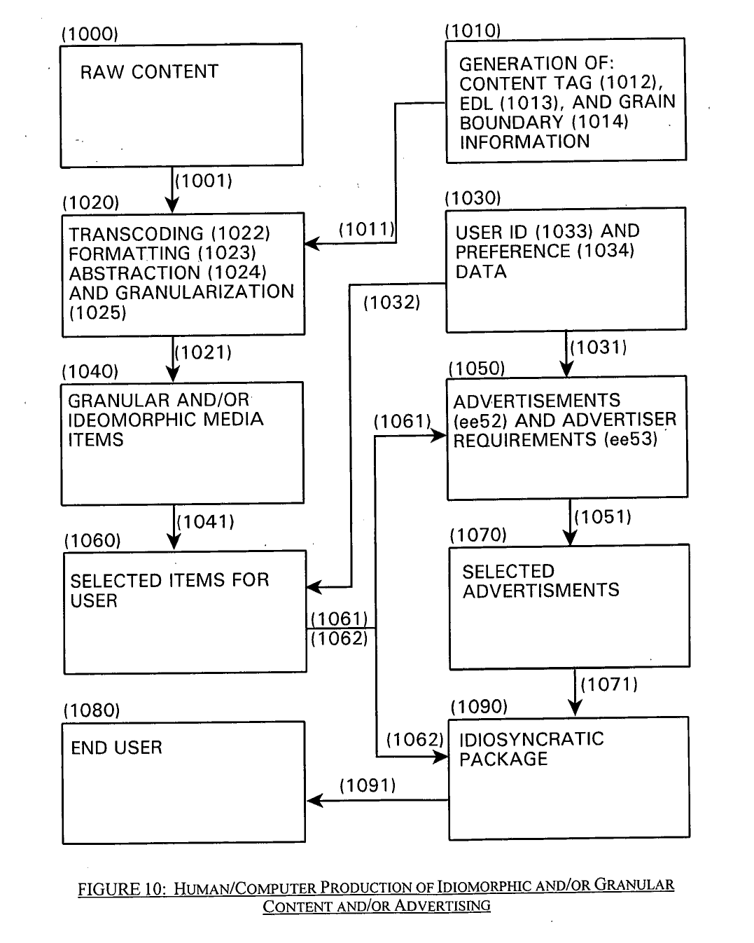

Reformatting and tagging these ‘program bites’ will not be cost free. But, by combining human intelligence in the editing and tagging process, with the highly cost effective operation of computers to do the matching between such tags and user interest profiles, we can provide custom programming to each of thousands of end-users for a tiny fraction of the cost of providing the same service to one customer at time. See, for example, FIG. 10.

If such a service achieves only a small fraction of the anticipated userbase; and spends only one cent on each of those users; it will have a substantial budget each day to collect and/or edit a large number of short text, graphic, audio and/or video segments. An entirely affordable job. Further, due to the technology and logistics of production, as the customer base grows exponentially, production costs will grow only modestly.

The advertising income resulting from exploiting this entirely new entirely captive audience are astounding compared to the costs of production.

### Business Model, Methods and Strategy

Companies like Microsoft and Corel/WordPerfect sell product to end-users outright. Adobe, taking a middle ground, gives away their .PDF reader, in order to boost sales of their professional .PDF publishing programs and licenses.

On the other hand, Google (and their subsidiary YouTube)—like radio and broadcast television before them—give their product away to the public in exchange for advertising revenue. That is the business model and method that will, optionally, be applied to the instant invention.

Google makes tens of billions of dollars a year in advertising revenues by placing ads in their search engine product. Their service has become ubiquitous—even without basic patent protection—even with competition from Yahoo, Microsoft Bing, and dozens of other search engines. Almost everyone using a computer uses Google almost every day.

The instant invention will enable a service that could easily become as ubiquitous as Google. However, there are advantages available with the instant invention compared to Google's business.
1. Google requires a gargantuan infrastructure of computers and networking, and staff, to deliver their service. The instant service will require far less in the way of both infrastructure and staff. It can start quite small and grow to a size that is just a small fraction of Google to deliver a product to hundreds of millions of users. Thus, such a new business can be established and grow with a relatively small amount of initial capital.
2. Almost everyone using a computer uses Google almost every day. But, users have to be online, and have to make a choice to go to Google. Once a user chooses to use the service based on the instant invention, the player (or other program or feature) will pop-up—completely passively and transparently for the user—dozens of times each day. Any time the computer ‘stalls’ with a processing or network delay.
INTEL's own research says that the average user of a computer equipped with one of their processors and some version of Windows suffers 13 minutes of delays per day. Under an assumption that the average delay will be less than 20 seconds, there will be more than 40 such delays—perhaps 100 or more—each and every day for each and every user. The inventive service will provide to the user, for many or all of these delays, an entertaining and/or informative diversion. And, with each of these 40 or 100 tiny content programs, we will piggy-back an advertising impression as well. This ‘captive-but-satisfied audience’ represents the equivalent of dozens of hours of hit prime time network television, each and every day.
3. Google's ads are tied to what the user is searching for with Google's search engine, but the ads are not truly tied to who the user is or what the user likes. Because the users of the instant service will tell the service about themselves, and about their likes and dislikes, in order for the service to deliver to them content that they will enjoy, the service will know who the users are and what their interests are! The service will, thus, be able to deliver micro-finely targeted advertising on behalf of their advertising customers (the paying clients of the service); advertising impressions that will hold the attention of users; and, advertisements that provide interactive digital commerce as well. That is the holy grail of advertising and neither print, nor radio, nor television, nor even Google provides it. However, the instant service will.

### A Product for Advertising Customers

It is possible, for example, for a user to have open both Photoshop and MSWord at the same time; and, when Photoshop delays, for example, while loading or saving a large image file, the user can switch focus to the word processor and add a few more words to their great American novel. However, this not a particularly efficient use of human time or cognitive resources, with delays of unpredictable length, frequency and occurrence being ill suited to such human multi-tasking, and both projects are likely to suffer. This is not even to mention the psychic distress caused the user by having to multi-task as a way to compensate for a computer system not able to keep up with human demands. The delays thereby caused are often too short to make productive use of, yet too long to experience without frustration.

The core of the consumer business enabled by the instant invention is to supply engaging, informative and/or entertaining tidbits, to fill frustrating functionality gaps when using a computer. This is particularly utile for gaps that are too short to accomplish anything else productive; because, by the time you can engage in another task (even if your stalled computer does not block you from doing so, or the launching of another application is not required) it is time to return to the primary task.

The core of the advertising business enabled by the instant invention is to supply micro-finely targeted, interactive incentive-based advertising, with built-in one-click electronic commerce—the holy grail for advertisers. It is as if your TV remote control had a ‘buy it now’ button.^{SM}

Print ads (at about 1.8¢ per impression according to some sources) or television ads (at about 3.3¢ per impression according to some sources) are deceptively expensive, inefficient and ineffective. (An advertising impression is one advertisement seen by one person.)

If an advertisement is seen by 8 million television viewers at a cost of 3.3¢ per viewer, the advertiser is paying $264,000 dollars. However, if the advertisement is for tampons, for example, half of the viewing audience may be male and their impressions are wasted. Another 10% of the audience may be girls under 12 years old and, although potential future customers, not present potential customers. Similarly, another 15% of the audience may be women over the age of 60, again not potential customers. Thus, the real cost of the advertisement per effective impression to a real potential customer is actually 13.2¢—four times as much.

Additionally, although the impression is made, when the potential customer is in the store shopping, perhaps several days later, will she remember the ‘new and improved’ features extolled in the commercial? Likely not. Such a too-long-delayed impression is not only expensive, but wasted.

On the other hand the inventive service knows who its customers are. They have told the service who they are, and what they like—in complete confidence—so that the service can supply them with the content they really want.

So, if an advertiser wants to target females, aged 13-55, the service can deliver females 13-55 and nothing else. Every impression is an effective impression. Even at, for example, 5¢ per effective impression, advertising provided by the inventive service would be far more cost effective than at 3.3¢ but with an actual cost of 13.2¢. While the exact figures for media impression costs vary depending upon what information source is consulted, and from month to month as the media business goes through convulsions, the principle still applies. Advertisers want real customers paying focused attention to their message—and the inventive service can actually deliver that.

As to the second issue—‘Will the customer remember?’—some narrative examples will illustrate, without limitation:

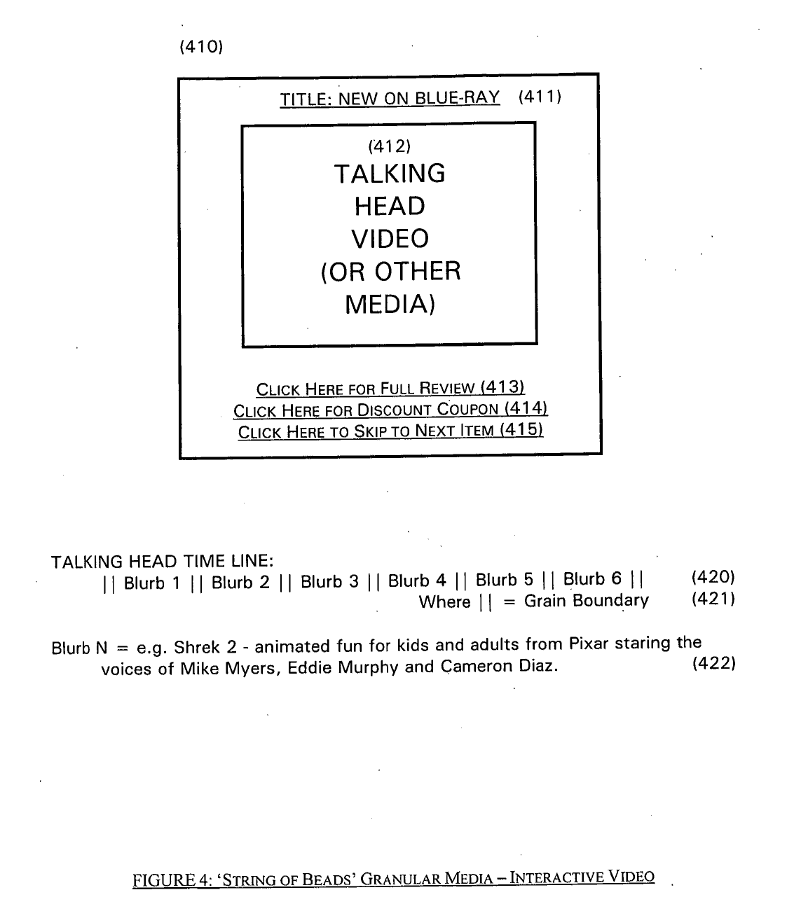

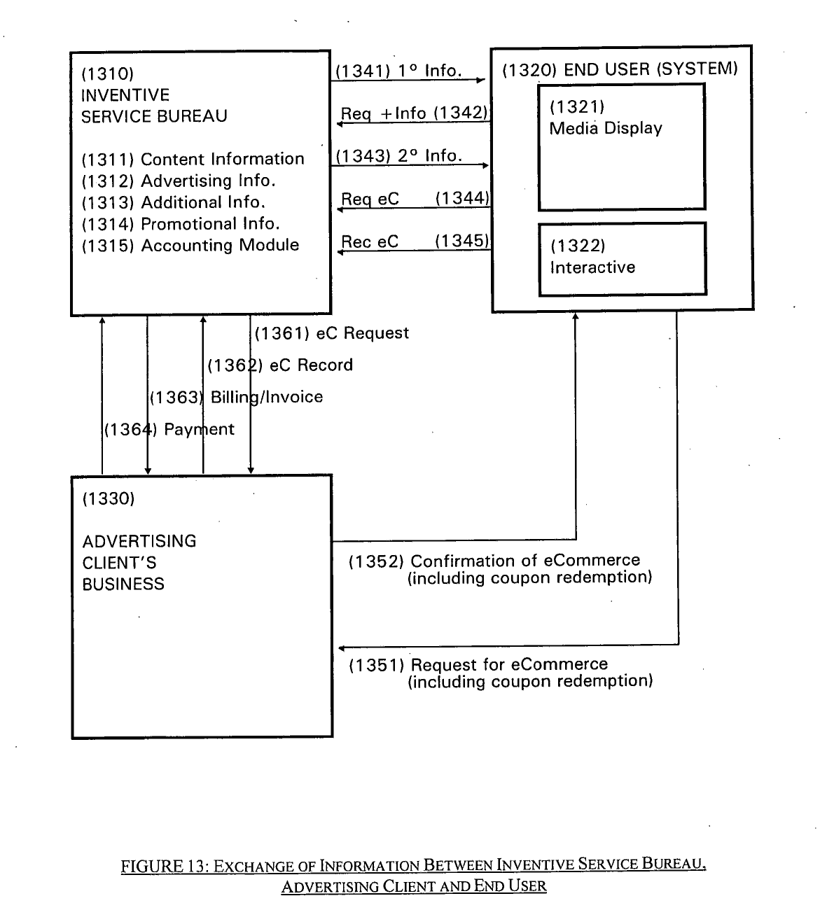

Ads will optionally include interactive incentive options. In the same example as above, a simple single click will deliver a ‘$1 off next purchase’ coupon to the user's email account. This will almost guarantee that the user will try this product and—if it is any good (but that is still the manufacturer's responsibility)—a new customer will be made. See, for example, the top of FIG. 4 and FIG. 13.

The service will not only receive a fee for each impression, but perhaps an additional fee for each discount coupon delivered; and, optionally, with tracking of coupons redeemed, an additional fee for those. End-users will welcome such promotions because they will be delivered in confidence, without disclosing the user's email address to the advertiser. Thus, there will be no unwanted follow-up spam.

This is good for the advertiser, good for the end-user, great for the bottom line of the inventive service.

Consider another illustrative, non-limiting example, with advertising tied to content: an informational program bite, 20 seconds in length, is provided to people who have expressed interest in technology, business, or ecological issues. The gist of the video item is that:

“When you recycle a typical printer cartridge, you save enough energy and plastic, that it is like saving 2½ gallons of gasoline.”

This video, or other media, is, optionally, accompanied by a text or other message that says, “If you need a printer cartridge, click here to order one from STAPLES with a one-time 10% discount.” Because the inventive service has on file the address where you live (or work), and has your credit card number on file (for your convenience) it can effect the order to STAPLES with a single click, and UPS delivers the discounted cartridge to you within 3 business days. See, for example, the top of FIG. 4 and FIG. 13.

The inventive service will not only get a fee for each of millions of impressions but, for a significant fraction of them, will also receive a more substantial fee for electronic commerce commissions for affecting automatic online orders.

This is good for the advertiser, good for the end-user, even better for the bottom line of the inventive service.

In another illustrative, non-limiting example, advertising is tied—by brand—to demographics: an informational item about how new cars get better gas mileage is displayed to end users. This would typically be paired with an ad for a car. However, if the user is an 18 year old student headed for college, the pairing would be with an ad for a Geo Metro or other inexpensive-to-own-and-operate ‘starter’ car. If the user is a ‘soccer mom’ the pairing would be with an ad for a suburban family wagon able to seat eight or carry a week's worth of groceries. And, if the user is a corporate executive earning $400,000/year, the pairing would be with an ad for a Lexus or Mercedes (unless the user has a child headed for college, in which case the pairing would, optionally, in addition to, or lieu of, the luxury car ad, be with the Geo Metro ad). The point is that the choice of advertisement is tailored to most closely fit the user's (and, thus, the advertiser's) needs.

The inventive service will not only get a fee for each of millions of impressions but, for a significant fraction of them, it will receive a more substantial fee or commission for supplying ‘additional information’ when the user clicks for more information. In those cases, the inventive service will then forward a 20-page, full-color .PDF brochure for the appropriate car to the user's email inbox—optionally in confidence, without permitting the advertiser to follow-on with additional mailings that would be considered spam.

All this is good for the advertiser, good for the end-user, and good for the bottom line of the inventive service.

Or, in another illustrative, non-limiting example, where targeted advertisements are delivered for a single brand: for example, consider that Barnes and Noble wants the inventive service to deliver an advertisement to every one of its users. The service knows who they all are, and knows what they all like. If a user likes horror stories, they are sent an ad featuring the new Stephen King book; if they are a thriller fan, they are sent an ad featuring the new John Grisham novel; if they are an amateur gourmet chef, they are sent an ad featuring a new coffee-table book on ‘creating pastries’; if they are a teenage girl, they are sent an ad featuring the latest Stephanie Myers vampire saga; and so on. All the ads are for B&N, but each is tailored to a specific user's preferences. All the ads feature one-click shopping with the book arriving at the user's doorstep in 3 business days. And, for all the ads clicked on for easy one-click purchase, the inventive service receives a substantial bonus in addition to the basic fee for each of, perhaps, millions of impressions.

All this is good for the advertiser . . . well, you get the point.

Finally, consider a situation where the inventive service fills a 30 second computer glitch by showing the user a trailer for a new movie. A movie the service knows the user will be interested in because they have told the service what they like. At the end of the trailer the user is offered—with one click—the ability to reserve and pay for a pair of tickets (or, optionally with additional clicks, 5, if they want to bring the kids along) at their neighborhood theater at their time of choice. No chance of missing out, no waiting on line, and the inventive service gets a substantial electronic commerce commission for each ticket ordered, on top of basic impression fee for telling the each user about the ticketing opportunity.

Google and others do try to do something like this with tracking cookies and the like. However, primarily the way Google targeted advertising works is that if, for example, you are searching for digital cameras, Google displays a dozen (more or less) competing ads, on the edges of the search result area, where you can click and go to a website selling digital cameras.

This is not very ‘intelligent’ and not very effective. If the user already owns a digital camera and is searching ‘digital cameras’ to obtain tips on how to shoot good pictures, all of these impressions are wasted. Google knows what the user is searching for, but does not really know who the user is—or what the user needs.

However, the inventive service does know.

So, for an illustrative, non-limiting example, if the inventive service fills a one minute computer lag with a quick tutorial on how to shoot great portraits with a digital camera, it can—just like Google—display an associated ad for buying a SONY digital camera. But the user already owns one. The service even knows which one.

What the service also knows—and Google does not—is that tomorrow is the user's wife's birthday. So, instead of a wasted digital camera ad, what is offered is a one-click solution (the service has the user's credit card number on file) that will have FTD (for example) deliver a bouquet to the user's wife (the service knows the user's address), while the user is at work tomorrow. The service not only gets basic fee for the impression, but a more substantial fee as an electronic commerce commission.

This is good for FTD, good for the bottom line of the inventive service, and great for the user's marriage.

In general, see, for example, the top of FIG. 4, and FIG. 13.

The other holy grail for advertisers these days is audience attention. The internet (not to mention, video games, DVDs, mobile broadband, etc.) competes for print and television audience. And, dozens of banner, side and display ads on every web page (not to mention the actual content) compete with each other. Web surfers have learned to ‘tune out’ internet ads.

The inventive service will be able to deliver to advertisers the undivided attention of the audience because of the unique nature of the inventive product.

When conducting a search on Google for example, the user is on a mission. Even if they are shopping, they are not just searching for a “digital camera” but for a “‘SONY MX1202’ ‘digital camera’ ‘accessory kit’ ‘free shipping’ ‘full warranty’”. Googlers have learned that the side ads offering “Low Prices on Digital Cameras” are most often empty come-ons and a waste of time. They do their own refined search (as just shown) or go to an on-line comparison site, like Priceline for travel. Ads are the distraction.

Similarly, with television the user is focused on entertainment. Ads are the distraction.

However, with some embodiments of the service, the user is working and focused. The computer stalls and that attention is frustrated. Then the service provides the user a brief diversion to focus that attention on. The user is focused, not distracted.

The inventive service knows that the user is, for example, a home gardener in the Northeastern US. The service presents a 20 second long featurette telling the user that next month is the time to plant seeds and bulbs for their summer flower garden. When the inventive service then informs the user that “Home Depot is having a garden sale—click here to receive a catalog and discount coupon via email,” it is not a distraction but exactly what the user wants, the natural progression from where the user's attention is already focused.

### Social Publishing

On the Sep. 30, 2010 episode of The Colbert Report, host Stephan Colbert interviewed Aaron Sorkin, creator of The West Wing and screenwriter of The Social Network, the hit film chronicling the founding of social media giant Facebook. These two media-ultra-savvy middle-aged white guys poked a little fun at the social media phenomenon, as exemplified by Facebook and Twitter.

Colbert: Are you on the Facebook?

Sorkin: No. I had a . . . a . . . a . . .

Colbert: Why not? You gotta be on the Facebook and the Twitter for the kids out there because they live their life, you know, just bytes at a time—I Tweet, therefore I am.

Sorkin: Yes. No, I'm not . . .

Colbert: There are 500 million people in your potential audience.

Sorkin: If it were a country it would be the third most populous country in the world.

Colbert: But why don't you want Facebook? Facebook's a way to share yourself with other people.

Sorkin: I don't have that much to share . . . um . . . and when I do . . . I . . . I . . . I'll call somebody and say I ate a good cupcake today.

Nevertheless, it is impossible to deny the inevitable—evidenced by the extraordinary popularity of online user comments, Blogs, {3} YouTube, Facebook, Twitter and the like—that the current digital culture is obsessed with being heard, seen, and read. 3. “A decade ago, no one had ever heard of a blog. Now, there are 112 million of them, with 50,000 new ones going up every day.”3. From the Dec. 14, 2008 Time Magazine, “Skimmer” column,“Blogging for Dummies” by Andrea Sachs, a review of The Huffington Post Complete Guide to Blogging by the Editors of the Huffington Post, Introduction by Arianna Huffington, Simon & Schuster (2008, New York), to be found at: http://www.time.comftime/arts/article/0,8599,1866312,00.html

It is, perhaps, not so surprising that after several generations of post-literate children being encouraged (by the likes of Drs. Benjamin Spock and Hiam Ginott) to participate from infancy in the adult world by screaming at the top of their lungs in public restaurants and theaters, and indulged a thousand times a day by responding to demands of ‘Mommy, look at this!’ and ‘Daddy, guess what?’ that Twitter's raison d'etre—the invitation to post for the word to see, “What are you doing right now?”—would surge to fill a deep and needy post-modern void.

This is the heart of the phenomenon known as Social Media.

Additionally, the democratization of digital distribution (and the commensurate “liberation” of content by Napster, Pirate Bay, news aggregators, and the like) via the Internet, has created a sometimes fatal financial hardship for content producers and publishers. Consequently, the institutional gatekeepers of quality—publishers of books, magazines and newspapers; film studios; television networks; and, record labels—are falling by the wayside.

The means of creation are now at the fingertips of anyone with a keyboard, or a cell-phone with a camera, and the Internet provides barrier-free distribution. Thus, without the editorial vetting of these traditional media outlets as a filter, almost anyone can publish almost anything. The result is that all voices are equal and—therefore—indistinguishable and—thus—unimpressive. While this may be an exaggeration, it is becoming less of one week by week.

While the huge number of people desperate to write their every thought and broadcast themselves continues to grow, finding an audience is becoming nearly impossible.

Conversely, finding information content personally relevant, and worth spending time with, is also becoming nearly impossible. As five television networks gave way to 100's of cable and satellite channels and, now, to an almost infinite number of sources of information on the Internet, it has proven to be true that the density of quality programming is inversely proportional to the number of choices. That is, the more choices of information that consumers have, the less likely it is that they will find something of real interest to them, and/or something worth spending their limited time on.

The founders of YouTube, Facebook (on the heels of MySpace) and Twitter, purveying outlier offerings to an unsuspecting world, unexpectedly (at least to outsiders) found themselves to be holding digital tigers by the tail.

On the other hand, some ventures based on embodiments of the instant invention are contemplated that will attempt to consciously engineer yet another paradigm shift in digital media.

Situated squarely at the intersection of the decline of traditional media, and the ascendancy of social media, such ventures could be mistaken for the ‘bastard offspring’ of Twitter and The New York Times (or, Time Magazine, The NBC Television Network, Universal Studios, Simon & Schuster, or Arista Records).

This child has the best features of both parents, and some inescapably attractive gifts of its own. They assume and make their own the ‘gatekeeper of the culture’ role, once played by the monolithic media distribution institutions, to harness the ephemeral blizzard that is emblematic of social media.

Solved is the problem of those who have finally found themselves with a voice; yet, have no ability to find a satisfactory audience.

Also solved is the problem of those with near limitless options to engage with information; yet, who can find nothing sufficiently engaging to warrant their attention.

Finally, and, perhaps, most importantly from an economic point-of-view, solved is the problem of advertisers who find it near impossible to capture the attention of a post-literate, post-MW, post-television, audience. A finely fragmented audience, lured away from traditional media (and traditional advertising) by the Internet. An audience that has been trained to ignore Internet advertisements in favor of content—trained by these very same overeager advertisers, bombarding users with multiple competing ads, crowding the browser page.

Embodiments of the instant invention effectively re-invent audience attention for the social media influenced environment.

A large part of the preceding document, and parent documents, are devoted to inventive technologies that enable the creation and delivery of idiomorphic' content to individual, and large groups of, users—that is, content that is personally selected to match the individual preferences of each and every customer. It is expected that this form of content will soon become irresistible and indispensable.

Similarly, the ability to custom-match advertising with customer interest will provide, for our paying advertising customers, audience impressions that are more cost effective, and more psychologically effective, than any other form of advertising currently available.

Ventures based on embodiments of the instant invention are contemplated which rely on these two factors.

However, an additional feature of such ventures will catch the attention of the public—potentiated by the fascination with social media—and create an outlet for new voices—creating a new form of publishing.

Such ventures will, optionally, collect, vet for quality, edit, and tag for subject and interest, media gathered from all over. This will comprise the bulk of the content delivered in customized packages to end users.

However, optionally, customers will also be invited to receive an amount of their choosing (from 0% on upward) of Avant Garde™ material that has not been fully reviewed by staff. (Although staff will, optionally, briefly review submissions to make sure they do not violate minimum standards of propriety.) These will comprise materials from the general public (or elsewhere), submitted to such a venture to see if their voice can find an audience.

The venture will submit an un-tried work (fiction, poetry, political rant, media review, viral video, musical composition or performance, etc.) from a new author to a small sub-set of the customer base who would likely be interested in such an item. Those accepting such Avant Garde materials will be asked for feedback—a simple thumbs up/thumbs down to the question “Would you like to receive more content like this?” or “Would you like to receive more content from this creator?” (With the user optionally being asked or invited to supply more sophisticated comments or, optionally structured or guided, feedback.)

From this feedback, the service will refine the targeting parameters for a successive small sample audience who has not yet seen the item. After several such progressively refined test rounds, the work will have found its niche audience, or failed to do so.

Those works which do find an audience of sufficient size and interest will, optionally, be submitted for full vetting by the editorial staff, and released to those in the general customer base who match the profile of the audience niche identified for the piece.

In this way the service will be able to obtain and select (from vast quantities submitted), in a semi-automated fashion, a substantial number of new works and authors, and welcomed new sources of information.

Additionally, this Avant Garde mechanism will, optionally, be integrated with existing social media communities to extend the scope of the “meme pool”™—as any combination of: reviewers and test audiences, sources of content, potential consumers of content, or otherwise.

By panning for gold—separating the wheat from the chaff—such a venture will potentially acquire additional high quality content. Content of low cost and effort to obtain, and—after automated filtering—highly attractive to the audience—specifically to the idiomorphic demographic niche so identified.

As for the authors, they will, optionally, be provided with a previously unavailable way to seek and identify their potential or actual audience in a quick and efficient manner.

With the number of magazine outlets shrinking dramatically it is increasingly hard to make a living as a free-lance writer. And, posting a blog (or a YouTube video) and letting your friends on Facebook, and your Twitter followers know, is not a reliable way to build an audience or start a career. It helps, but not that much, unless you are already famous and successful.

Thus will be created a path to recognition, for new voices, without the need for an agent, a publicist, or even a traditional publisher.

All that is needed is the talent to say something worth saying—a true meritocracy.

Content creators will not only be provided with an identified audience but—through micro-payments—provided with anything from pocket money to a sizable full-time income from writing, videoing, music, etc. It all depends on the size and willingness to pay (directly or through ad support) of the audience that can be attracted.

This “Social Publishing” paradigm will provide new and inexpensive sources of content for such a venture. (Note that others have used the term ‘social publishing’ to refer to publishing via twitter, blogs and the like. This is not at all the same thing.)

It will also generate the kind of enthusiasm from the creative community specifically, and the public in general, that phenomena like YouTube, blogging and Twitter have.

Finally, it will generate interest in, and ‘heat’ about, such a venture, which will be an essential element for the venture when finding its own audience—its place in the Zeitgeist.

### Additional Details of Implementation

Two of the elements that distinguish the instant invention from the techniques that comprise some embodiments of the technologies disclosed in the related applications and patents are granular media and interstitial channels. Much of the basic technology and necessary details of implementation have already been disclosed in those parent documents, which are incorporated in their entirety by reference; and/or, are within the ken of those skilled in the art. These previously disclosed technologies, details of implementation, business methods and models, etc., include, without limitation: generation of idiomorphic media (idiosyncratic or personalized content and advertising); generation and/or insertion of timing or segmenting information into media streams; timing or segmenting decision lists; tagging of media for content, interest, timing, etc.; designs for display, GUI, systems, program flows and algorithms; advertising; data-mining; etc.

In particular, with regard to the last two (advertising and data-mining, and related operations) ventures employing the instant inventions will, optionally, but generally, operate in a way that is unusual, if not unique, with regard to end-user customers, as opposed to advertising customers. Operations, such as Google, and others, also work with end-user information. Google, in particular, data-mines information about its end-user customers for the use of its advertising customers. The ‘privacy policies’ that such companies employ with respect to end-user information (either supplied or monitored) are generally: self-serving and onerously tilted far in favor of the company rather than the end-user; are generally not particularly optional or flexible; and, often are mercurial containing phrases such as, “these policies can be changed at any time without notice.” Unwanted and uninformed use of technologies such as ‘tracking cookies’ are often part of such sharing of end-user information.

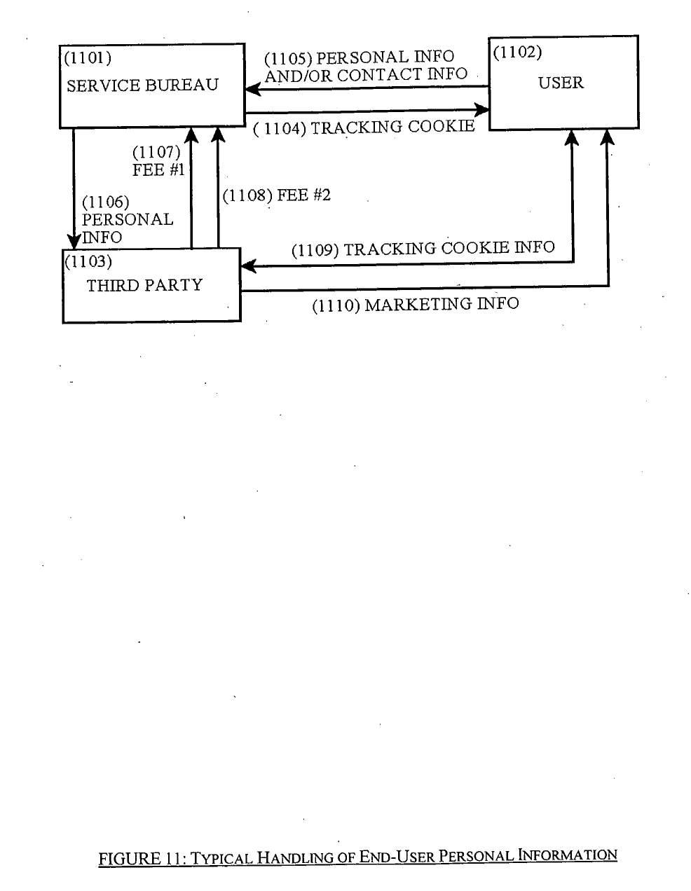

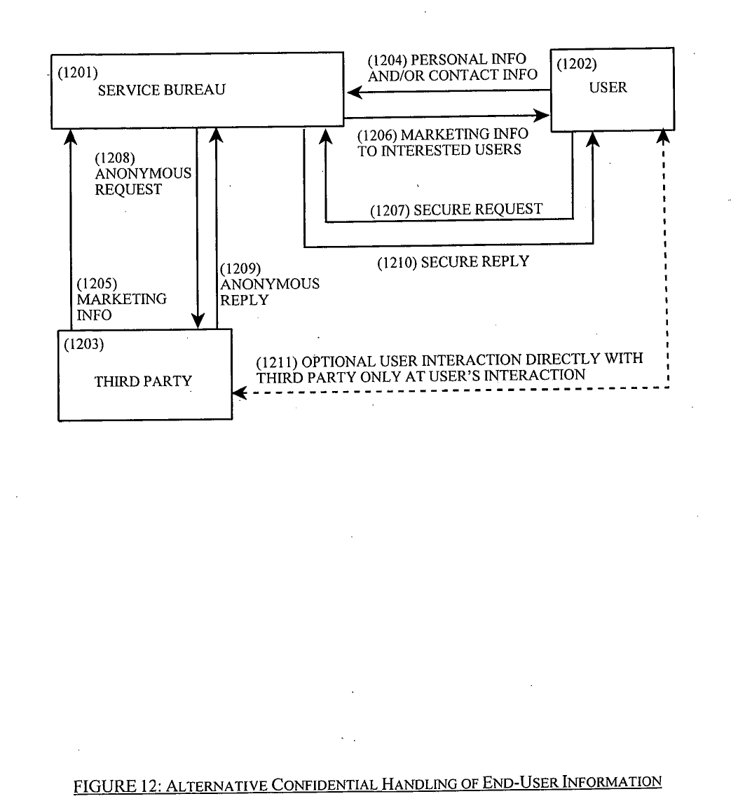

In contrast, an important, if ultimately optional, element of the inventive ventures, will be that end-user information will be treated strictly confidentially, for the benefit of the end user. Although it will also benefit advertising customers indirectly, it will generally not be shared with them. Thus, like confidential banking, legal or medical information, the use and distribution of such end-user information will be professionally, ethically and tightly controlled. The information will be used to provide end-users with idiomorphic media (customized and idiosyncratic content). It will also provide idiomorphic advertising—which will be welcome, or at least less onerous to the end user—which can be viewed as micro-finely targeted advertising from the advertiser's point of view. However, the end-user's information will be tightly controlled and protected from disclosure to the advertiser, in order to avoid follow-up communication or other actions that might be considered to be comparable to spam. While users will receive information from advertisers indirectly, through the inventive service, and will be free to contact, and/or establish two-way communication with, advertisers, advertisers will not be supplied with end-user information. See, for example, FIG. 11 and FIG. 12.

### Distribution via Interstitial Channels

From online definitions at:

http://www.merriam-webster.com/dictionary/interstitial;

http://www.merriam-webster.com/dictionary/interstices; and,

http://www.medterms.com/script/main/art.asp?articlekey=9587, respectively, it can first, rather obviously and tautologically be gleaned, without much utility, that “interstitial” means “relating to or situated in the interstices.” Following on, it can more illuminatingly be discovered that an “interstice” is “1a: a space that intervenes between things, especially one between closely spaced things; 1b: a gap or break in something generally continuous; 2: a short space of time between events.” Or, more succinctly, “Interstitial: Pertaining to being between things, especially between things that are normally closely spaced.”

In the instant application the term interstitial, and more particularly interstitial channel, is used to indicate a channel (generally an opportunity for communication or information display) that exists within the spaces or gaps between the generally (intended to be) continuous operation of a computer system. The interstices (iconicly hourglass-emblemed delays) are generally (or, at least intended to be) relatively short compared to the normally closely spaced periods of normal computer operation.

Thus, the interstitial channel under discussion is one composed of an aggregation of, generally, short discontinuous periods of time corresponding to delays in computer operation; e.g., the collected gaps in operation that cause hourglass syndrome, or some similarly ‘skipping stone on water’ structured opportunity for interaction, communication, or presentation of information.

The instant invention will archetypally be implemented to work on a machine running some version of the Windows operating system with its ‘windows object oriented’ and ‘message passing’ paradigms: currently, at a minimum, several versions each of Windows XP, Windows Vista and Windows 7 are all popular, with others still in use. However, optionally, it will also be implemented to run under versions of operating systems available from Apple (the UNIX-based Mac OS X), and under Unix/Linux and other operating systems as well. The programs involved will, optionally, be developed in C, C++, C#, Pascal, Java, Visual C++ or any of the other ‘visual’ languages, ActionScript (used with Adobe Flash, Flex and AIR), or any other suitable programming language, or using any suitable development environment. Use will also, optionally, be made of the Microsoft Foundation Class (“MFC”), X-11 or other software development library. Additionally, the programs will, optionally, run under the operating system as stand-alone programs, hidden processes, add-ons or plug-ins (in particular to a web browser or other networking program), and, in turn, will optionally run secondary applications. They will, optionally, run native; as part of a browser or other application; in Flash, Java, etc.; or, otherwise

In addition, the inventive programs will, optionally, be developed to run on smart phones (or other mobile broadband devices) which have other operating environments, development libraries and languages, alternative sub-operating-environments (web, Flash, Java, etc.), and system and software requirements. Apple's iPhones (and related products), Google's Droids, and other advanced phones from Blackberry (RIM), Motorola, Nokia, Sony Ericsson, etc.; and e-Readers such as the Kindle, Nook, Vook, etc.; Etc.; will, in general, each have particular and/or distinct requirements.

Further, under Windows or other window-like GUI operating environments, multiple windows are open with, generally, one and only one having the focus (GUI interaction with the user) at a time. On mobile devices, the screen will, optionally, only accommodate one visible program at a time, which by default has the focus, while other programs may run in the background, not displayed.

To further complicate matters, new platforms, new operating and development environments and languages, and new variations of older operating and development environments and languages, are announced, it seems, several times a year or more often.

Consequently, the options and variations available for development and implementation are myriad, with alternatives generally available even within a specific hardware/operating environment combination. For example, in order to get (determine) or set (select) which window has user focus, in the X-11 windowing library used with Linux/Unix, calls can be made to XGetInputFocus( ) and XSetInputFocus( ) while in the MFC Library generally used with Windows development references can be made, for example, to CWnd::GetFocus and CWnd::SetFocus. Thus, the selection of which programming language and environment to use, and the details of coding, are within the ken of those skilled in any one or more particular of such arts, and will be left to the practitioner skilled in the appropriate programming arts who will be implementing or integrating any particular embodiment of the instant invention.

Therefore, the following programming, system design and system operation discussions will be offered in functional detail, but without reference to the specifics of any particular programming language, library, or operating or development environment.

This discussion will generally be carried out in terms of a Windows-like operating environment, but it is, optionally, applied to other situations, in general practice, that are similar, but not identical. For example, if the invention is carried out on some sort of smart phone-like device, it may not be necessary to poll multiple programs or processes, or to ‘get the focus’ to determine which application is interacting with the user—it may be as simple as examining the one-and-only application that is being displayed. In some systems, it may be the operating system that determines if a process, program or application (terms that, while distinct, are largely interchangeable for the purposes of this non-implementation-specific discussion) is busy; in other systems, it is the application (or one of its processes) itself that puts itself into the ‘wait state.’ Similarly if the invention is being practiced within, or in association with, a specific application (such as a web browser) rather than at the operating system level, it may only be necessary to determine the state of that particular program, or windows or tabs within that program, rather than monitoring several different programs. Further, the definition of ‘wait stated’ or delayed may vary: encountering an hourglass in one case; waiting for some element(s) of a web page to arrive (but not, technically, ‘hourglassed’) in another, which will, optionally, involve monitoring of a ‘download progress bar’ rather than an ‘hourglass.’ Similarly with a graphics program such as a .PDF reader, a video editor, or a ‘paint program’—the definition of ‘wait stated’ may be that the program is decoding and loading (or encoding and storing) a complex graphic that may take a relatively long time, particularly when large video files and complex effects or other processing are involved—the graphic program may not technically be ‘hourglassed’ and there may not even be a progress bar to monitor—but the condition to monitor is, whether the graphic program is accessing the disk and transforming a large file for/from screen display (this may, in turn, involve identifying and monitoring individual processes, rather than a monolithic high level application and, so, in this particular case, the distinction between process and application is meaningful.) And, the process of monitoring a system to create a useable interstitial channel from intermittent fallow (or blocked) periods can be applied to situations other than the GUI of a multi-tasking computer operating system. For example, with regard to a web browser in particular, practical user access to the information requested may be literally, or effectively, blocked by: display of a relatively short (e.g., :15 to :30 second) video advertisement; a full-, or nearly full-page blocking advertisement which, while often having a [X] or similar ‘close’ link, will optionally remain blocking access for a similar period; a count-down timer delaying access to a free on-line service, which is intentionally designed to annoy users into subscribing to a paid, timer-free, version of the same service; or, otherwise. Similarly, programs such as database management systems will, even if technically not blocked or delayed in an ‘hourglass’ fashion, sometimes be in an operational state where the user, waiting for results of a query (or, similarly, for delivery of a web page or other web resource with other programs), will not be in a position to continue with a productive task which requires access to that resulting information. The user will, optionally, be provided with a ‘request alternative presentation’ button, to request that the inventive system operate and provide a diversion, should it fail to identify any delay or other inciting condition, such as described just above, or otherwise.

In general terms, the instant invention relates to making use of the collected ‘hourglass delays’ or other periods of user non-productivity, as an interstitial channel; and, further, to presenting a stream of media or other information, or the operation of an alternative (to the one that is currently stalled, blocked by advertising, waiting for resources, or otherwise unavailable for productive user interaction) application to utilize, for alternative user engagement—an alternative presentation.

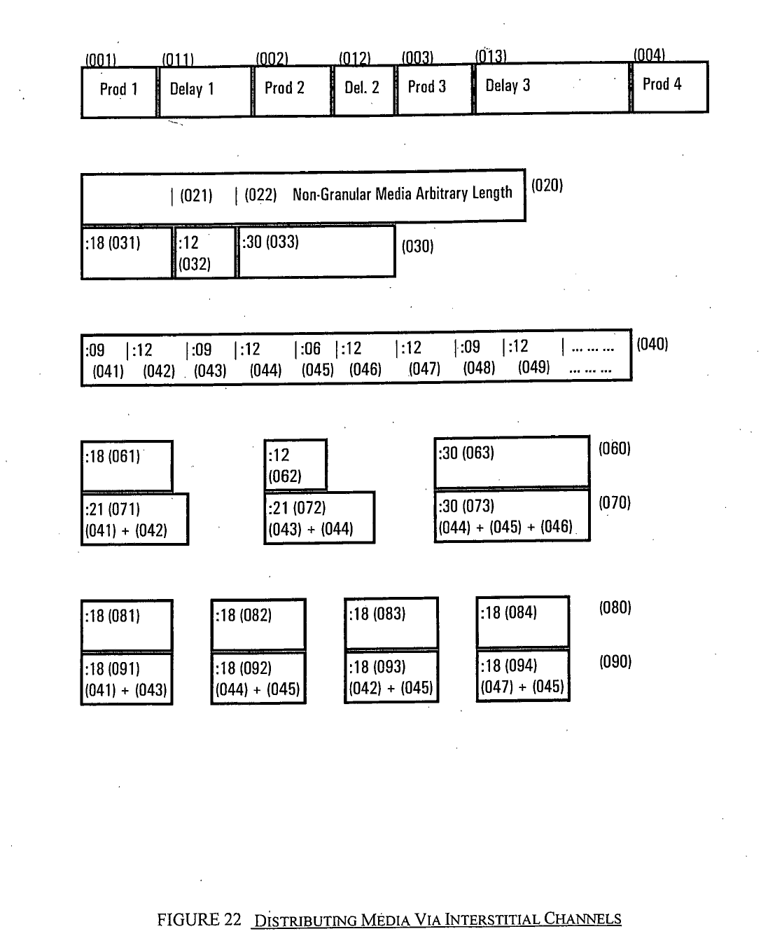

Turning to FIG. 22, it will be examined how to best deliver such an alternative presentation; discussed here in terms of a media presentation but, optionally, a presentation of an alternative computer application program.

The top row of FIG. 22 depicts a stream of computer system operation where periods of productivity (001, 002, 003 & 004) are interspersed with gaps or periods of delay (011, 012 & 013). The periods of productivity are depicted as uniform in size (comparable to length of time) but, in practice, are of arbitrary length. Further a period of productivity (e.g., (002)) will, optionally represent, for just one non-limiting example, the use of a first application for a period, followed by prolonged use of two other applications in tandem, and the use of a fourth application for some time, before a gap during the productive user operation of application four causes the provoking or inciting delay, or other, condition or (012). On the other hand, the gaps or delays (011, 012 & 013) are intended to be depicted in geometric width roughly comparable to delays of :18, :12 and :30 seconds, respectively.

In rows (020) and (030) a non-granular, that is standard, essentially continuous, media or other presentation of arbitrary length is compared to the reassembled one minute ‘interstitial channel’ comprising the conglomerated yet separate delays of :18 (031), :12 (032) and :30 (033) seconds, which correspond to the delays (011), (012) and (013) respectively. Note that since, in practice, there will be arbitrarily long periods of discontinuity between (031) & (032), and between (032) & (033), that (020) will be interrupted at points (021), at :18 seconds, and (022) at :30 seconds running time; and again, at 1:00, one minute running time, as the non-limiting examples in FIG. 22 continue beyond what is depicted. Since these interruptions will, generally, be at unpredictable times; and, generally, at times uncoordinated with the production of (020), even if predictable; the interruptions at (021) and (022) will be (for example, if (020) is display of graphic or playback of audio, comprising the text of a book) potentially inconvenient at best; during an unfinished paragraph or sentence, or even during a word. Similarly, with the presentation of an alternative application program, that program will potentially be interrupted at an inconvenient point of operation to return to the primary task at the end of a particular delay period.

The alternative would, optionally, be to start the alternative presentation at essentially the beginning of the delay period and then leave it up to the user to stop operation of the alternative presentation at a convenient point, subsequent to the point when the delay of the primary task is already over, and the user is ready to return to the primary task. However, the user may not be able to easily determine that the delay (or other inciting condition) is over; such checking would potentially be more annoying then the short delay itself, defeating a primary annoyance-avoiding purpose of the instant invention; or, the user may become so engrossed in the alternative presentation that they will remain engaged for minutes or longer after the delay has ended, defeating a primary, efficiency enhancing, purpose of the instant invention; or, some other complicating or problematic situation will ensue. Alternatively, the system will, optionally, be supplied with a timer, to notify the user that a maximum permitted time has elapsed, or an alarm that indicates the delay or other inciting condition has ended. However, such alternatives are, themselves, annoying mechanisms, even if they work well; will potentially be ineffective at disengaging the user, if they are not mandatory; and/or potentially still cause cognitively disturbing interruptions if they are mandatory; or, have other problems of complications associated with them.

The problems associated with such situations is addressed by the use of what will come to be described in detail below as ‘granular’ alternative presentations of media, alternative applications, or otherwise.

The presentation of (040) has been created, produced, edited or otherwise formatted as a granular presentation. That is, cognitively coherent segments—(041) of :09 seconds, (042) of :12 seconds, (043) of :09 seconds, (044) of :12 seconds, (045) of :06 seconds, (046) of :12 seconds, (047) of :12 seconds, (048) of :09 seconds, (049) of :12 seconds, conveniently separable at grain boundaries indicated by (|)—have been assembled from diverse parts, extracted from a coherent whole, or otherwise, such that the presentation is, optionally, stopped after any such segment without the user feeling they have been ‘cut off in the middle’. The presentation will, optionally, still require that the segments be experienced without skipping any, in order to perceive a coherent, if interrupted presentation; or, the grains will be entirely stand-alone; or, any other structural, functional or narrative relationship between grains and the whole will, optionally, prevail.

Assuming, for the moment, that the coherent, if interrupted, presentation of (040) will require that grains (041) through (049) be presented in sequence, the presentation will proceed, in a non-limiting example, as depicted in (060) and (070). When Delay 1 (011) in encountered a period of :18 seconds (061, corresponding to 031) occurs (ignoring any further delay caused by the operation of the inventive system, for example, to detect the delay or other inciting condition) resulting in a corresponding requirement for alternative presentation to engage the user during the delay. Such a display will commence with the first grain (041) or presentation (040) lasting :09 seconds. This will leave the delay (061) continuing for an additional :09 seconds, which length will be: known to the system, unknown to the system, or predicted by the system with some level of reliability. Assuming that the additional length is unknown to the system, and just that the delay continues is known to the system, the system will then continue the alternative presentation with the second grain (042) of (040) lasting an additional :12 seconds, or :21 seconds running time in total. This is an over-run of :03 seconds beyond the :18 second delay; an over-run that is quite acceptable compared with: the additional cognitive disturbance and commensurate potential delay to productivity resulting from cutting off the alternative presentation in mid- sen; or, the long potential delay resulting from the user becoming ‘lost’ in a unrestrained presentation. Alternatively, if the system did know that the remaining delay, (061) less ((041), was :09 seconds, and the next grain (042) was :12 seconds, and decided not to present the second grain (042), there would be a delay of :09 seconds, still fairly problematic, even compared to the full :18 second delay (061) without intervention.

Similarly, the second delay period (062) will be covered by alternative presentation of grains (043) and (044) comprising :21 seconds in total, over-running in this case by :09 seconds. In this case, if the system was in possession of knowledge that the delay would be continuing only three seconds beyond presentation of grain (043), there is the possibility that the system will be programmed with an algorithm that will weigh a further delay of :03 seconds uncovered by alternative presentation against an over-run of :09 seconds and (depending upon the algorithm) decide not to display grain (044). Generally, for example, it will increase efficiency to have the user engaged for :15 seconds, rather than have them frustrated for :10 seconds.

Finally, with regard to rows (060) and (070), delay (063) comprising :30 seconds, is covered by alternative presentation of grains (044) of :12 seconds, (045) of :06 seconds, and (046) of :12 seconds, also comprising :30 seconds running time in total and, in this case, exactly matching the delay time and the alternative granular presentation.

The discussion has, thus far, assumed that grains of a granular presentation need to be presented in consecutive order, starting from the beginning. However, if such a requirement is loosened in some way, it will, potentially, be possible to create alternative granular presentations that more closely or, as depicted, exactly, match the system delays. Several non-limiting examples follow, comparing rows (080) and (090).

Delay (081) of :18 seconds is the first delay encountered. The requirement is that the first grain of the presentation (041) must be presented first, but then subsequent grains may be presented without having to necessarily present all the intervening grains first. In this case, alternative granular presentation (091) comprises grain (041) of :09 seconds followed by grain (043) also of :09 seconds, exactly matching the :18 second length of delay (081).

Generally, but not necessarily, individual grains will not be presented repeatedly during a session and, thus, when presentation constraints are more fluid, it will need to be kept track of which grains have already been presented, not merely a progress or bookmark point (generally a grain boundary) for which it is assumed all prior grains have been presented and all subsequent grains have not.

Delay (082) of :18 seconds is the first delay encountered. The requirement is not that the first grain of the presentation (041) must be presented first, but that grains must be presented in sequence without leaving any gaps. In this case, alternative granular presentation (092) comprises grain (044) of :12 seconds followed by grain (045) of :06 seconds, exactly matching the :18 second length of delay (082) within this set of constraints.

Delay (083) of :18 seconds is a delay encountered, not the first; grain (041) has already been presented. The requirement is that unused grains must be presented in order, but not necessarily consecutively. In this case, alternative granular presentation (093) comprises grain (042) of :12 seconds followed by grain (045) of :06 seconds, exactly matching the :18 second length of delay (083) within this set of constraints.

Delay (084) of :18 seconds is a delay encountered, not necessarily the first; some grains have, potentially, already been presented (in this case (041), (042), (043), (044) and (046)). The requirement is that only unused grains be presented; but, in any order. In this case, alternative granular presentation (093) comprises grain (047) of :12 seconds followed by grain (045) of :06 seconds, exactly matching the :18 second length of delay (084) within this set of constraints. Grain (047) is presented first in this case because, hypothetically, it is known ahead of time that the delay will exceed 12 seconds, but not known by how much. Thus, an unused grain as large as possible is selected leaving flexibility once the additional delay period can be determined (:06 seconds in this case) and, thus, short (045), medium (048) and long (049) grains are left to select from once the additional delay time can be known, or estimated.

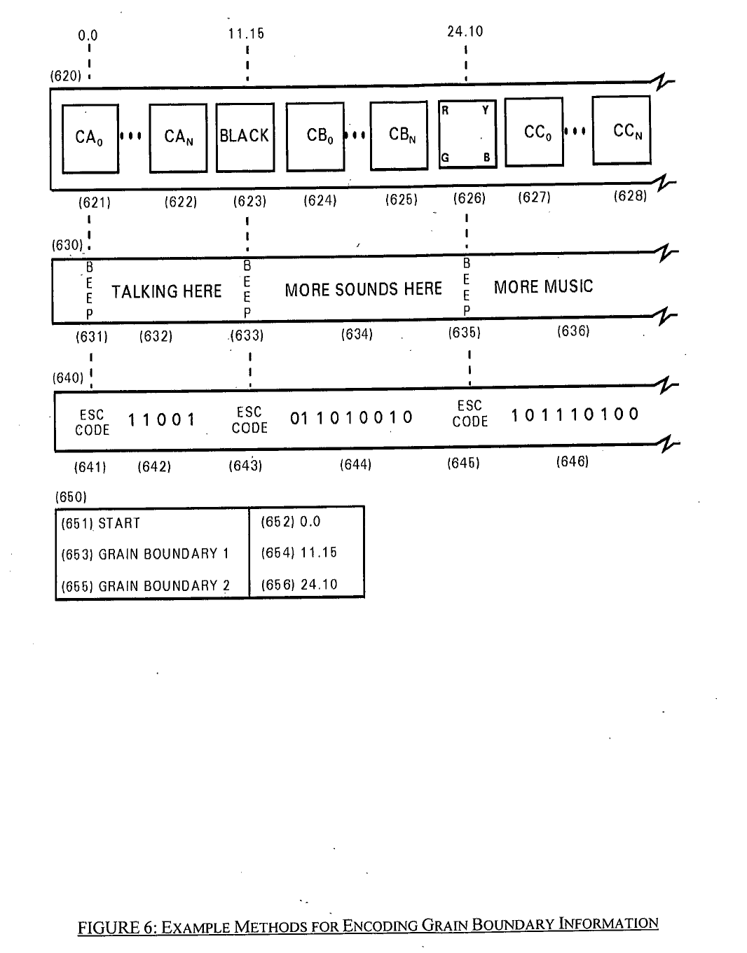

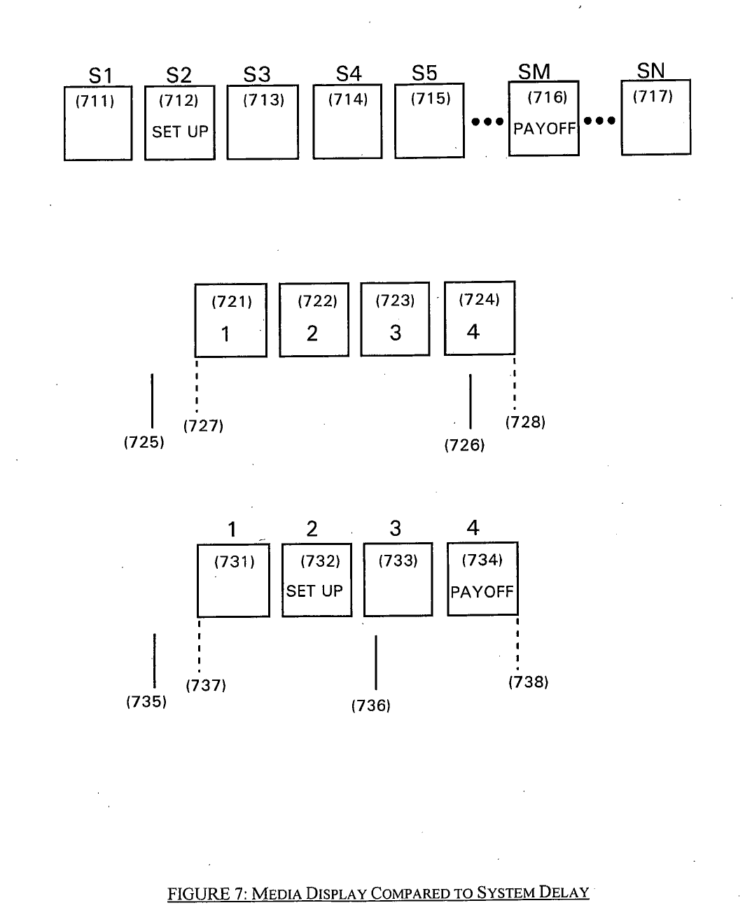

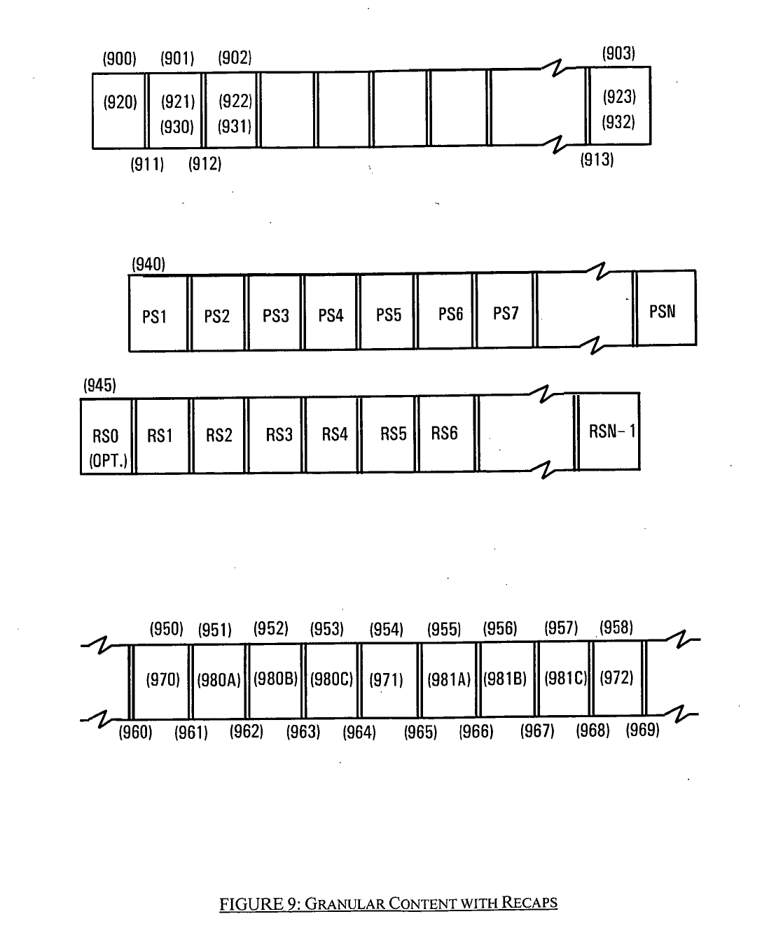

Other variations to the interaction between interstitial channels and granular presentations are applied as needed and are not limited by the examples discussed or depicted herein. See, also, for example, in particular, FIG. 6, FIG. 7 and FIG. 9, and the accompanying discussions for, additional details.

### Production/Preparation of Granular Media

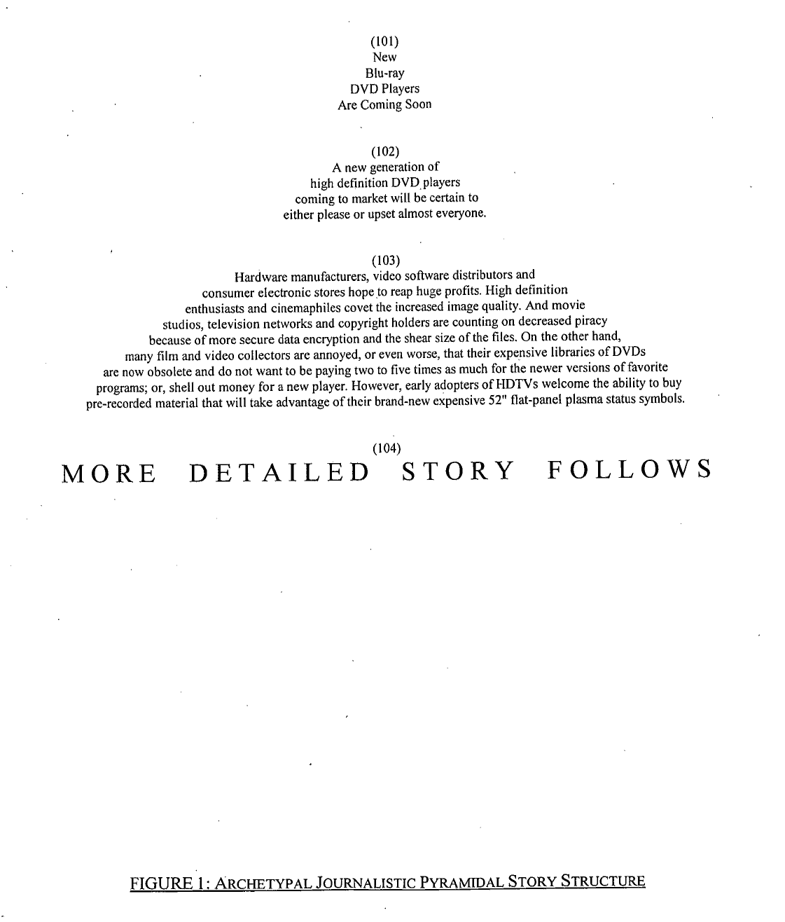

Journalistic writing is, stereotypically, supposed to be written in a pyramidal structure. That is, referring to FIG. 1: a very short attention-grabbing headline (101), is followed by a somewhat fuller encapsulating lead (102), is followed by a summary (103) and, finally, a fully detailed story (104), optionally with supplementary information. In this way, the reader can choose to spend progressively more time with a story to match their level of interest and, yet, bail out at any one of several convenient points without a sense of leaving the story hanging in the middle. However, each subsequent layer takes significantly more time to absorb than the previous one, which is not a particularly useful structure for many of the specific applications that are the subject of the instant invention. That is not to say that this format is actually adhered to by journalists, but it is the theory. Pyramidal structuring and delivery of media is used in a related but distinct manner in some of the disclosure and teachings in the parent documents to this application, and that meaning therein, and when used herein in that context as well, is related but distinct from the meaning which is illustrated in FIG. 1. Media for delivery by the inventive system will, optionally, be structured in a pyramidal fashion, as is discussed in detail in parent document(s), and that pyramidal media will then optionally be granularized.

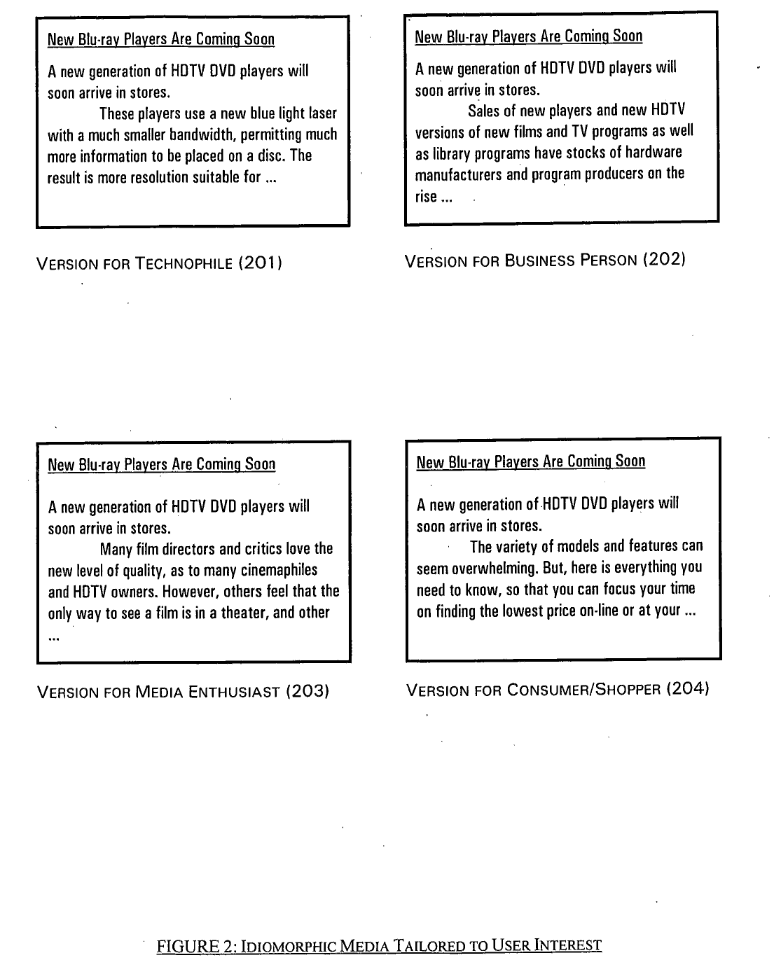

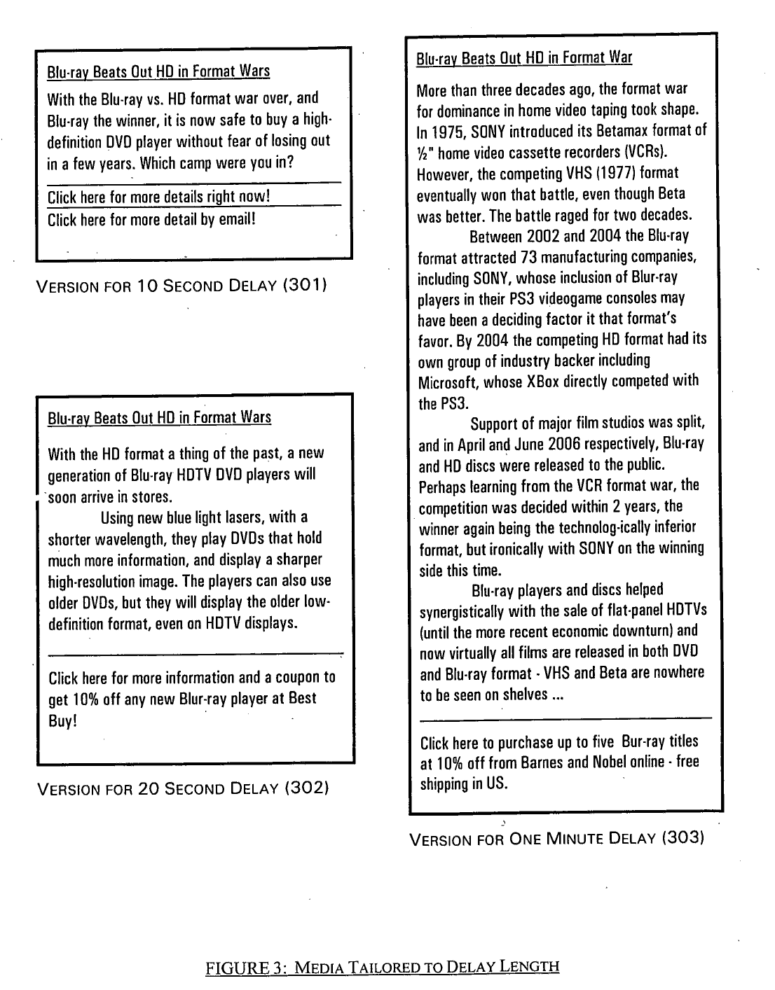

Two other concepts that are fundamental to understanding how to practice the instant invention are illustrated in a non-limiting way in FIG. 2 and FIG. 3. These concepts, and production, editing, tagging and other techniques relating to them, are disclosed and taught elsewhere herein and in the parent documents referenced herein. Briefly, they relate to tailoring (e.g., selecting, editing, or otherwise particularly creating) media: with user-appropriate content in mind; and/or to an appropriate length. Note that in these examples, as well as elsewhere herein, or in the parent document(s) media will often be shown, for illustration purposes, as text. However, any and all of the techniques disclosed herein and in the parent document(s), however shown or discussed, are, optionally, applied to text, audio, video, or otherwise, as needed and appropriate.

FIG. 2 depicts how media—represented by text in this illustration, but which is, optionally, any combination of text, audio, video or other media—are optionally presented or edited (e.g., by selecting information from a longer article, not shown, containing a super-set of all the information contained in all four articles shown) for distinct users with distinct interests. As shown, in this non-limiting example, versions have been crafted for: technophyles (201), business persons (202), media enthusiasts (203), and consumers/shoppers (204). As illustrated, each story continues . . . Generally, granular content will, optionally, be made available for diverse user interests, ages, reading levels, genders, political or social opinions, or otherwise.

FIG. 3 depicts how media—represented by text in this illustration, but which is, optionally, any combination of text, audio, video or other media—are optionally presented or edited (e.g., by selecting information from a longer article, not shown, containing a super-set of all the information contained in all three articles shown) for distinct time periods, or to fill expected delays of distinct times. As shown, in this non-limiting example, versions have been crafted for periods of nominally: 10 (301), 20 (302), and 60 (303) seconds, the last of which is shown to continue . . . Also, note that each such non-limiting example is depicted with an optional interactive offering one or more opportunities for additional information, either immediately or via email (301), or for incentive offers (302, 303). Note that such additional information optionally comprises additional content, additional advertising/marketing information, or otherwise. Also, note that such delivery of additional information via email will be clearly marked in such a way that it is easily differentiated by the user from spam.

If one were to attempt to construct content suitable for a delay that may be characterized in being roughly a multiple of ten-second increments, and which in some circumstances may be of a length that cannot reliably be predicted ahead of time, one might intentionally string together a sequence of short content bites. For example, a collection of cookie fortunes could be sequenced like a string of beads (Pearls of Wisdom™ Confucius might call them) and as many as needed would be offered in sequence until the required period was filled (or, in practice, probably slightly overfilled, as the delay will not necessarily end at exactly the end of a particular ‘bead’). Similarly for a series of amusing photos or graphics which the user will flip through until the delay is over.

An object of the instant invention which will be addressed next is how to acquire, collect, aggregate, edit, produce from scratch, or otherwise prepare media suitable to fill intermittent gaps, such as those encountered in association with hourglass syndrome, or for delivery over other interstitial channels.

From the websites http://en.wikipedia.org/wiki/Granular and http://en.wiktionary.org/wiki/granular, respectively:

“Granularity is the extent to which a system is broken down into small parts, either the system itself or its description or observation. It is the ‘extent to which a larger entity is subdivided. For example, a yard broken into inches has finer granularity than a yard broken into feet.’”

“The essential characteristic of being granular is that something appears to be composed of small, discrete entities as opposed to being continuous or monolithic, and this is primarily a binary distinction, not a matter of degree.”

Nevertheless, as to matter of degree: most books, for example, can be thought of as consisting of chapters with a course degree of granularity, and consisting of individual words with a very fine degree of granularity. The instant invention is concerned with creating media that most often comprises a granularity somewhere in-between; suitable for the purposes of addressing hourglass syndrome or similar situations; and, which may consist of a collection of separate individual grains or, often better, a granular whole capable of being separated into chunks of roughly the appropriate size as needed, along grain boundaries.

Such granularization of content is achieved by careful selection of suitable content materials; editing of content materials; reformatting of content materials; and, in particular, marking materials with grain boundaries and, optionally, providing sequencing (for example, with respect to set-up and pay-off markers for comedy content) or other timing information. As with the supplementary content information comprising subject matter tagging for idiomorphic selection of content, or for the timing and/or edit information related to content abstraction (see parent patents and applications for additional information on these two and related subjects), the supplementary information or tagging related to granularity is produced, at least in some instances, by the application of human intelligence and creativity. Such custom human tailoring would, generally, be unaffordable on a one-to-one basis; however, by embodying the human intelligence as machine comprehendible supplementary or tagging information, computers may then reliably, quickly, efficiently and cost-effectively produce custom information experiences for each member of a mass customer base, with the human input being affordably amortized over the customer base. See, for example, FIG. 10.

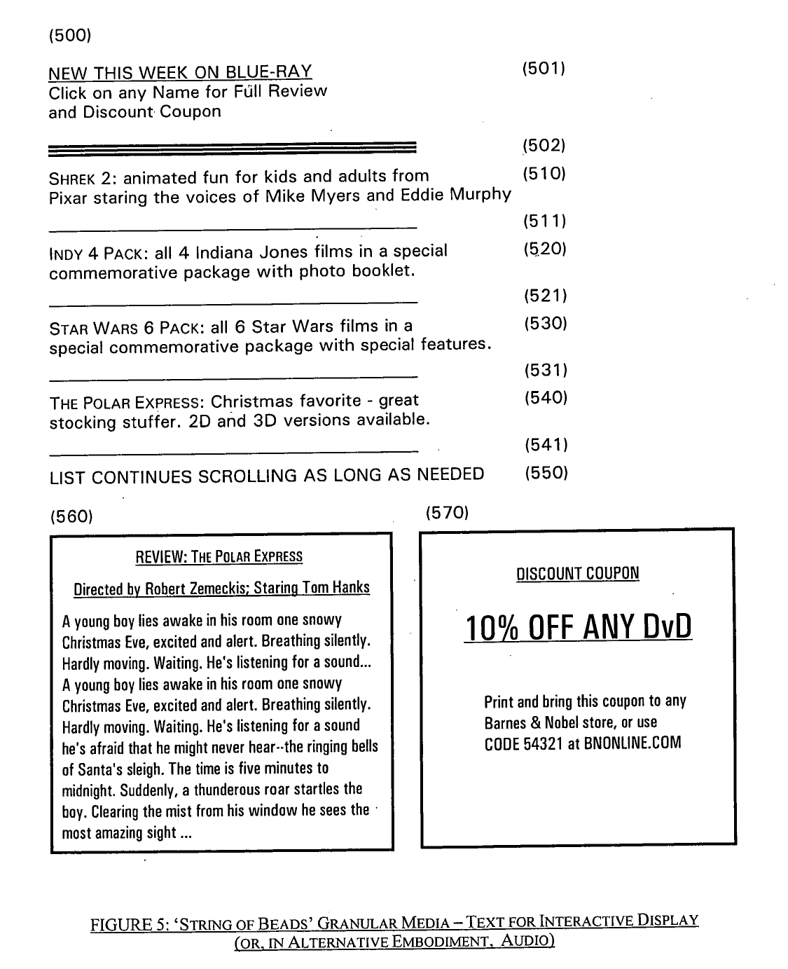

FIG. 4 and FIG. 5 illustrate non-limiting examples of granular media and how they are, optionally, presented. These examples have been intentionally constructed to be simple and straightforward for illustration purposes.

FIG. 4, first depicts what is a display (410), or a window of a more general display, to present granular media to a typical end user. The display comprises an option title bar or similar identification (411); an optional sub-window (412) to display media (any combination of video, animation, graphics, text, or otherwise; in motion, as a series of still images, scrolling imagery, or otherwise) which, if audio only, is replaced by an audio rather than visual display. The display is also depicted with interactive hyper-links which, in this non-limiting example, signal requests from the user for: a ‘full review’ (413); a ‘discount coupon’ (414); and, directions to escape the current grain presentation and ‘skip to next item’ (415). Optionally, other interactive requests are supplied (e.g., supplementary menus, as described, below), and other interactive mechanisms used. For one non-limiting example, user interaction is carried out via audio cues and voice recognition, particularly if the ‘display’ (412) is audio only. All of this is fairly typical interactive multimedia technology and is within the ken of those skilled in the appropriate arts. It is offered to describe a typical, essentially ‘off-the-shelf’ mechanism within which to deliver some embodiments of the instant inventions.

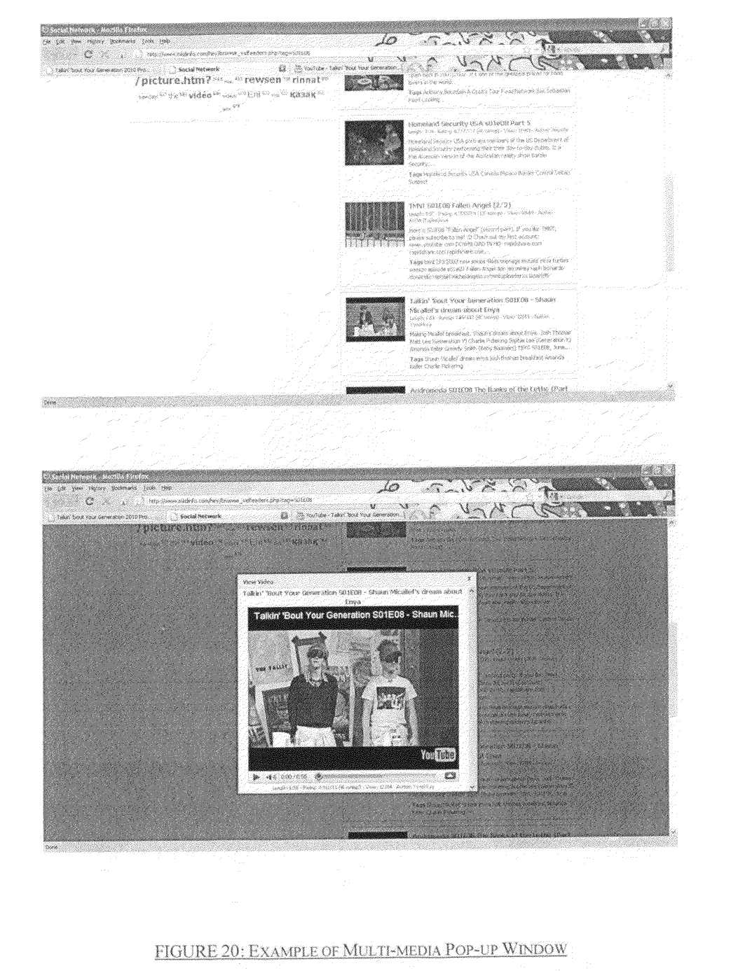

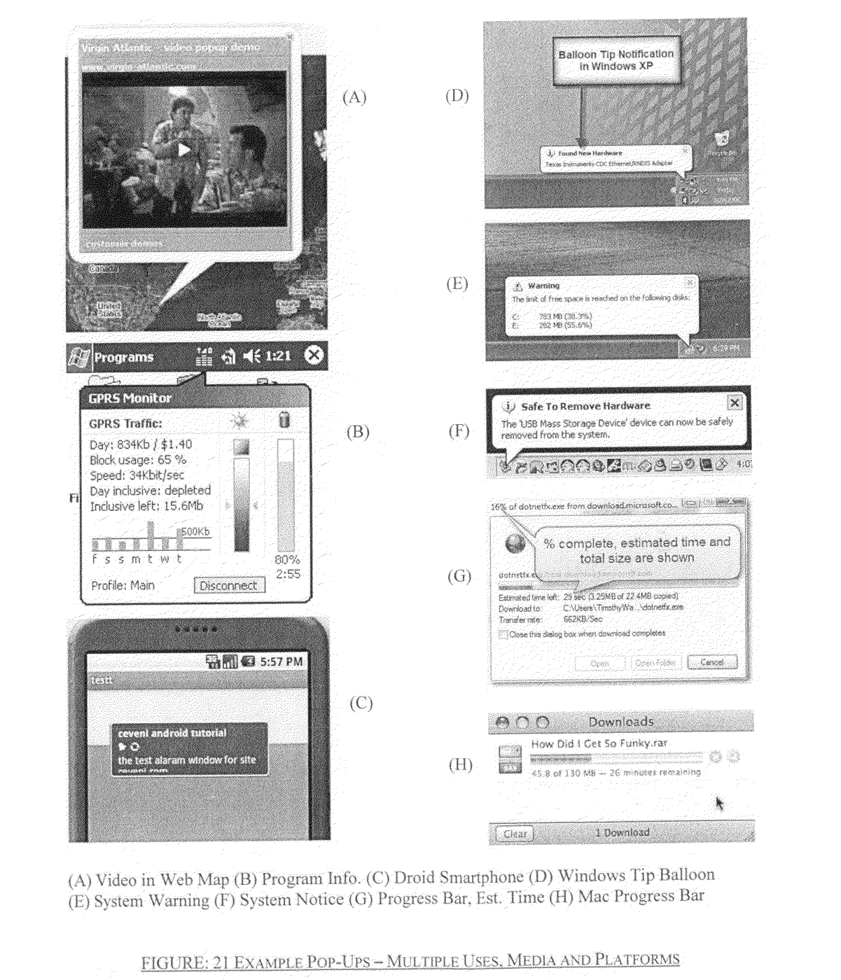

Delivery will, optionally, be in a windows-like graphic users' interface (GUI) of an operating system on a typical desktop or laptop computer; within some other application, such as a web browser, media player, inventive-service-supplied software, or otherwise; on other devices, such as smart phones, eBook readers, netbooks, iPads, etc.; or, otherwise. In particular, and especially appropriate for some embodiments of the instant invention where minimal amounts of content are delivered during very short delays, such delivery is, optionally, effected via ‘pop-up’ windows. See FIG. 20 and FIG. 21 and the text discussing them (and the text surrounding those discussions) elsewhere herein.

Focusing, now, on one non-limiting example of the granular media which would typically be presented via (410) or otherwise, a video stream is displayed of a ‘talking head’ optionally interspersed or merged with images from the films being described. The timeline (420) of the video stream depicts blurbs (for example, as shown here, brief descriptions or reviews of films) separated by grain boundaries (421). Thus, in this example, each blurb is a grain. One such grain is shown in more detail in (422, roughly comparable to 510); others are seen, for example, at (520, 530 and 540).

During presentation of any particular grain (e.g., 422), interactive opportunities will optionally be offered to the user and would include, for example:
a. to request (413) to escape or extend the short blurb into a longer full review, which review (e.g., 560, as text, video, or otherwise) will, optionally, extend the presentation beyond the system delay or other condition that prompted the presentation of the potentially shorter grain. Alternatively, the potentially longer review (or other supplementary material) is, optionally, delivered via email, stored in memory or on disk, or otherwise supplied in a way such that it can be consumed in an asynchronous or other manner that will not unduly distract the end user from a task they are, potentially, anticipated to return to after a relatively short delay. Further, the review or other supplementary material will, optionally, be displayed via the same mechanism as the blurb it is associated with (potentially, in a seamless manner), or via some other mechanism (e.g., another such window, a web page, or otherwise).
b. to request (414) the delivery of, or access to, a discount coupon (e.g., 570) or other incentive offer, which offer is optionally presented immediately, delivered via email or otherwise, delivered to a smart phone or otherwise for display at a merchant site, is printable, is forwardable for use in eCommerce or otherwise, includes a code (keyed to some combination of the offer, the user, a transaction, the inventive service, or otherwise) that can be presented at a physical merchant site or website or otherwise for commerce that is optionally electronic; etc.
c. to indicate (415) that the user is not interested in consuming the balance of the current blurb or grain of content, and wants to skip to the next grain of content.
d. etc.

The top portion of FIG. 5 depicts an alternative text-oriented version of a presentation similar to that depicted as video in FIG. 4. Here a title and instruction area (501) remains fixed at the top, optionally separated via a grain boundary and/or visually (502) from the blurbs, while a series of text blurbs (510, 520, 530, 540 . . .)—which continue (as indicated by 550) as needed until the delay or other inciting condition has been satisfied or until the string of grains is exhausted—and are separated in some manner by grain boundaries known to the system, as indicated by (511, 521, 531, 541 . . . ). The text (as shown) blurbs are presented as a scroll (continuous or intermittent), as a series of slides, or otherwise. As indicated in the example title/instruction bar, clicking on any one such blurb will trigger the offering or delivery of interactive options—in this example depicted as a full review (560) and discount coupon (570). Additional interactive features (not shown) are, optionally, offered; and, in particular, a click on an area such as (501) will, optionally, invoke a pop-up, pull-down or other menu of multiple interactive options.

Again, although these non-limiting examples are depicted as video, in FIG. 4, and text, in FIG. 5, such presentations are presented in any media including audio. Such audio presentations are conducted via audio cues to prompt the user, and computerized voice recognition of user responses. Taken together, these are sometime referred to as voice response technology.

Such techniques, technologies and systems are used for automated telephone systems, hands-free control of radio, navigation and telephone devices while driving and for other applications; and such technology is well known and within the ken of those skilled in the art. Such well-known technologies, and others (e.g., eye tracking, body-gesture tracking, inertial sensing, GPS tracking, etc.) are not in and of themselves generally the inventive subject matter of the instant invention. However, the use of such well-known (or lesser known) technologies (and their substitutes, and successor technologies later developed) to effect any combination of the inventive embodiments disclosed herein, and in the parent documents, is.

When a work of granular content is to be displayed or otherwise delivered in part, it is most advantageous to separate the media along grain boundaries—breaks between segments that will not be perceived as ‘stopping in the middle.’ As to how grain boundaries are indicated and/or embedded within such granular media, many such techniques have been disclosed in patents and applications parent to the instant application. Generally, as shown, for example, in FIG. 6, several approaches are used in any combination, including without limitation:
1. Marking within the media itself. For example, in a video program (620, comprising segments 601, 602 and 603, and frames 621-628) short fades to black, or even a single frame of black (623), could indicate a grain boundary, so long as black frames were not part of the program proper. Other less-likely-to-occur indications can be concocted which can be inserted into the media, for example: a small red area in the upper-left corner, a small green area in the upper-right corner, a small blue area in the lower-left corner, a small yellow area in the lower-right corner, for a short period, or even a single frame (626); or some other less obtrusive contrivance. Any such marker, a partial or entire frame is, optionally, suppressed from display once it is sensed.
2. Marking within an allied media stream. For example video signals (digital or analog, broadcast or files,) generally have associated with them a synchronized audio file (630, comprising segments 631, 633 and 635). Some sort of audio marker, for example, an inaudible ‘beep’ or other marker (or an audible marker, that is, optionally, suppressed from playback) is, optionally, used as a grain boundary marker (632 and 634). Such a marker optionally comprises a digital code which is, once recognized, suppressed or removed from a media data stream prior to decoding and/or playback.
3. Marking within an allied non-media stream. For example video signals can have other signals or files (e.g., sub-title, closed caption, vertical-blanking interval signal, etc.), synchronously or asynchronously associated with them (640, comprising segments 641, 643 and 645). Some sort of marker, recognizable as a grain boundary marker (642, 644), can be placed within such a signal; or, within a new signal developed for such a purpose.
4. A grain boundary marker list, similar to an edit decision list, is, optionally, produced to indicate the timing of program grain boundaries (650). That is, rather than have a synchronized signal that indicates boundaries temporally, a list of times is maintained as a separate data structure of some sort; e.g., a simple list of running times or time-codes (652, 654, 656) where the grain boundaries (651, 653, 655) occur.

A few narrative examples will illustrate, without limitation, how such granular media are to be structured, and how boundaries are to be inserted, in practice, to indicate appropriate places to segment the content.

1. STAND-UP COMMEDY (LATENIGHT-MONOLOGUES): Such presentations by their nature are strings of, for the most part, unrelated jokes. As shown, for example in FIG. 7, grain boundaries (depicted as spaces between joke boxes) are placed between each joke (711-717), for example during laughter or applause. Then, during a computer delay (725-726) a first joke is displayed (721, starting at time 727), followed by other jokes (722, 723, 724) until the delay ends (726). At that point, the joke currently being displayed (724) is completed (potentially extending the delay slightly, until 728, as depicted) and, at the next available grain boundary, the content is stopped and the program break is done. One variation is that in some such performances one joke (712) ‘sets up’ a situation that is not ‘paid-off’ until a subsequent or final joke (716). In that case the set up is played (732, starting at time 737), followed by an arbitrary number of unrelated intermediate jokes (represented by 733) and then, when the computer delay (starting at time 735) is over (at time 736), the pay-off joke is played (734). Again, the overall delay period may, in such manner, be slightly extended (until time 738), but the benefit of ending the program in an orderly fashion will cognitively make the slightly longer delay more acceptable then leaving the break with the nagging feeling that content has been left hanging.

It should be noted that, in general, by using additional memory, computing cycles or other resources, the operation of the media player that comprises the instant invention will further tax system resources and, thus, may actually incrementally add to the situations that cause the hourglass or related delays that the invention is meant to deal with. However, it is the contention of this invention that a 1 minute and 10 second delay comprising amusing or engaging content will be far less cognitively debilitating, frustrating or distracting than a delay of 1 minute and 0 seconds that is spent waiting for a computer system to become functional again. Thus, overall productivity will increase, even if the work time marginally decreases.

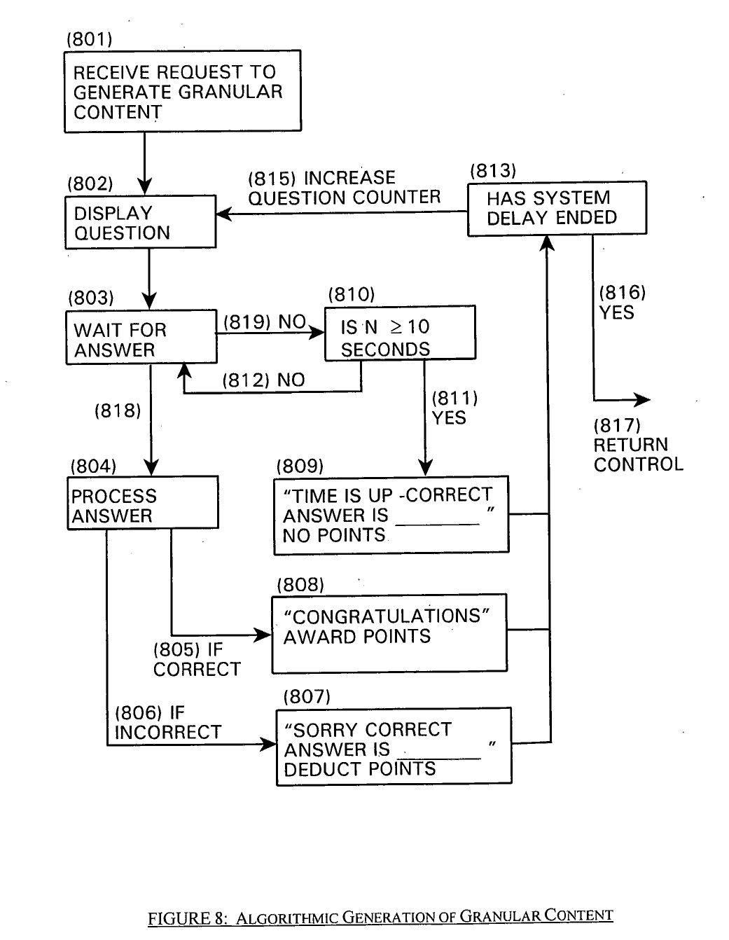

2. GAMES, SUCH AS JEOPARDY!: Such games may be handled algorithmically, as shown, for example, in FIG. 8, under program control. For example: when a delay is detected (801) a question (or, in the case of JEOPARDY! an answer) is presented (802). This may be uniformly timed (say, seven seconds), if the question is displayed as text; or, if the question is presented as audio or video, it may take a non-uniform time, say between six and nine seconds. Then, the user is permitted time (say, an additional eight seconds, via loop 803, 819, 810, 812, back to 803) to consider and enter an appropriate response and type in a free-form answer, or multiple-choice letter or number (803); the loop will be exited it the allotted time is exceeded (via 811, 809), or if an answer if entered via arrow (818) to (804). The system then processes the answer (804) and, via (805) displays either a “Congratulations, you got it right” (808) or, via (806) a “Sorry, the answer was [fill in appropriate answer]” message (807). A score is optionally updated (807, 808).

Then, if (813) the delay has ended (816), so does the granular program (817). However, if the computer is still in delay mode (814) another grain of a programmed question/response is performed (815, returning to 802) before checking again (. . . 813) to see if the delay has ended; and, so on.

Similarly, other computer games can be algorithmically doled out in granular fashion. For example: a game such as poker or chess, played against the computer, or solitaire, video pinball or slot machines, can be played where after each hand, or each move or ball, the inventive program checks to see if the computer is still in delay mode and, only if so, continues with another hand or move. Similarly, games more continuous (or have a very fine granularity of events or which have a very), such as TETRIS can be played where play is more easily interrupted more closely to the end of the computer delay. Where the, game has left off and/or score are, optionally, kept for play that is executed over a sequence of breaks separated by periods of productive computer work.

Such operation can permit employees (or, the self-employed) to take a controlled break with a diversion that, under other circumstances, could cause an open-ended distraction from work that would be objectionable.

3. PRODUCTIVE ALTERNATIVE TASKS: Although the primary focus has been on providing diversion during computer delays, it is also possible to dole out alternative productive tasks. For example, during a computer delay, a recently received but not yet read email message would be displayed, read, and then replied to or just marked as read. If the computer delay is not yet finished, the next message (the next ‘grain’) is displayed and dealt with, and so on, until the computer delay has resolved.

Similarly, other tasks (e.g., an alternative, longer-term writing or other task; monitoring of a remote babycam or other situation; etc.) can be periodically visited or be doled out over a series of breaks.

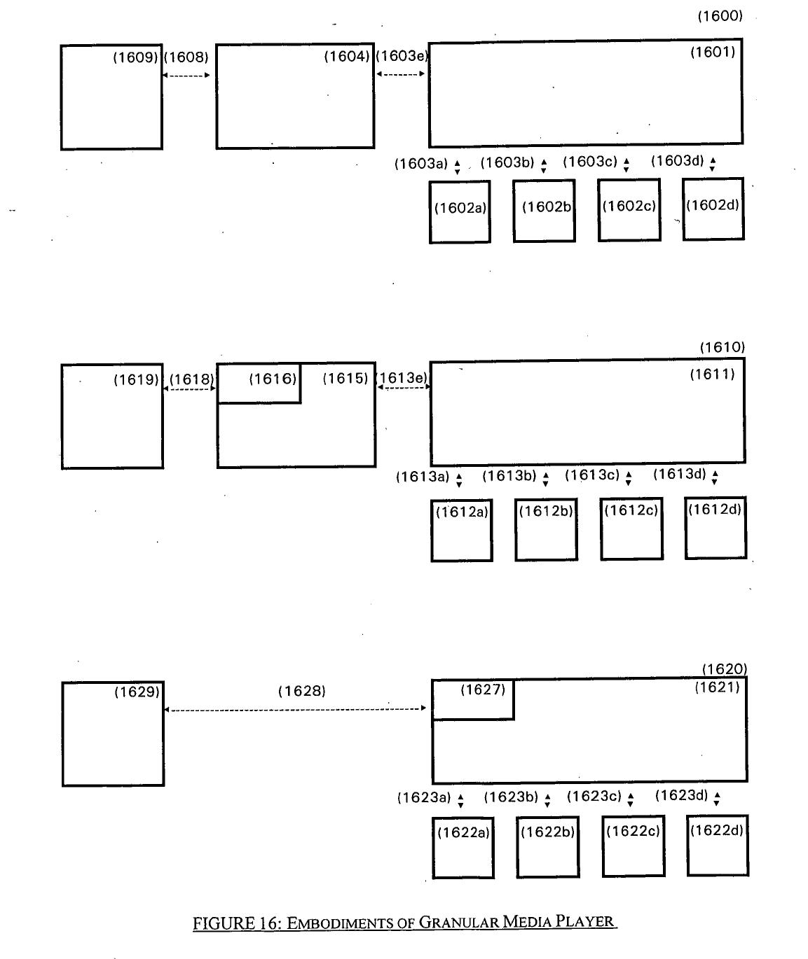

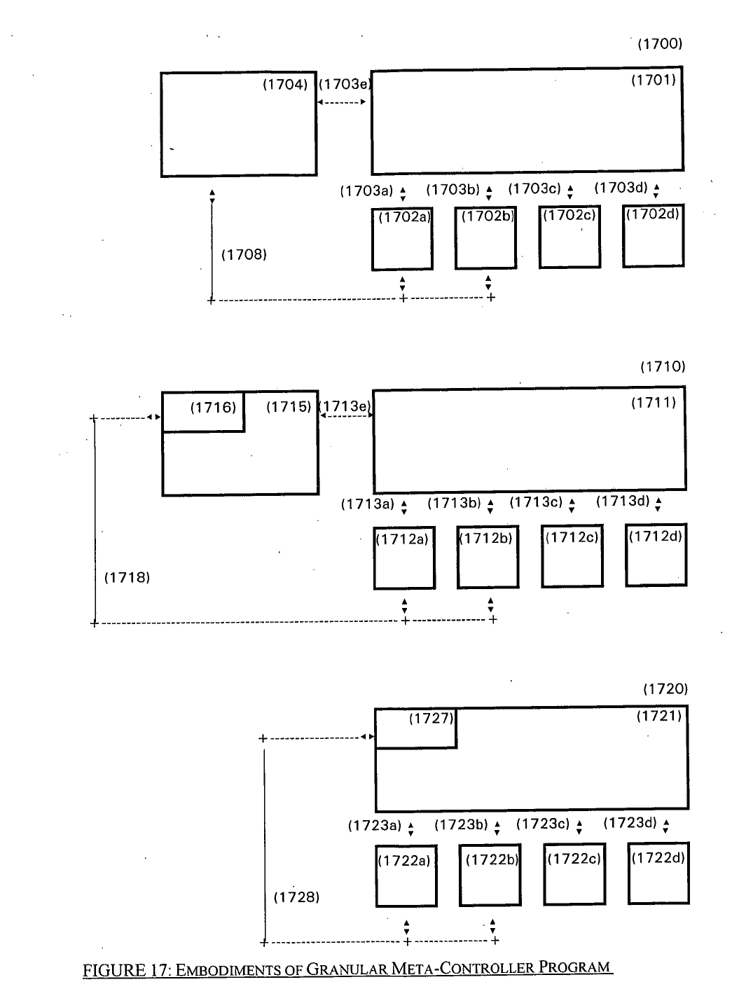

See, for example, FIG. 17, compared to FIG. 16.

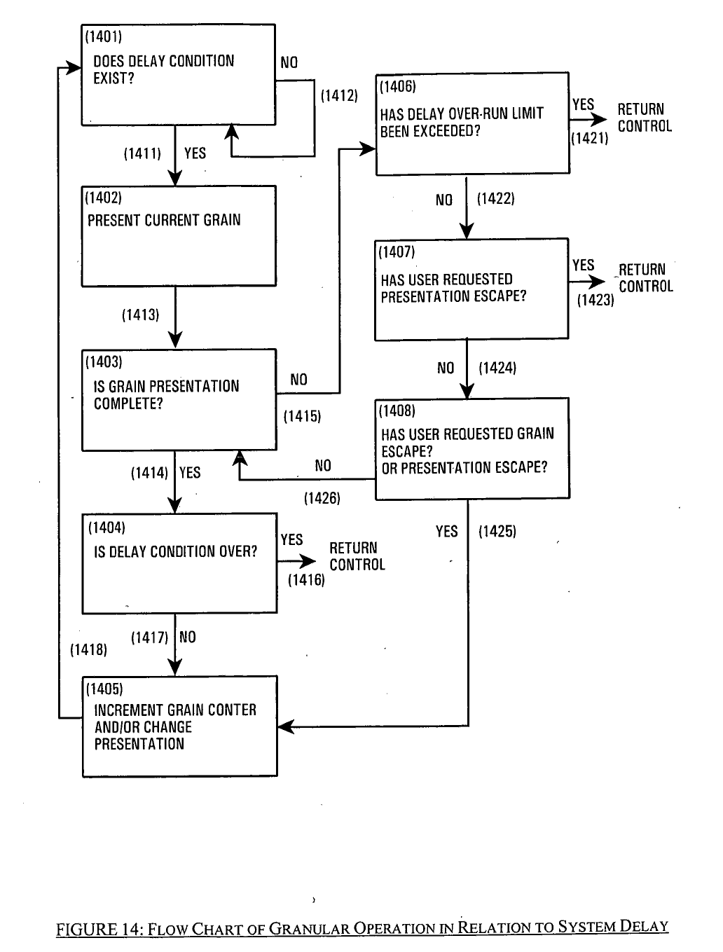

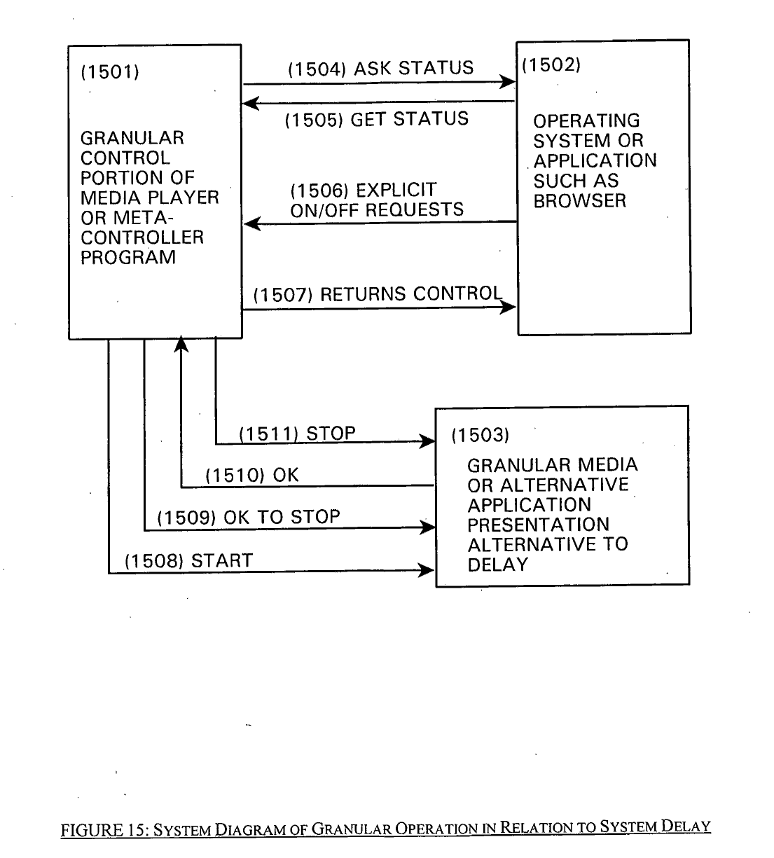

4. PROGRAM FILTER: In general, one alternative embodiment comprises a filtering- or uber-program, that will, in turn, monitor system operation and pass control to, in general, any selected application available to run in such a secondary mode, and will, during delays, permit the secondary program to be used and will, after a delay is over, switch control back to the delayed program. See, for example, FIG. 14, FIG. 15 and FIG. 17.

While it is possible for a user to manually switch to another task for these short delays there are several problems related to such an approach. First, if the computer is jammed up, without some overriding system management provided by the inventive system, it may not be practical (even if theoretically possible) to start up or even switch to another task within the computer delay period in order to be able to accomplish anything productive, or even at all. Second, if the users themselves are tasked with the switch back and forth, it is quite possible that some users will become distracted by the secondary task to the detriment of productivity with regard to the primary task. This is particularly true if the secondary task is something like a video game (or web browsing, or even email review) which may be far more engaging than some work-related task. It is for just such reasons that work systems are often locked out from operating games, or browsing, or checking personal email, by employers.

Another advantage of the inventive system is that user performance, and ratio of primary vs. secondary task time, can be monitored to ensure, for example, that users are not intentionally jamming up the system with extra applications, windows or downloads, just to cause delays that will reward them with engaging tidbits—like lab animals repeatedly pushing the red button for a pleasure shock, ignoring the blue food pellet button while they waste away.

5. GENERAL A/V PROGRAM CONTENT AND, IN PARTICULAR, AUDIO BOOKS: While videos (films, TV or otherwise) are one type of programming that is, more or less generally, amenable to being doled out in segments, another type that may be more suitable is the audio book. While some materials already consist of short segments which are ideal to granular presentation (e.g., Reader's Digest fillers; radio between musical segment fillers, such as John Tesh's Intelligence for Living; continuing micro-portioned serials, such as a novel presented in the margis of one edition of the Whole Earth Catalog; etc.) the discussion here related to longer works that are to be granularized. Either video or audio (or even text) presentations will be improved by the inclusion of grain boundaries, such that pauses come at cognitively appropriate times. However, audio books (and other media) can be formatted, edited, or even authored from scratch, to be more amenable to pausing. Further, when a ‘next’ segment starts the playback will, optionally, back up slightly to remind the user of where they were; and/or, there may be a short recap of the previous segment(s) played. Thus, careful insertion of grain boundaries, authoring of recap material, and a program that automatically backs up or inserts recap material are all optional components of embodiments that play audio books, or films/videos or other more general program content via an interstitial channel. Similarly for text books or other text works.

Referring, now to FIG. 9, there are illustrated two non-limiting examples of how segments comprising primary content and recap content are, optionally, handled. In the top illustration grains 0, 1, 2 . . . N (900, 901, 902, 903) are separated by grain boundaries (911 through 913) and contain primary content segments 0, 1, 2 . . . N (920, 921, 922, 923). In general the first segment will have no recap; although, optionally, a title-page-like introductory statement might be supplied and considered as a pre-start recap of sorts. Thus, as shown, the first cell (900) will have no recap segment. However the second cell (901) comprising primary content segment (921) will also comprise a recap segment (930) recapping primary content segment (920), which recap will, generally, be offered prior to primary content segment (921). Similarly, the third cell (902) comprising primary content segment (922) will also comprise a recap segment (931) recapping primary content segment (921) and, optionally, necessary or highlight elements of prior primary content segment(s), which recap will, generally, be offered prior to primary content segment (922). Similarly, the N^{th} cell (903) comprising the last primary content segment (923) will also comprise a recap segment (932) recapping the penultimate, N-1st, primary content segment (922) and, optionally, necessary or highlight elements of prior primary content segments, which recap will, generally, be offered prior to primary content segment (923). Note that since grain boundaries fall between cells that each, generally, except for the first, contain both primary and recap content segments, there is no convenient way to suppress or skip over recap material if the users feels it unnecessary (and communicates that to the system by general preference; or, on a work-by-work, session-by-session, or grain-by-grain basis); or, if the system automatically detects a condition to suppress recaps. Such a condition would include that the prior primary content segment had been accessed by the user within some time period considered short enough to not require recapping; and, in particular, if several primary content grains are presented sequentially with essentially no break between them.

In an alternative embodiment example, two separate streams of granular content are created, one with primary content grains (940), and one with recap content grains (950). Each stream of cells, segments, grains and grain boundaries are structured in a manner similar to the previous example. Then, for any particular grain presentation, the corresponding recap grain is, optionally, presented or not, depending upon conditions similar to those discussed in the previous example, and is then followed by the corresponding primary content grain.

In yet another alternative embodiment example (also not shown, but which is similar to the next illustrated embodiment, except that only one style of recap is made available), primary content grains and recap content grains are interleaved. Then, as it is decided to present each new content grain, the recap content grain is presented if the conditions warrant it, followed by the corresponding primary content grain; otherwise that recap content grain is skipped over, and the following primary content grain is presented immediately.

In yet another alternative embodiment example, cells (950-958) separated by grain boundaries (960-969) comprise of primary content grains (970, 971, 972), which are each (except, optionally, for the first) preceded by several styles (a, b, c, as shown) of recap content grains (980a, 980b, 980c; 981a, 981b, 981c). For example: one style (a) is composed of a quick recap of the preceding primary content segment only; a second style (b) is composed of a more extensive and details recap of the preceding primary content segment only; a third style (c) comprises necessary highlight material from segments prior to the preceding primary content segment, and is optionally presented prior or subsequent to, or in lieu of, either of recaps (a) or (b); other styles (not shown) optionally integrate both recent and long prior material into a single recap, bring in ancillary information not directly part of the primary work, etc. Then, depending upon user preference and/or circumstances surrounding the time delay between presentation of sequential grains, the appropriate type(s) of recap grains is/are selected from among these styles of recap (including the option of no recap) and presented prior to the primary content segment.

Alternatively, such recapping functions can be supplemented or replaced with: 1) simply backing up the presentation into the tail end of the prior string of primary content grain(s); or, 2) presenting some more sophisticated sampling of prior content effected through the use of some mechanism similar to an edit decision list (as described in parent documents, either integrated with primary content or available as an associated but separate information structure) which will, optionally, present several alternative versions of recapping information, such as discussed in the previous example (a, b, c, etc.).

6. EDUCATIONAL MATERIALS: In general audio, video or textual (with optional graphics) educational materials (and, in particular, corporate or work related training materials) can be treated, in general, as other such materials. However, review materials and, in particular, flash-card-style review materials, are particularly amenable to granularization. In particular, such materials can be combined with user monitoring functions that track user progress, and which adaptively cull those materials mastered and/or stress those not yet mastered. Such tracking and adaption can be applied in a simple and straightforward manner, or is optionally implemented in a more sophiticated manner, as is disclosed in parent documents.

7. STRESS RELIEF MATERIALS: In as much as the instant invention is intended to address “Hourglass Syndrome . . . the frustration that stressed computer users are facing as they watch the little hourglass spin while waiting for the program to open or a website to load,” the invention can more directly address this problem by offering content specifically intended to provide stress relief. First, music can be provided: any that the user selects, but classical and, especially, new age' or meditative music is particularly effective for stress relief. Because only a segment of an arbitrary length will be played, the sound is optionally faded up and, even more particularly, faded out from. The fade out, in particular, may be rather long and gentle, and the music may continue, optionally at a reduced volume, during normal computer operation. Similarly, grain boundaries are utilized to indicate times when the music can be discontinued entirely, without the cessation seeming jarring.

Second, the user may be taken through guided meditations or visualizations—generally to be done with the eyes closed or, optionally, with still or moving graphics supplied by the inventive program. Again, the exit in particular may be somewhat slow and extended: even if this prolongs the delay slightly, the resulting benefits will, on balance, overcome any additional temporal overhead.

Third, during delays, users will be encouraged and led—via audio, video, text or graphics—to perform some stretching or other physical activity. In this way, tension and stiffness is relieved or reduced in hands, neck, back, hips, knees, feet, eyes (exercise directions may be as simple as looking up from the screen at some object in the distance, or closer than the screen), etc. The short-term benefits will be to make the user feel refreshed and less tense and will, generally, benefit work. Long-term benefits to health and the avoidance of chronic physical problems (e.g., periodic cessation of typing in favor of hand and wrist exercises to help avoid carpel tunnel syndrome, as well as hourglass syndrome). Exercises need not be complex, prolonged or particularly strenuous to be beneficial; and, may be as simple as standing up, stretching, neck-rolls, finger and wrist flexing, etc. Again, warm-up and cool-down periods may be included, as well as grain boundaries, so that such mini-workouts do not jar physically. Any such program should be developed in consultation with medical or physical training professionals, and users should be appropriately warned or screened, if necessary; and, obtaining releases (even if just scroll-and-click) may be beneficial or necessary.

8. Music: Independent of stress-management, music (or other audio programming) can be handled as described just above. In particular, the program may continue throughout computer use at a reduced background volume, with the volume increased during delays. Again, the use of grain boundaries are optionally used to time the fades. Once the inventive program notes the hourglass-type delay has ended and that supplied program content will be faded and/or soon end, it will, optionally, signal the user visually or audibly (e.g., with a soft chime or other consistent sound). This technique is, optionally, applied to any embodiment explicitly disclosed in, or adapted from, this application. Further, particularly if the music is algorithmically generated (or processed, such as processing that can change the timing of audio without effecting pitch) the music or other program may be slowed during breaks and sped up slightly during work (for just one non-limiting example) to help appropriately and beneficially promote alternation of periods of focus or attention with periods of relative calm and relaxation. Other processing or sequencing of audio or other content to achieve psychological effects, now known or later developed, are optionally combined with, or incorporated into, the instant invention and such is intended to be within the scope of the instant invention.

These examples are not meant to be exhaustive or limiting in nature. Other types of content, specific applications, embodiments, and variations are within the scope of the instant invention. In particular, it will often be an object of the instant invention to provide idiomorphic content (and advertising)—that is, content (and advertising) geared (selected, formatted, edited, etc.) to the specific idiosyncratic interests and/or other preferences of the end-user. Nevertheless, the subject matter being worked with (or, in particular, searched for)—and in particular the subject of web pages (or other network resources) being worked with, if the delay is due to a delay in downloading such materials—is also, optionally, used to select content and advertising. However, it is acknowledged that, in general, it is intended that idiomorphic selection (at least in part) is preferred over strictly work- or search-related selection.

As is described elsewhere in the instant application and the parent documents incorporated herein, a primary goal of the invention is to provide custom granular content to many users, by expending an affordable amount of collaborative human and computer effort. The overall process is diagramed in FIG. 10. Unlike with some system diagrams, where boxes correspond to nouns or things, and arrows refer to verbs or processes, the boxes in FIG. 10 can refer to objects or precesses. Generally, the arrows show where information is transferred from one box to another.

Data (1030) is collected regarding user demographics (1033); as well as user preferences and interests (1034) for: content, presentation style and advertisements; ownership, use and interests in products, various media (including internet and social media); etc. Data is collected directly from the user (e.g., during sign-up and later updated); extracted and inferred from user use of the inventive services (and other media) or other behavior which can be tracked or monitored; monitoring or mining of cookies, search histories and other similar sources, internet sources, social media, statistical inferences from preferences of users with similar likes, or use/behavior patterns; etc.

In some embodiments of the instant invention the user will be identified by a user name, code or otherwise, and such user-related or profile information will be retrieved based on that identification of the user. Alternatively, in other embodiments of the instant invention (or for use in other inventions) the user system will instead upload user profile information separate from (and, generally, without) the user identity, so idiomorphic information (or other personalized services) can be delivered without user identification. This will permit ‘guest’ or confidential usage of such systems. A standardized user profile will enhance the ability of diverse systems to interact with, and supply idiomorphic product to, users of any such system.

This data is used as part of the process to select (1060) advertisements and content snippets for inclusion in the user's idiosyncratic (or personally customized) package of program material (1090), which is delivered (1091) to the end-user (1080) as an assembled program or in parts.

Although as described herein and in the parent document(s) such idiomorphic (customized) media is assembled in a personalized fashion prior to delivery, any such embodiment will, optionally, be adapted to operate in such a way that a super-set of content, advertising and/or other information is delivered or supplied, and the idiosyncratic editing, formatting or other preparation for customized presentation is performed, in whole or in part, after delivery, during presentation, locally, or otherwise.

Further, particularly if the inventive system is operating as part of a web browser, or on a system where a web browser is in operation, the content of web pages being visited (or the content and operation of other applications on the system) will, optionally, be used to further refine the selection of what materials (generally, from a large amount of materials supplied by the service), both content and advertisements, are presented. The selection of materials offered will also, optionally, be refined prior to delivery and/or supplemented and updated after delivery, in real-time, or near-real-time, by the inventive service in response to these and other factors, including the needs of users, advertising clients, or otherwise.

Advertisements (1050) are supplied from a number of agency or direct client sources, optionally via web or other fully or semi-automated request or submission. That is, a request for insertion with a finely-tuned and defined target population, number of repeats, etc. (1053) is submitted, together with media, optionally including interactive data and alternative media for additional information and purchase requests made by users (1052); or, is submitted as a request to use advertising media that has already been supplied to the service. The requested target data (part of 1053) is matched against user data (1030, via 1031), and exact or close matches (within some threshold distance in a multidimensional target-feature space; or matching some optionally weighted minimum number of features, etc.) are made available for that advertisement (1070). Also, pending scheduling of advertising space/time for that same user is taken into account, when multiple advertisers/advertisements compete for the same user demographic. Additionally, what content items are currently selected for that user package (1060, via 1061) will also, optionally, be taken into account when selecting advertisements (1070) for inclusion in the idiosyncratic package (1090). For one non-limiting example, an ad for gardening supplies will be included with a program segment about preparing gardens for spring planting, preferentially over other user factors; and, that same ad will also optionally be targeted (optionally a second time, if received as per the first criteria) to users interested in gardening, regardless of whether they are receiving that particular gardening program segment.

In a second major process stream raw content (1000) is entered into the system. Such material is obtained from any combination of: content producers, owners, publisher, micropublishers or sources, via paid acquisition, strategic partnership, paid insertion or other arrangement; content submissions by individuals and business or other entities; as well as questing for content from print, television, radio, telephonic, internet, web, social media and other sources by: humans (staff, stringers, users, guests, etc.); human/computer collaboration; automatic analysis of text, audio, closed captions, video, etc.; data mining or inference from searching external sources, such as www, social media, blogs, etc.; or any other means.

The content so collected, including content submitted by individuals (which will, optionally, be vetted by the inventive service), will optionally be organized into an index, catalog, or other, optionally, searchable structure. Users will, thus be able to access such a ‘grain cloud’ (by downloading a catalog, visiting a web site, or otherwise) and, optionally, select their own content specifically and explicitly, as an alternative to providing preference information to guide the inventive service to make specific content choices on behalf of the user. Features such as ‘show me content similar to ______’ or ‘show me content selected by people who selected ______content’ will, optionally, aid the user in such selection.

Unlike with typical ‘news’ organizations much of the content supplied by the inventive service will be ‘feature’ material that does not necessarily need to be as topical. Thus, as material is collected, abstracted and/or granulated, it will be useful to keep track of what material a particular user has received (or what users a particular parcel of material has been distributed to) so that unintended duplication does not occur. In this way, as time progresses, although fresh and topical material will be added to the library of materials, it will, optionally, be the practice to rely upon a growing library of granular materials to offer users (particularly new users) on an initial and ongoing basis. Based on explicit requests, or monitoring of patterns of user preference and use, filtering this vast reservoir of material to select a subset to offer an individual user based on their preferences, will be an ongoing and progressively refined process.

The raw content (1000) is analyzed (1010) using information from sources and by techniques as just described with regard to content acquisition. The analysis (1010) is carried out by a combination of human, automated and Al computer, and human/computer collaborative means, as shown in and discussed in detail elsewhere in this and related applications and patents. In particular, information is developed relating to, without limitation: tagging incoming media for content subject matter (1012) to be compared with end user interest (1034) to create what is generally referred to elsewhere herein as personalized or (optionally, together with abstraction) as idiomorphic content; creating alternative snippets (e.g., via edit decision list “EDL (1013)” generation, or otherwise) of distinct running times, levels of detail, and/or slants of user interest/relevance—generally referred to elsewhere herein as abstraction; and for identifying and specifying media content grain boundaries (1014) used to create what is generally referred to elsewhere herein as granular media. All of these techniques are described in more detail elsewhere herein, including in the related applications and patents.

The result is that, for a multiplicity of incoming raw content items (1000), processing generally results in a multiplicity of different versions and/or segments which are created (1020) via optional transcoding between various media (1022), formatting (1023), abstraction (1024), granularization (1025), or otherwise. These media items, segments, snippets and/or versions (1040) are tagged, for content subject matter, timing, etc., by a combination of human judgment and computer processing (1010). The tag information (1010 incorporated via 1020 into 1040) are similarly matched (on an absolute, feature-space distance, weighted threshold, or other basis) with user ID & preference data (as well as historical data of what has been sent to a user, and their reaction to it, etc.) (1030) in order to select which snippets are to be included (1060) in a particular idiosyncratic package of material (1090). Again, content selection (1060) influences ad selection (1050) and, optionally, vice versa. (Although, it is acknowledged that undue advertiser influence on content selection is counter to an intended basic tenet of the inventive products and services as delivered to the end user.)

The idiosyncratic package of content (with optional advertisements) (1090) is sent (1091), generally via network, such as the internet to a PC, or mobile broadband to a smart cellphone or netbook, or via cable, telco or satellite to a TV, to the user's display device (1080); or, is delivered on CDROM, DVD/ROM of otherwise; or, is downloaded to an intermediate device, such as a PC, for in-house transfer and download to a mobile device, such as a smartphone. The entire, or parts of, the package are also, optionally, sent on a streaming or real-time basis via some network.

As discussed elsewhere, and in particular, with regard to the top of FIG. 4 and FIG. 13, during display, the user will optionally make requests for more information (to supplement content, or regarding an advertised product including promotional materials), or to conduct eCommerce transactions (including purchases and/or redemption of promotional materials). Some of that supplemental information is, optionally, already included within the package, or otherwise already resident on the user's device. Other information will be supplied by some server (operated by the inventive service, or some commerce or advertising client's site, for example) to the user's device on an as-requested or (near)-real-time basis. Still other requests will be filled by supplying additional information (an email tickler, video, .PDF catalog, coupon, etc.) to the user's email address or other destination, rather than to the device currently being used; although, in such cases, an acknowledgment of fulfilment or receipt will, optionally, be sent to the device from which the request was made.

It is noted that, in addition to submission from content partners or other sources, on a repeated, occasional or one-time basis, additional items of raw content will be identified, and all content optionally will be tagged, edited, or otherwise analyzed and/or processed, via: humans (staff, stringers, user feedback); human/computer collaboration; automatic analysis of text, audio, etc., by AI, etc.; mining or inference from trawling external sources, such as WWW (e.g. Wikipedia, search engines, directories), social media, blogs; media or news aggregation sources including newsletters or columns; etc.

FIG. 11 and FIG. 12 depict, in non-limiting examples, two approaches to handling the sharing of personal end-user customer information with paying advertising clients, as is also discussed above. It should be noted that the use of the word ‘client’ in this instance, and in some instances elsewhere in this and the parent documents, is used in the general business sense, like customer. This is distinct from the computer science technical use of the term (which is also used herein and in the parent document(s)), as in ‘client/server’ interaction between two networked computers in a particular relationship where, generally and typically, information is intentionally supplied from the server (often running on behalf of a commercial or institutional organization) to one or more client programs (often running on behalf of a customer or consumer of information). For example, a web server will distribute, generally at the request of any web client (e.g., a web browser program) information resources including web pages, images, video and other media files, etc.

FIG. 11 depicts a highly typical relationship between a commercial service bureau (1101), such as a search engine service; an end-user client (1102), generally receiving the service free of charge; and, a third party (1103), generally a paying client advertiser whose advertisements or other marketing information are directly or indirectly displayed, or otherwise delivered, to the end user. Although not separately shown, it is often the case that another party, such as an advertising broker or arbitrager will be involved delivering advertisements, optionally in a near realtime basis, auctioning or otherwise offering available advertising space to interested advertisers on the basis of availability, willingness to pay, and often including whatever demographic or other information about the users (1102) is available. In such a typical relationship, personal or other sensitive information relating to user demographics, identification, searching habits, website visitation habits, eCommerce habits, etc., are made available for the benefit of the third party (1102), the enrichment of the service bureau (1101) (and, optionally, any advertising broker involved), and to the general annoyance of (although theoretical benefit to) the end user, by receiving advertisements they will be particularly susceptible to.

Such information is, in some circumstances, collected as a result of direct query; as the result of conducting eCommerce, user registration, or a survey; via collecting and storing such information as a ‘cookie’ (often by a web browser program) which is, optionally, made available to other organizations, or otherwise. The user is often unaware, or unable to control in a reasonable manner, such activity by such online organizations. One particular problem with such practices is that information collected is sometimes tied to a particular system, or program, no matter who is using it, rather than to a specific user. So, not only is such information use often obtrusive but, potentially, is not even correct information, which is not beneficial to any of the parties involved.

Such personal user information, optionally including contact information, will, generally, be collected from a multiplicity of service bureau or other (1101) organizations, including advertisement brokers. Some such information will be supplied (1105) (overtly, as part of registration, part of eCommerce, or otherwise) by the user (1102) to the service bureau (1101), which is, in turn, shared with other parties (1106) for their own various uses, generally in exchange for a fee (1107). Such uses include, for just one non-limiting example, the sale of contact information as part of a mailing list, more often these days as an email address list. Such lists are used to distribute (1110) legitimate, if not necessarily welcome, marketing information or out-and-out spam to users (1102). Such information so collected and shared is not limited to contact information but will, optionally, include information about demographic identification, searching or purchasing habits, etc.

Other information will be supplied (1104) by a particular service bureau (1101) to be stored as a tracking or other cookie, or otherwise, on the user system (1102). Such information often comprises information about the user's searching and/or purchasing habits, for example, or otherwise and will also, optionally, include contact, identification or demographic information. Such cookie information is then retrieved (1109) from the user (1102) by a third party (1103)—which, although not separately shown in this figure, in some instances will be the original service bureau (1103)—to be used to select and supply specific advertisements or other information (1110) to the user (1102). Many diverse such entities (1101) will, typically (attempt to) store such tracking or other cookie information (1104) on any particular user (1102) system. As just one example, if a user has recently visited an online site selling vitamins, and in particular, if they have viewed information about a specific item, but have not purchased it, a number of different websites will (optionally, via an ad broker) display ads about the online site in question, optionally featuring the specific item the user expressed interest in. Such ‘reminders’ will, it is hoped, close a deal for a purchase that is being considered by the user. Such use of cookies, or other use of shared information, will also, optionally, result in a fee being paid (1108) by the third party (1103) to the party sharing the information (1101). Parties will, optionally, cross-share information, or provide other services in return, in lieu of payment.

Turning now to FIG. 12, the inventive service (1201) is, generally, intended to operate, in many embodiments, in a manner that will protect the users (1202) of such a service from unwanted and unintended contact with, and reception of material from such third parties (1203) who will, in this case, generally, be paying advertising (or other) clients of the inventive service (1201).

It is intended that the inventive service bureau (1201) will collect (1204) from its users (1202) extensive personal information that will, optionally, include: detailed preference information in many areas, including preferences for reading, film, television, music, travel, leisure time, etc.; what products and devices are owned, and services are used, by the user, potentially including models and, optionally, serial numbers; contact and address information; credit card and other financial information in order to conduce eCommerce; etc. Such information will be provided (1204) by users (1202) to the service bureau (1201) willingly, in as much as many of the inventive services to be provided (idiomorphic content and advertising; one-touch eCommerce, etc.) require such detailed and candid information sharing. It will, thus, be an essential element of such a service (1201) that the information (1204) provided by users (1202) and held by the service bureau (1201) be treated in a processional and confidential manner. In order to adhere to such standards and still perform the kind of advertising, marketing, eCommerce and other functions that will be essential to financially supporting the service (1201), and reducing or eliminating costs to the user (1202), the following alternative information sharing structures will be used. This figure and discussion are presented as non-limiting illustrative examples, and a guide to the principles of how such features are to be implemented, rather than an as an exhaustive and comprehensive list of every possible manner in which such user information will be utilized and handled between the inventive service bureau (1201), the users (1202) of the service, and the third parties (1203) who are generally paying advertising (or, more generally, marketing, sales or promotional) customers of the inventive service.

First, note that user information (1204) is held in confidence by the inventive service (1201), and it is that service that matches marketing information (e.g., advertisements) (1205) with user information (1204) to select and provide only that marketing information which will be of interest to users (1206). That is to say that the set of users that an advertiser will want to reach, and the set of users that will be interested in an advertisement, will not be the same; and, first, the primary allegiance of the service (1201) will be to its end user customers (1202) over its advertising clients (1203); and, second, the set of users actually interested in receiving information about a product (i.e., a pre-qualified audience) is a highly desirable ‘demographic’ of users to the advertisers which they will not otherwise, generally, be able to reach easily.

Second, note that in more usual circumstances, when a user clicks on a banner advertisement for more information, makes an eCommerce purchase, or has some other interaction with an advertiser or online marketer, that party then has some way, via a cookie, email address, credit card number, or other information, to maintain or initiate other contact with the user, which contact will not necessarily be welcome and may be considered to be spam.

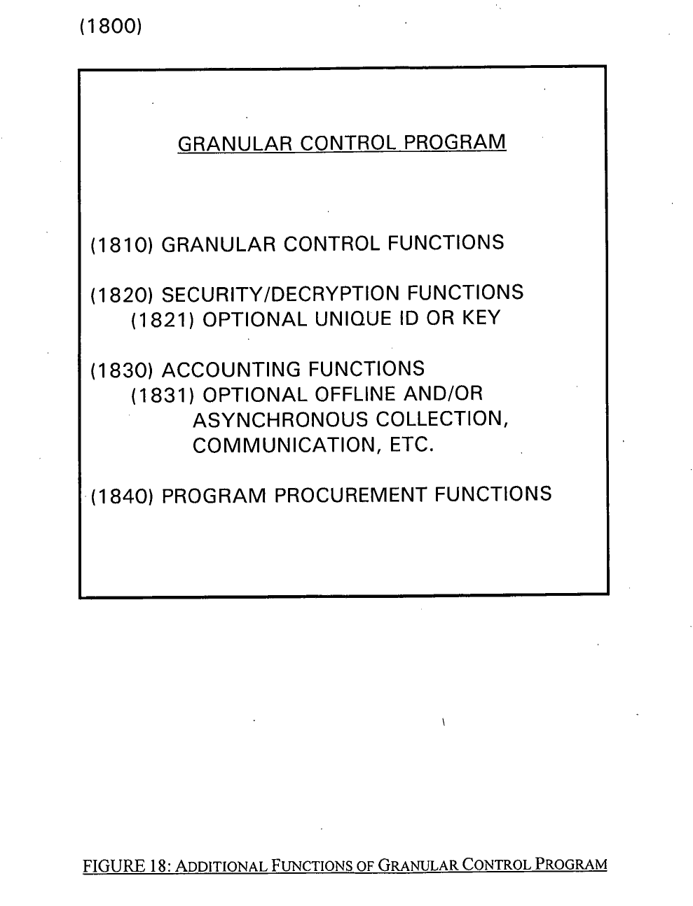

With the inventive service, such contacts will be offered in an anonymous way. For example, in response to an advertisement (1205) sent from the advertising client (1203) via the service bureau (1202) and selectively forwarded to (1206) the user (1201), the user will, in some circumstances, ask for additional information, for example by clicking on such an advertisement. Rather than such a request going directly from the user (1202) to the third party (1203), with the inventive service a secure request for additional information (1207) will be received by the service bureau (1201) from the user (1202) and anonymously passed on to the third party advertiser (1203). The third party advertiser (1203) will then, in response, pass back an appropriate reply (e.g., a more extensive advertisement, a catalog, a discount coupon or other promotional incentive, etc.) anonymously (1209) via the inventive service (1201) to be passed on securely (1210) to the user (1202). In practice, such additional information (e.g., more extensive advertisements, catalogs, discount coupons or other promotional incentives, etc.) will, optionally, be kept on hand by the inventive service (1201) and passed on (1210) to any user (1202) who requests them (1207) without having to involve the third party (1208, 1203, 1209) at all; saving both time and expense. Since the third party (1203) will not have access to personal user (1202) information (1204) there is no advantage to them to be involved in each such transaction; and, further, accounting of such supply (1210) by the service (1201) to the user (1202) will be accounted for to enable accurate billing and payment between the service (1201) and third party paid advertising, or other clients. See, for example the discussion regarding element (1830) of FIG. 18, and elements (1363 & 1364), in particular, and FIG. 13 generally.

Also note that eCommerce transactions can be handled by the same secure/anonymous mechanism as just described. With digital computer software, films, television programs, music, and eBooks and eMagazines, the product itself can be handled fairly simply, as just described, with the product comprising the ‘additional information’ to be delivered. When physical goods are to be supplied in such a manner, the procedure will be a little more complex. The service bureau (or, a sub-contractor) will, optionally, act as a fulfillment center, collecting credit card or other, generally electronic, payment from users and passing funds on to the third party. Alternatively, some sort of ‘Chinese wall’ or trusted department within the third party organization will be set up to handle physical fulfillment of such eCommerce transactions where the inventive service was involved, in order to ensure that no inappropriate (based on these generally more stringent restrictions) use is made of user contact, or other, information.

End users will still be able to initiate direct, generally two-way, contact (1211) with the third parties supplying advertising, discount coupons of products via eComerce or otherwise. However, such contact will be governed by the third party (1203) and not the service bureau (1202) and will, generally, open the user (1202) to potentially unwanted follow-up, or other use of user information, by the third party (1203) or its affiliates. Such circumstances would potentially include, without limitation, product registration or activation of a purchased item, customer service or return with regard to a purchased item, fulfillment of a discount coupon, eCommerce purchase, or any other transaction or communication carried out directly between the user (1202) and the third party (1203) rather than via the service bureau (1201). In the event that any such insecure transaction is initiated within the confines of the system or display provided by the inventive service, great care will need to be taken in order to notify and make it very clear to the user that such communication or transaction is not secure.

These non-limiting examples of information sharing are meant for illustration purposes only and are not meant to be comprehensive.

Referring now to FIG. 13, this figure illustrates the interaction between the service bureau (1310) offering content, advertising and eCommerce products and services based upon embodiments of the instant invention, paying advertising clients (1330), and end-users (1320) who generally receive content for free in exchanging for also receiving advertising and marketing information. (In other embodiments, end-users may pay for a free, or reduced advertising, version of the service.)

The service bureau (1310) delivers (1341) primary program content (1311) which, although optional, will generally include advertising content (1312), which is what is under discussion here, generally including interactive components, to the end-user's system (1320). The end-user's system (1320) will have facility to display program and advertising media content (1321) which may comprise text, graphics, audio, video or otherwise; and will also have facility to display interactive media components (1322) which may include, without limitations, hot-links, clickable icons, etc., capable of sensing and relaying user requests. Delivery (1341) of advertisements (1312) to end-users (1320) will be accounted for (1315) for later billing or invoicing (1363) to the paying advertising client (1330).

When interactive components are activated by the user (1322), as for example by a mouse click, touch-screen gesture, voice recognition request, or otherwise, that request is relayed via (1342) back to the service bureau (1310). Such requests include, without limitation, requests for additional information (1313) related to the content of the advertisement and which will, optionally, further include a discount coupon or other marketing incentive (1314). Such additional information is delivered (1343) to the end-user (1320) by the service bureau (1310) in response to an interactive request (1342). Such delivery will, optionally be: delivered directly to the user's system specifically in response to a request (1341); or, as part of the overall content delivery, and is, optionally, delivered as a default, waiting for local activation in response to the request (1322), which may be at any time, even when the user is off-line or disconnected from the service bureau, and/or is optionally offered (for a first time or again) even without an interactive request; via email, text message, cellphone or smartphone, or any other electronic delivery; or, any other delivery mechanism, even including hard-copy by physical mail. Delivery (1342) of additional information (1313) and/or marketing incentive information (1314), to end-users (1320) will be accounted for (1315) for later billing or invoicing (1363) to the paying advertising client (1330).

If such a marketing incentive (1314) is delivered (1343) to the end-user (1320), it will, in many cases, eventually be presented to (1351) the adverting client's business (1330) for redemption, with optional confirmation (1352). Such presentation my be via electronic means, including without limitation: electronically, via interactive link (1322, as shown), or email, cellphone or smartphone, or otherwise; or (other means not specifically shown), optionally, by printing and presenting a physical ‘coupon’ to the business (1330) physically or otherwise; by presenting a hardcopy coupon received in the mail, physically or otherwise; by presenting an image (optionally, including an alphanumeric code or barcode) of the coupon via the display of on a cellphone or smartphone; by presenting (by any means, physical, electronic, visual (e.g., an alphanumeric code, barcode), verbal, keyed, touchpaded, interactively, or otherwise) a ‘code’ or other designation received by any of these means; or otherwise.

If an indirect coupon redemption (1344, 1310, 1361, 1330), is initiated from the end-user's system (1320), as the request passes through the service bureau (1310) the transaction will, optionally, be accounted for (1315) for later billing or invoicing (1363) to the paying advertising client (1330). If a direct coupon redemption (1351, 1330), is initiated from the end-user's system (1320) a notification (1345) is also, optionally, made by the end-user's system (1320) to the service bureau (1310) such that the transaction will, optionally, be accounted for (1315) for later billing or invoicing (1363) to the paying advertising client (1330). If the ‘coupon’ is presented by some other means, a record of such—optionally including some alphanumeric code, barcode or other designation that will identify, for example, a particular redemption program, specific end-user account, or specific transaction between end-user and service bureau (including, for example, what advertisement or other information triggered delivery of the coupon)—will, optionally, be passed back (1362) from the advertising client's business (1330) to the service bureau (1310) such that the transaction will, optionally, be accounted for (1315) for later billing or invoicing (1363) to the paying advertising client (1330).

In response to an interactive request (1322, 1344), or other request initiation not necessarily shown, which will, optionally, be initiated from information in an advertisement (1312), additional information (1313), marketing incentive or promotion (1314), or otherwise, the service bureau (1310) will pass on an eCommerce request (1361) to the advertising client's business (1330). Such a request will be accounted for (1315) for later billing or invoicing (1363) to the paying advertising client (1330). Alternatively, such a request will be passed directly (1351) from the end-user (1320) to the advertising client's business (1330), with an optional confirmation or receipt returned (1352). In that case a record of the request will, generally, also be passed back (1345) from the end-user (1320) to the service bureau (1310), or passed back (1362) from the advertising client's business (1330) to the service bureau (1310), to be accounted for (1315) for later billing or invoicing (1363) to the paying advertising client (1330). A customer, transaction or other code will, optionally, be included within an eCommerce transaction to be used in a manner similar to the ‘coupon’ code as described above. In particular, while fees for delivering advertisements, additional information, marketing incentives including coupons, may be fixed, fees for electronic commerce will, optionally, be tied to the items purchased and/or amount spent. Such eCommerce transaction information will also, optionally, be included in such communication (1362) to the service bureau (1310).

In response to periodic billing or invoicing requests (1363) the advertising client's business (1330) will pay funds (1364) to the service bureau (1310) electronically, or otherwise.

FIG. 14 and FIG. 15 depict a flow chart and system diagram, respectively, for the basic alternative, optionally granular, presentation of media or alternative application during a system delay. Non-granular media and non-granular alternative application presentations can also be controlled by this mechanism, but do not have the benefit of continuing to a cognitively appropriate break point in the presentation, prior to returning, after a provoking delay or other condition (e.g., a distracting video, or blocking, advertisement is running its course on a web page) has ended.

In FIG. 14, the first step is to determine if there is a system delay or other condition that warrants granular (or non-granular) alternative presentation (1401). This may be achieved by polling the various applications active on the system to see if any are in a delay state; by querying the operating system, or other program (e.g., a web browser) where delays will be filled with granular presentation; by checking a status flag set by the operating system, browser or other program; waiting to be explicitly called into operation by the operating system, browser or other program; or, by any other mechanism appropriate for a particular embodiment, operating within a particular operating environment, on a particular platform. A condition other than an hourglass may constitute the provoking condition. For just one non-limiting example, a browser will be equipped with a plug-in or other enhancement to monitor display of advertisements; for example, a short video being played prior to the longer requested media, or that the web page is displaying a substantially full-screen blocking advertisement, etc. Such advertisements will be identified by their duration, size, location, file name, supplying domain, or otherwise.

(Some embodiments will contain software routines that not only detect (optionally using various intelligent techniques, including extensions of extant functions such as pop-up blockers and other forms of ad rejection or defeat) and monitor such advertisements (or other delays and distractions for the user) but, optionally, and to whatever extent practical, will block, shorten the duration of, silence, and/or automatically close, such advertisements. Optionally, profiles of complex system behavior (optionally trained by monitoring user behavior) will simulate user interaction (e.g., click ‘OK’, ‘cancel, ‘skip ad’ or ‘[X]’; enter a (dummy) email address; enter user ID/password; interact with ‘captcha’; defeat persistent intrusive web pages; etc. by detecting and killing related system processes, Etc.) to avoid such ads and similar distractions, and be maintained on the service-based and/or local-user system, and/or supplied by the inventive service in the same way that virus, spyware and adware profiles are used to detect and defeat such security threats via services such as MacAfee, Norton, etc. Such will, optionally, be implemented by providing a web browser or related program, to replace the standard web browser or related program with a version that is designed to selectively suppress, or bypass, the display and/or interaction of such intrusive resources.

Alternatively and optionally, interactive controls made available to the user will permit them to start/stop the inventive alternative presentation at their own discretion to cover ads, delays, or otherwise. A related, optional, feature or control will suppress audio from selected or all sources, except for the audio associated with the alternative presentation. This will permit the prior embodiment to be practiced where human/computer collaboration is used in place of an entirely automated or intelligent-software computer operation.)

Additionally, in some embodiments, the user will be supplied with an icon or other place to click, or a control key combination, to request a grain of content. This will be used to extend a granular presentation that the user is not ready to end, or to start a granular presentation without an inciting condition. However, it will also be the option to limit such user-initiated use, and/or to provide monitoring for the user, or an employer, to prevent the invention from becoming another distracting time-waster, like a video game. Further, it will also optionally be a feature of the invention to monitor user behavior to make sure they do not intentionally overload the system, by opening too many windows, requesting too many resources, or otherwise, in order to intentionally create needless inciting or provoking conditions as a way to receive additional grains of content.

If there is no delay, program flow loops back (1412) to keep checking (1401). If there is a delay (1411), flow continues to (1402) where the current grain of media is displayed, or the current grain of alternative application is set into operation. It is the current grain, rather than the first grain, because, in many circumstances, granular media or presentation will pick up at a subsequent delay (with the next grain) at a point just after the presentation associated with a prior delay left off. If an entire granular media work is exhausted, or a different granular media work is selected by the user or system, then the ‘current’ counter is updated accordingly, for example to the first grain of the different work; or, to the current ‘bookmark’ counter associated with that work, if the different work being selected has already been partially viewed by the current user at an earlier time. In embodiments where media is not granular, or the alternative application is not capable of granular operation, the player or alternative application is set in operation in a straightforward manner.

The control program then checks (1403) with the media player or alternative application to see if a grain or media or program operation is completed. If the media or alternative application is of the non-granular type, control passes immediately via (1415) to (1406). Otherwise, if the media or application is operating in granular mode, if the grain is completed control passes via (1414) to (1404), otherwise via (1415) to (1406), and the right-hand loop of FIG. 14, which is discussed more fully below.

In the event that the grain is complete, control passes via (1414) to (1404) to check if the delay condition that provoked operation of the presentation has ended. In the event the delay has (1416), the presentation is complete and control is returned back. Generally control will be returned to the program (or, for example, the browser window) that initiated the presentation due to its delay or other condition. Alternatively, some other event in the operating environment outside the operation of this program has potentially changed conditions. For some non-limiting examples: the system focus has changed, the delayed program was delayed due to a ‘hang’ and the application was terminated in the interim, the delay was due to final system housekeeping tasks and the program has exited in the interim, etc. In such cases the operating system will, generally, pass the returned control on to another application (e.g., the application that now has focus); or, for example, the browser will return control back to a different browser window than the no-longer-active page that provoked the alternative presentation. Similarly, in some embodiments, some such changes in the operating environment—for just one non-limiting example, that the user has via a mouse click moved the focus from the delayed window to another window—will cause the alternative presentation to terminate, either immediately, or when the next grain boundary is reached.

If the delay condition is not over (1417) control is passed to (1405) where the grain counter is incremented. Generally this is a simple +1 increment (unless media branch selection, or other complicating user interaction has intervened). However, if the entire granular alternative work has been completed, or alternative application has terminated, during the delay (or a non-granular alternative presentation of media or application program has finished), then a new work of media or application is selected (optionally, by escaping and querying the user for a selection), and the grain counter (if it is of granular type) is set to the beginning or, optionally, to a bookmark counter, if the work or application has been partially experienced, but not completed, by the user at a previous time. Control is then passed, via (1418) back to (1401) for continued granular (or, non-granular) operation, generally until the delay condition has been completed; and, thus, closing the loop on the left-hand side of FIG. 14.

Returning now to (1415), the ‘No’ response to ‘Is Grain Presentation Complete’ (1403), control is passed to loop constituting the right-hand portion of FIG. 14, at box (1406).

In (1406) it is determined if a ‘delay over-run limit has been exceeded’. Recall that a primary object of granular operation is that, when the delay condition is over, return to the original delayed task will, generally, be slightly further delayed in order to complete the presentation of a grain and not interrupt the presentation at a point that will be cognitively disturbing. Thus, presentation will generally continue to the next grain boundary. For some non-limiting examples: if a quiz question has been asked, the user is permitted to answer, and determine if they were correct; if the telling of a joke has been started, it continues through to the punchline (or, a pay-off joke is presented, optionally out of linear turn, if the set-up portion has already been presented); presentations are not cut off in the middle of a sentence, or, optionally, a paragraph or chapter; a game program is not cut off in the middle of a move; etc. However, particularly if a grain is of a substantial length—for example, if an audio book has been granularized only to the level of chapters that take 5 to 7 minutes each—or, if the presentation is not of granular type, a grain boundary may not be soon enough in coming. The definition of ‘soon enough’ in this case will, optionally, be that a ‘delay over-run limit’ will be defined such that, for example, once a delay condition has completed, but a grain is still running, after a limited over-run period of, say, 20 seconds, the grain will be interrupted even if not completed. Generally the operation of this function will be a bit more complex, although not shown in this diagram which is intended to clearly illustrate the programmed interaction between granular presentation and system delay. For example, with a 20 second limit; after 10 seconds a chime or other audio or visual cue will be presented to let the user know of the pending interruption; at 15 seconds a second, optionally more insistent, cue will be presented. The user will thus be forewarned to get themselves into a cognitive state ready for interruption. Finally, at 20 seconds, the presentation will end and control will be returned to the primary application. Additional, optional, features will be that the user will have an ‘extend delay’ widget to click on that will extend the delay over-run limit by an additional 10 seconds each time—akin to an alarm-clock snooze-button. The system will, optionally, also have a limit set as to the number of times such an extend delay button can be hit. Alternatively, the manual extend button will extend the alternative presentation indefinitely; in which case there will also of necessity be a button to end or ‘escape’ the alternative presentation and return to the primary application. Such an ‘escape’ button will, optionally, be provided in any event (e.g., the mechanism that will be monitored by (1407)), in order to permit the user to escape even a non-open-ended extension of the alternative delay-covering presentation. For example, the user will, potentially, want to attend to some system house-keeping chore to end a stalled process causing an overly-long or open-ended delay.

In any event, if it is determined in (1406) that a delay over-run limit has been exceeded (1421)—including any optional extension mechanisms, illustrated by the non-limiting examples above—control will be returned, with all the same caveats as above. Otherwise, if the delay over-run limit has not been exceeded, control is passed via (1422) to (1407).

In (1407) it is determined if the user has requested to escape entirely the alternative, generally granular, presentation, and to do something else during the delay. For example, if the delay is taking far longer than expected, the user will, potentially, want to escape the alternative presentation and invoke a utility such as the Windows Task Manager, and terminate an application program that has become ‘hung.’ Or, the user has become tired of the alternative granular presentation. In that case the user will indicate their intention by some mouse click, key sequence, or otherwise and, sensing this in (1407), control will also be returned via (1423) to the system, with all the same caveats as above. Additionally, the user will have the option of turning the granular presentation system on or off.

Depending upon the operating system or other elements in the overall system, in some embodiments, it will be possible for the user to escape the alternative presentation, with or without termination, by, for example, clicking on the window associated with some other application, and grabbing the focus from the alternative presentation. The alternative presentation will then, optionally, continue, pause, go mute and gray, terminate—to be picked up at the previous, current, next or other grain, when subsequently called upon again—or otherwise.

Generally, many embodiments of the instant invention will also have an on/off mechanism that will permit a user to enable or disable the automatic delay-covering alternative presentations. For clarity, and to focus FIG. 14 on the intended teaching, this feature has not been shown in the figure. Any number of additional features and nuances can be added to this basic program flow without straying from the intended scope and purpose of the instant invention.

Assuming the user has not requested to escape the alternative presentation entirely, control is passed via (1424) to (1408), where it will be sensed if the user has indicated their request to ‘escape the current grain’ and go on to the next; or to ‘escape the current granular presentation’ but pick a new granular work to continue the presentation, rather than end the presentation entirely (as by the user instruction that is sensed in (1407), for example).

For example, if the grains are short 10-second encapsulations of news stories, the user may determine that they are not interested in a particular story immediately, and want to skip to the next one. Or, if the user is bored with the entire type of presentation—say, these news stories—the user will instead signal to not just skip to the next grain of news but, rather, to stop the news presentation entirely and change to a granular program consisting of, again for just one example, a presentation consisting of quiz-type questions and answers. Again, some mouse click, key stroke or other mechanism will communicate either of these user desires; or, other interactive features not specifically shown in FIG. 14. Additionally, an optional menu of alternative presentation title, or similar interactive mechanism, will be offered to the user in order for them to select which alternative presentation (media or application) to substitute for the current one.

If no such user desire is detected (1426) then control is returned to (1403) completing a right-hand loop of FIG. 14. However, if the user indicates they want to escape the presentation of the current grain only, or change the granular presentation being offered, then control is passed via (1425) to (1405), reentering the loop on the left-hand side of FIG. 14 at (1405). There the grain counter is incremented, or the presentation being offered is changed, with all the caveats discussed above, and control is passed via (1418) to (1401), and the process is continued with the next grain.

FIG. 15 depicts a system diagram that roughly corresponds to the flow diagram of FIG. 14. As will be explained, they do not necessarily completely overlap or depict identically operating embodiments in all respects. FIG. 14 depicts a non-limiting example illustration as to how overall system control operates. FIG. 15, depicts a non-limiting example of how three idealized system modules communicate. The discussion will focus on granular elements; however, like with FIG. 14, optionally, non-granular media or non-granular alternative applications will be presented (1503) in response to a system delay or other provoking or inciting condition. Generally, FIG. 15 depicts an example of how the system components will communicate, while FIG. 14 depicts an example of how the information so communicated will be processed upon. Any actual real-world embodiment will combine elements of either perspective, or otherwise, depending upon the details of the embodiment, the programming style of the implementors, the programming language and development environment utilized for implementation, the target operating system and platform, and the other software the embodiment will be interacting with.

Element (1501) represents the granular control portion of the media player (see FIG. 16 and the accompanying text) or the meta-controller program (see FIG. 17 and the accompanying text). Element (1502) represents the operating system, application program such as a browser, individual application programs running under and operating system, or some other program environment within which, or which itself will encounter, periodic delays (or other condition), which will cause (1501) to request of (1503) to provide an alternative presentation (media or application program) to fill the period of the delay. Element (1503) represents the granular media display or the granular operation of the alternative application (that is, alternative to the application or other program that is in a delayed state).

In order to know whether to offer alternative presentation (1503), the granular control portion of the system (1501) needs to know when a delay or other provoking condition exists. Thus, (1501) will ask for (1504) and receive (1505) the status of delay conditions from (1502). This will consist of asking the operating system about the status of any applications for which delays will be considered significant (a list of which programs to include in such status reports and which to exclude is an optional feature of the system); polling the application programs individually for delay status (directly, or via the operating system); querying a program such as a web browser about the delay status or other provoking condition (e.g., advertising display) of web pages or windows under its operation; or, otherwise depending upon the particular embodiment, application programs, operating system, and platform involved. Alternatively, (1501) will, optionally, run under the control of (1502) and will be explicitly directed (1506) by (1502) when to turn the alternative presentation on and off.

While the delay condition exists, determined by (1501) as just described, (1501) will interact with the alternative presentation portion of the system (1503) as follows. Control portion (1501) will ask (1508) the granular presentation portion (1503) to initiate presentation of a grain of media or alternative application operation (or initiate a non-granular presentation). Information as to which granular work, or granular application, as well as which particular grain to present, will also, optionally, be communicated via (1508). The alternative presentation (1503) will continue, grain by grain, under program control, as was described in the flow chart of FIG. 14. Alternatively, the alternative presentation (1503) will continue on it's own, grain after grain (or continuously, if not of granular structure), without continued intervention of the control portion (1501) until it is directed to stop (1511).

At a point in operation when the granular control portion (1501) learns, via (1504/1505), (1506), or otherwise, that the inciting delay or other condition has ended, it will interact with (1503) to stop the alternative presentation as follows and/or, generally, in some combination as discussed with regard to FIG. 14, or with other variations and modifications to the general operation discussed herein. (1501) will inquire (1509) of (1503) if it is OK to stop?—that is, has a grain boundary been reached or grain been completed? (1503) will indicate (1510) that it is OK, or when it is OK. For example, in a first case, if the two software modules (1501) and (1503) operate in a tightly bound fashion—with a loop constantly ‘asking’ if a grain boundary has been reached (such as the right-hand loop in FIG. 14) and, then the grain counter is incremented (1405) before the next grain is presented (1402)—then (1509) operates as ‘is grain presentation complete’ (1403) and (1510) operates as returning an indication to (1403) comparable to ‘yes’ (1414) or ‘no’ (1415). (1511) is then an optional signal to stop the alternative presentation, media or alternative application, granular or non-granular; which signal will optionally be timed by (1501) to coincide with the ‘grain boundary reached’ condition. Alternatively, if the granular control module (1501) and alternative presentation module (1503) act (and/or are implemented) in a more arm's length, asynchronous or ‘object oriented’ mode, then the alternative presentation module (1503) will be operating grain after grain without having to be told to update the grain counter (1405) and present current grain (1402). In that case, (1509) will be more accurately described as ‘let me know when a grain has been completed?’ and (1510) will be more accurately described as ‘the current grain has completed.’ (1503) would then, in that case, be programmed to stop at the end of the grain during which (1509) was received; or, to stop at the end of the grain or, optionally, immediately, when receiving an explicit command to stop (1511) from (1501). (1511) will also, optionally, be used to force stop a presentation, even during a gain, when a condition comparable to ‘delay over-run limit has been exceeded’ has been determined by (1501), by an internal timer, by directions from (1502) via (1506) or otherwise.

In any event, once (1501) and (1503) have negotiated actual or soon pending termination of the alternative (to delay) presentation, (1503) will communicate via (1507) to (1502) (operating system, application program, browser, or otherwise) to return control or focus to, or otherwise restore operation of the no-longer-delayed program. Alternatively, once the delay has ended, (1502) will request (1506) of (1501) to negotiate with (1503) the immediate (1511) or grain boundary sensitive (1509, 1510 and, optionally, 1511) termination of the alternative presentation.

FIGS. 16 and 17 each show three variations of two embodiments. In this discussion, in element numbers, X refers to a digit or letter for which any of several options depicted are substituted.

The embodiments of FIG. 16 are for a granular media display program (1604, 1608, 1609; 1616, 1618, 1619; 1627, 1628, 1629) where media are displayed (16×9) during delays generally related to application programs (16X2a-d). The embodiments of FIG. 17 are for a granular control program (“meta-controller”) (1704; 1716; 1727) where application program(s) (17X2a, 17X2b) alternative to the primary application program(s) (17X2c, 17X2d) are promoted to active status during system delays.

Common elements include the operating system (16X1, 17X1); application programs (16X2a-d, 16X2a-d) which generally run under control of the operating system, and in FIG. 17 some (a and b) also under control of the granular control program (1704; 1716; 1727); and communication signals (16X3, 17X3) between the operating system and other elements; (16X8) between the control and display portions of the granular media display program; and (17X9) between the granular control program and the alternative applications (a, b) which are generally two-way as needed, and which communicate control (e.g., go quiescent, become active), status (e.g., delay status, focus status), or other information between the various system elements.

In each figure, the top depiction (160X, 170X) shows an embodiment where the player (1604, 1608, 1609) or control program (1704) is separate from, but generally operates under, the operating system (1601, 1701); the bottom depiction (162X, 172X) shows an embodiment where the player (1627, 1628, 1629) or control program (1727) is incorporated into the operating system (1621, 1721); and, the middle depiction (161X, 171X) shows an embodiment where the player (1616, 1618, 1619) or control program (1716) is incorporated—as an embedded feature, plug-in, add-on or otherwise—into a web browser or other program (1615, 1715) which itself generally will run under control of the operating system (1611, 1711).

Focusing now on the top illustration of FIG. 16, a granular media player comprises two main functional components, a control portion (1604) which monitors for and communicates about system delays and controls features of the content to be displayed by the display portion (1609). These two components are integrated or separate functions and, as necessary, communicate via (1608). The components of the granular media player communicate with the operating system (1601) via (1603e). In general, but not necessarily, the components of, or integrated, granular media player operate under the auspices of the operating system (1601). However, in other embodiments, particularly those during which granular media display will be offered during system boot up delay, which may be substantial, some form of the granular media player will, optionally be installed and operate on the computer prior to and during operating system boot-up. Then this preliminary version of the granular media player will optionally continue; or, it will optionally give way to a version operating under the operating system. The operating system (1601) also communicates with and/or controls application programs (1602a-d) (generally end-user applications run in GUI windows, with other programs and processes not shown) via generally bi-directional channels (1603a-d) and, in particular, exchanges information relating to the focus, visibility and delay status of application programs, as well as user interaction (not shown).

When an application (1602a-d)—generally the one which has the focus, or is being interacted with by the end user—goes into a delay state, the operating system is aware (or able to become aware) of the situation. For example, the operating system will, optionally, have put the application into a wait state in order to, for example, open a file, allocate memory or other system resource, or otherwise; or, the application will have put itself into a wait state—optionally requesting that the operating system display of the hourglass instead of the arrow cursor—based upon a user request, such as to open a file, etc.; or, otherwise. In any event, the operating system can check—or be asked by some other program, such as the granular player control program (1604), to check—on the wait status of applications and, in particular, the application program that currently has the user focus. When it is so determined, by the granular media player control module (1604) that the conditions exist that correspond to ‘the user is likely experiencing a delay in productivity’ it will, in turn, instruct the granular player display module to become visible and display the appropriate content. As discussed in more detail elsewhere herein, the specifics of the appropriate content is determined by some combination of: a user profile; information about the application which has caused/requested the delay (or other applications running); content and information downloaded from an affiliated service (or local data library or otherwise) providing content and optional advertising, scheduling, etc.; as well as, optionally, information or an estimate of the length of the expected delay. If display of a grain of media has been completed, and the delay is still ongoing, generally another grain(s) of media already queued up will be displayed until the delay has ended, or the user or system requests the display (1609) ends.

The granular media display will continue to display until: it is explicitly directed to close (which closure will, optionally, be delayed until the end of a media grain has been reached); until it runs out of content and has not been directed to continue with additional content; until explicitly requested to close (which closure will again, optionally, be delayed until the end of a media grain has been reached) by the user, which request will generally be passed back (e.g., by some mouse gesture or control key sequence not shown), optionally via an application window (1602X, 1603X) or the desktop, then optionally via the operating system (1601, 1603e), then optionally via the granular media player control module (1604, 1608) to the display module (1609).

Focusing now on the bottom illustration of FIG. 16, the arrangement and operation are generally the same as for the top illustration with the following exceptions. The penultimate digits of the element numbers have been changed from 0 to 2. The granular media player control module (now 1627—rather than ‘1624’—to distinguish the variation) is now shown to be part of the operating system (1621). This module (1627) will here, optionally, be made available as an integrated feature or function; or, as a ‘plug-in’ or ‘add-on’ or other later installed program. The display module (1629) of the granular media player, as shown, is depicted as still being separate from the operating system (1621); but it may also, optionally, be integrated into the operating system, separate from or integrated with the control module (1627). Details of operation are, generally, as with the 160X embodiment, except that, for example, certain communications (e.g., 16X3e) will now, optionally, be an internal part of the operating system (1621) rather than as an external communication link.

Focusing now on the middle illustration of FIG. 16, the arrangement and operation are generally the same as for the top illustration with the following exceptions. The penultimate digits of the element numbers have been changed from 0 to 1. The granular media player control module (now 1616—rather than ‘1614’—to distinguish the variation) is now shown to be part of a web browser or other program (1615) not earlier shown. This module (1616) will here, optionally, be made available as an integrated feature or function; or, as a ‘plug-in’ or ‘add-on’ or other later installed program. The display module (1619) of the granular media player, as shown, is depicted as still being separate from the nominal browser (1615); but it may also, optionally, be integrated into the browser, separate from or integrated with the control module (1616). Details of operation are, generally, as with the 160X embodiment, except that, for example, certain communications (e.g., 16X3e) will now, optionally, be conducted via the browser (1615) as an additional layer.

Although not necessarily, with this embodiment variation (161X), the delays monitored and substituted for with granular content will, optionally and typically, be download delays experienced as a result of the browser program downloading information from a network, typically the internet. In general however, this other program (1615) will, optionally, be other than a web browser. For example, if it is a database retrieval program, the delays being monitored and substituted for with granular media would, generally, be delays due to the processing of queries or database management tasks requested by the user. Instead of merely waiting for a response to a query, said wait being sufficiently lengthy as to be perceived as an annoyance, the user will be offered the display of one or more grains of granular media (in this embodiment, or some grain of operation of an alternative application in other embodiments as in FIG. 17). While such delays are often visibly indicated by a progress bar—which is often informed by system knowledge of an estimated length of task/delay and/or the percentage already accomplished, which is, optionally, also indicated to the user—rather than an hourglass. By being integrated into the web browser, database system, or other program (1615), the granular player control module (1616) will have access to such application-(1615)-delay-related information directly, rather than necessarily having to obtain it via interaction with the operating system (1611).

Similarly, although not necessarily, with this embodiment variation, and particularly if the other program (1615) is a web browser, the granular media display module (1619) will optionally be effected as a web browser window and/or by using some other functions or services of the web browser.

Further, generally, an optional manner of implementation of functions of the granular media display module (1609, 1619, or 1629) in any embodiment variation, involves establishing or spawning a web browser window and/or by using some other functions or services of the web browser. With, Java, javascript, Adobe Flash and other multi-media, interactive and programming services typically now integrated into browsers (and routinely and frequently updated), as well as HTML, relying on a browser framework will, optionally, be a highly effective way to implement the granular media display module (1609, 1619 or 1629) with services that are widely available, platform-flexible, and reliably maintained and updated.

Additionally, available both within browser windows and, generally, with operating systems or other applications, are facilities for displaying pop-up windows. These are often, but not necessarily, tied to a user-initiated mouse action or roll-over of some hot-link, icon, file name, or other GUI item. The information displayed in the window can be a minimal text item (such as the operating system displaying the file size associated with the file name being pointed at by the cursor); or, it can be a complex multimedia window consisting of any combination of text, graphics, a video clip, and hot-links providing hyper-navigation and/or interactivity. Alternatively, such pop-up windows (or balloons, or tips) are displayed as a result of an operating system or application program action or state change: e.g., a notification to the user that a file download, or other task, has completed. Similarly, in web browsers or other applications, such pop-up windows are often displayed unrequested by the user, as a result of advertising, or other content, being passively or actively embedded into content.

FIG. 20 shows an example of a web page (top) where activation of a hyperlink or hot-link causes (bottom) the greying out of the page and the opening of a pop-up window that includes: text, video, interactive controls, a progress bar (although for video play, and not a delay), and a further hyperlink (the YouTube logo, which takes you to a page at the YouTube site displaying the same video clip).

Particularly when used in conjunction with a web browser, but also generally, variations of the instant invention, which will optionally, not be tailored to interstitial operation, will supply content in parallel with non-stalled applications. For example, if a user has expressed interest in rock climbing and, thus, the service has downloaded (or could, optionally, in real- or near-real-time download) content (and advertisements) related to rock climbing on the user's system, a pop-up window offering that content will (optionally, in addition to during a system delay) be offered if the user is visiting a web site related to rock climbing, writing in a word processor about rock climbing, reading a .PDF mentioning rock climbing, etc. The user will, optionally, be able to turn such ‘helper’ presentations (or the entire gamut of presentations) on or off.

FIG. 21 shows examples, without limitation, of pop-up windows with diverse media, on diverse platforms, and for diverse uses, including: (A) Video and text in a pop-up window associated with a hot-spot in a map on a web browser page (B) Program information associated with the roll-over of a menu icon of a Windows program (C) A pop-up window on the display of a Google/Droid Smartphone (D) A Windows tip balloon (E) A Windows system-initiated system warning (F) A Windows system notice indicating completion of a user-requested function (G) A Windows progress bar, including estimated time to completion (H) A Mac platform progress bar which also indicates a rather lengthy delay until task completion during which time the user may, or may not, have some alternative task for the computer or themselves to perform.

However implemented, the granular (or non-granular) alternative presentation will be run at a relatively high priority so that it will ‘pop-up’ quickly, as will be useful for an application that will need to start, play out one or more grains, and close down, all within a delay of some other system component that may last a matter of seconds. Running at high priority will help ensure that the alternative presentation is quickly made available, ahead in priority of other application programs and, in particular, ahead of the stalled program causing the delay. However, generally, even if the alternative presentation will be run at a priority higher than other application programs, it will generally not be run at a priority higher than the operating system itself.

Further, particularly with large amounts of system memory being the norm, the control and presentation software of the alternative presentation mechanism, and/or, the initial grain(s) or one or more granular presentations, will be kept resident in system memory, rather than on disk, to speed the start-up process of the alternative presentation.

The granular media player of FIG. 16, the granular operation program meta-controller of FIG. 17, or other embodiments will be operated to provide users with experiences alternative to passively waiting for delays including, but not limited to: system boot-up (as described above); application launch; file opening, closing or processing; other processing task; database queries or processing; download or upload of files or other resources via a network, including the internet; allocation or their management of resources, including memory, disk space, file or communication channels, network connections; any delay caused by interaction with a network or system remote to the user system; etc.

Focusing now on FIG. 17: the three embodiments shown in the top, middle and bottom illustrations roughly correspond in system configuration with the three comparable illustrations of FIG. 16. The major difference is that FIG. 16 shows embodiments that would reasonably be called granular media players, while FIG. 17 shows embodiments that would reasonably be called granular meta-controller program (Meta: beyond, transcending, more comprehensive, as in metalinguistics)—that is a program that operates above a second program, doling out the operation of that second program in a granular fashion.

Focusing now specifically on the top illustration of FIG. 17, a granular meta-controller program (1704) monitors for and communicates about system delays and controls operation of alternative application program(s) (1702a & b, as shown). The meta-controller communicates with the operating system (1701) via (1703e). The meta-controller communicates with those alternative application programs via (1708) or, indirectly via the operating system (1701), via (1703e) and (1703a & b). In general, but not necessarily, the meta-controller program operates under the auspices of the operating system (1701). However, in other embodiments, particularly those during which the granular meta-controller program will offer alternative application programs to the user during system boot up delay, which may be substantial, some form of the granular meta-controller program (as well as the required alternative application programs) will, optionally be installed and operate on the computer prior to and during operating system boot-up. Then this preliminary version of the granular meta-controller program will optionally continue; or, it will optionally give way to a version operating under the operating system. The operating system (1701) also communicates with and/or controls application programs (1702c&d, and alternative application programs 1702a&b). These are generally end-user applications run in GUI windows, with other programs and processes not shown. Communication between the operating system (1701) and these application programs is via generally bi-directional channels (1703a-d) and, in particular, they exchange information relating to the focus, visibility and delay status of the application programs, as well as user interaction (not shown).

When a primary application (1602c&d)—generally the one which has the focus, or is being interacted with by the end user—goes into a delay state, the operating system is aware (or able to become aware) of the situation. For example, the operating system will, optionally, have put the primary application into a wait state in order to, for example, open a file, allocate memory or other system resource, or otherwise; or, the application will have put itself into a wait state—optionally requesting that the operating system display the hourglass instead of the arrow cursor—based upon a user request, such as to open a file, etc.; or, otherwise. In any event, the operating system can check—or be asked by some other program, such as the granular meta-controller program (1704), to check—on the wait status of primary applications and, in particular, the primary application program that currently has the user focus. When it is so determined, by the granular meta-controller program module (1704), that the conditions exist that correspond to ‘the user is likely experiencing a delay in productivity’ it will, in turn, activate one (perhaps one or more of several) alternative application program(s) (1702a&b, as shown).

Activation will, optionally, involve: (particularly for the first time used during a computing cycle) initiating, booting or loading of the alternative application; making the alternative application (or the window it is running in) visible; passing the user focus to the alternative application (or the window it is running in); or otherwise. The meta-control program will optionally perform such activating task itself, will ask the operating system to do so, or will ask the alternative application itself to do so: for example, depending upon the details of operation of the operating system involved, the operating system will control application status, will change application status at the request of the application or user, or some combination or alternative.

As to which (one or more) of several alternative applications is to be activated, factors that enter into that decision include, but are not limited to, long-term user preference profile, specific user short-term request, and the expected delay. For example, if the delay is expected to be a minute or more, the alternative application program activated would be an email program, where it is deemed that a full minute is sufficient to at least briefly review (if not reply to) an email message; while, if the delay is expected to be less than a minute a game, such as Tetris or solitaire, is activated and the user plays it for, say, a period of 40 seconds before the game is gently deactivated and the system/user returns to working with one of the primary application programs.

Advertising is, optionally, included with the presentation of the alternative application(s).

If a grain of alternative application operation (e.g., review of one email, completion of a game move) has been completed, and the delay is still ongoing, generally another grain(s) of alternative application operation will be offered until the delay has ended, or the user or system requests the alternative application to end.

The operation of the alternative application(s) will continue until: it is explicitly directed to stop (which cessation will, optionally, be delayed until the end of a grain of alternative application operation has been reached); until it runs out of tasks to perform and has not been directed to continue with additional program tasks; until explicitly requested to close (which closure will again, optionally, be delayed until the end of an operational grain has been reached) by the user, which request will generally be passed back (e.g., by some mouse gesture or control key sequence not shown), optionally via an application window (1702a or 1702b, via 1703a or 1703b, or via 1708) or the desktop, then optionally via the operating system (1701, 1703e), then, optionally, via the granular meta-controller program module (1704, 1708) to the alternative application (1702a or 1702b) directly or, again, via the operating system and appropriate channels (1703e, 1701, 1703a or 1703b).

Focusing now on the bottom illustration of FIG. 17, the arrangement and operation are generally the same as for the top illustration with the following exceptions. The penultimate digits of the element numbers have been changed from 0 to 2. The granular meta-controller program module (now 1727—rather than ‘1724’—to distinguish the variation) is now shown to be part of the operating system (1721). This module (1727) will here, optionally, be made available as an integrated feature or function; or, as a ‘plug-in’ or ‘add-on’ or other later installed program. Details of operation are, generally, as with the 170X embodiment, except that, for example, certain communications (e.g., 17X3e) will now, optionally, be an internal part of the operating system (1721) rather than as an external communication link.

Focusing now on the middle illustration of FIG. 17, the arrangement and operation are generally the same as for the top illustration with the following exceptions. The penultimate digits of the element numbers have been changed from 0 to 1. The granular meta-controller program module (now 1716—rather than ‘1714’—to distinguish the variation) is now shown to be part of a web browser or other program (1715) not earlier shown. This module (1716) will here, optionally, be made available as an integrated feature or function; or, as a ‘plug-in’ or ‘add-on’ or other later installed program. Details of operation are, generally, as with the 160X embodiment, except that, for example, certain communications (e.g., 16X3e) will now, optionally, be conducted via the browser or other program (1715) as an additional layer.

Although not necessarily, with this embodiment variation (171X), the delays monitored and substituted for with granular content will, optionally and typically, be download delays experienced as a result of the browser program downloading information from a network, typically the internet. In general however, this other program (1715) will, optionally, be other than a web browser. For example, if it is a database retrieval program, the delays being monitored and substituted for with granular media would, generally, be delays due to the processing of queries or database management tasks requested by the user. Instead of merely waiting for a response to a query, said wait being sufficiently lengthy as to be perceived as an annoyance, the user will be offered some grain of operation of an alternative application program (in this embodiment, or the display of one or more grains of granular media in other embodiments as in FIG. 16). While such delays are often visibly indicated by a progress bar—which is often informed by system knowledge of an estimated length of task/delay and/or the percentage already accomplished, which is, optionally, also indicated to the user—rather than an hourglass. By being integrated into the web browser, database system, or other program (1715), the granular meta-controller program module (1716) will have access to such application-(1715)-delay-related information directly, rather than necessarily having to obtain it via interaction with the operating system (1711).

Similarly, although not necessarily, with this embodiment variation, and particularly if the other program (1715) is a web browser, the granular operation of an alternative application offered to the end user will optionally be effected within a web browser window and/or by using some other functions or services of the web browser. For example, many games and other programs can be delivered as Java applets, Flash programs or otherwise on a web browser; or, services such as email are, optionally, delivered via a web interface, rather than via a PC-operating system-based application program. Similarly, smartphone apps offer games, email and many other functions and, optionally, serve the place of primary or alternative applications for embodiments running on such devices.

The preceding discussion relates primarily to the location and function of the portion of the inventive system which would generally be referred to as the granular control program module. That is, the portion of the system that controls granular display of media (1604, 1616, 1627), as opposed to the module actually performing the display to (1609, 1619, 1629), and interaction with (generally via the operating system (1601, 1611, 1621)), the user, for example; or, the module providing granular control of alternative applications, the granular meta-controller program (1704, 1716, 1727); or, other modules in other embodiments.

In addition, these modules—or other or separate modules in such a system—will provide additional functions supporting the operation of some embodiments of the inventive system, or other systems. These, and other such functions now known or later developed to conduct support enhancement or otherwise related functions will be incorporated into embodiments of the instant invention as needed and such use is within the scope an purpose of the instant invention. A non-limiting array of such related functions is depicted as being part of the granular control program in FIG. 18. In that figure the granular control program (1800) not only provides granular control functions (1810), but also, security/decryption functions (1820), accounting functions (1830), and program procurement functions (1840). These additional function are described, following.

At any location within the inventive system but, in particular, with regard to (1820), security, encryption/decryption or other functions will be provided to protect privacy, to protect the security of copyrighted or proprietary materials, or otherwise. The inventive systems described in this and related applications generally provide media comprising program content and advertising materials. These materials will typically be proprietary, protected by copyrights and trademarks, or otherwise provided to the inventive service and/or the end user with the intention that the materials will not be copied, adapted, re-distributed, or otherwise used in unauthorized ways. Generally, two ways of preventing unauthorized use is to require user identification, as by some password protected access or login mechanism; or, to provide materials in an encrypted or encoded form, where the required decryption or decoding key or other mechanism (e.g., another use of a password) is more tightly controllable, even if the encrypted media is easily obtained, captured and (re-)distributable by general end users, or even non-authorized users. Such identification, password, encryption/decryption and related security technologies are well known and within the ken of those skilled in the appropriate arts; and, the instant invention relies upon the well-developed existence of such techniques, rather than claiming such, in and of themselves, as inventive. However, what is unusual about the inventive system is the way such technology will be used. Most digital media distribution systems (e.g., YouTube, Hulu and other video distribution websites) distribute identical copies of the same material widely, and use various copy defeating technologies to attempt to prevent or discourage unauthorized retention and further distribution, if they even try to do so. Other media, such as software distributed by Microsoft, Adobe, Apple, etc., require the purchase of a key or serial number (delivered via email, affixed to a physical copy purchased, etc.) needed to install or activate the (entire package, or selected features, of) software. Still other sources (e.g., many newspaper websites) require a login with password, and then give any user so identified access to otherwise unprotected and identical content. Etc. This is because (near) identical product is delivered widely and handling security on an individual basis is often impractical, even if not literally impossible.

However, with the inventive services/products in this and related applications, rather than mass distribution of a single or relatively small number of products to a mass consumer base, the product delivered (e.g., 1091) to an end user (e.g., 1080) is, generally, personalized, customized or ‘idiosyncratic’ (e.g., 1090). Thus, with each copy being (completely, or to at least some extent) unique, there is the opportunity to uniquely (or, with a large enough number of keys or IDs to be close enough to unique, for practical purposes) encode, encrypt or otherwise secure each item delivered for a specific user or system. Thus, in some embodiments, the material sent to an end user (1090) will be encrypted, encoded, password protected or otherwise secured with a key, password, or otherwise (e.g., although not specifically shown, such processing will, optionally, be applied to some or all of the elements of the idiosyncratic package (1090) before, or as, it is delivered (1091)) that is, potentially, keyed to a specific end-user or end-user system (e.g., 1420, 1202, 1080, 1601, 1611, 1621, 1701, 1711, 1721, or otherwise).

Further, in addition to, or lieu of, limiting (e.g., by encrypting, encoding, via identification or otherwise restricting access) content use according to a particular user, some embodiments of the inventions, herein or in related applications, or otherwise, will restrict content according to subject matter. That way, in one non-limiting example, any user who subscribes, has signed up for, paid for, or otherwise is authorized to receive sports programming will be given the key or other information item that will enable them to decrypt, unlock or otherwise access any and all sports programming, which will have been uniformly encrypted or otherwise prepared. Any user who subscribes, has signed up for, paid for, or otherwise is authorized to receive arts programming will be given the key or other information item that will enable them to decrypt, unlock or otherwise access any and all arts programming, which will have been uniformly encrypted or otherwise prepared. And so on. In that way, the number of individual items of content that will have to be individually encrypted (for example) will be greatly reduced, saving computing power, time and, ultimately, money. Further, a single (or limited number of) ‘superset’ version(s) of material will, optionally, be prepared which share some authorized content between multiple users, but where for at least some users, some of the content will not be authorized. In that way, a single (or limited number of) version(s) of content can be distributed to a wide number of customers, or posted (e.g., on the web) for their download, with each customer being able to decrypt or otherwise access the content they are authorized for, and not the balance of content. It is noted that if distributed to many users via network (e.g., in particular, metered mobile broadband networks), the overhead (at either end) of sending inaccessible content to users has disadvantages, particularly if the proportion of inaccessible to accessible is large. However, if such material is delivered via means such as optical disk, or is delivered as a background task at underutilized times or via an underutilized channel (e.g., delivered as an email attachment, twitter-like channel, etc.), such disadvantages are minimized. Alternatively, if the content is available for end-user download (e.g., via a web-site) the user may pick and choose content that is of their liking and for which they are authorized from single-encrypted copies of content, which copies are then unusable by unauthorized users even if downloaded. The group of selections are then delivered (separately or as a package, with advertising or other not-specifically-requested material, optionally, integrated) via the same interface (e.g., a web interface, with a click) or, via email, delivery via mobile broadband to a mobile device, etc. In such embodiments, if material is loaned, borrowed, or otherwise distributed to those for whom is not originally intended upon first delivery (or, optionally, shared with authorization to a well-defined or informal group or ‘community’), only the portions of ‘borrowed’ content that a secondary user will be able to access will be those for which they are authorized to.

When grouping content for single-key encryption it was discussed, as an example, that broad areas are employed (e.g. sports vs. arts programming). However, different types and degrees of fineness can be applied to encryption categories. Without limitation, such categorization can include the following. In one non-limiting example, content is categorized by date (of first availability, for example), or other time period, with older content optionally archived, optionally with a new access mechanism, to be made available more widely (to all customers), or less widely (only users who also have ‘archive’ access, in lieu of, or in addition to, ‘content category’ access). Thus, decryption keys (or other security mechanisms) will optionally have limited life, or expire; and, continued access would then, optionally, require re-registration, additional request, payment, or other optional mechanism.

In another non-limiting example, sub-categories, for example sports, will, optionally, be accessed by specific sports (e.g. baseball vs. football) or teams (e.g. all NY teams, Mets or Jets only, etc.). Further, content may be selectively secured by degree of desirability. Most simply entertainment, news or other ‘user program content’ would be encrypted or otherwise protected, while advertisements and marketing-oriented content (e.g., product, book and film reviews, trailers, promotional pieces, etc.) would not. In another example, general news and headlines would be accessible to all users, with detailed news stories and features (e.g., on technology and science, business, sports, arts and entertainment, etc.) available to limited subscriber groups. And so on. These few examples are exemplary. With more complex encryption, or other security, schemes can be handled in any of several ways. In particular, for example, a single user will be given many security keys, one for each type of content, for example: general news and headlines, business, football, Mets, Jets, gardening, film and television. Alternatively, particular content will be encrypted or otherwise keyed to a group of keys. For example, a detailed feature regarding the NY Mets baseball team would be available to those with keys authorizing: the NY Mets specifically, all baseball teams, all NY teams, all baseball related stories, all sports related stories, an all-news-and-features pass. In another example, suitable for highly complex and flexible schemes, each item or type of content will be matched against a database (e.g., a matrix of user ID vs. content category) and will be given access on an item by item, or similar, basis.

Category, hierarchical or otherwise, access will optionally be effected by separately encrypting many individual information elements each with individual decryption keys (or other mechanism) and delivering a large number of such keys to a user. For example, a user who subscribes to sports generally will receive the keys for all stories related to sports; and, a user who subscribes to baseball will receive the keys only to that subset of stories. Alternatively, a system of keys will be employed where a master key will permit access to all stories (or whatever information items are being supplied); a sub-master key (one of several, one for each master category) will unlock all stories categorized under one category, such as sports, arts, technology and science, health and medicine, etc.; sub-sub-master keys will unlock all stories related to a sub-category, for example baseball, football, hockey, etc. under the sports category; a third-level-sub-master key would, for example, unlock specific teams or regions under a sub category, for example, Mets, Yankees, NL East, etc.; a further level would unlock an individual story. This is just one, non-limiting, example and any category structure, with hierarchical, temporal, or other categorization of stories or items (optionally overlapping) is intended to be within the scope of the instant invention.

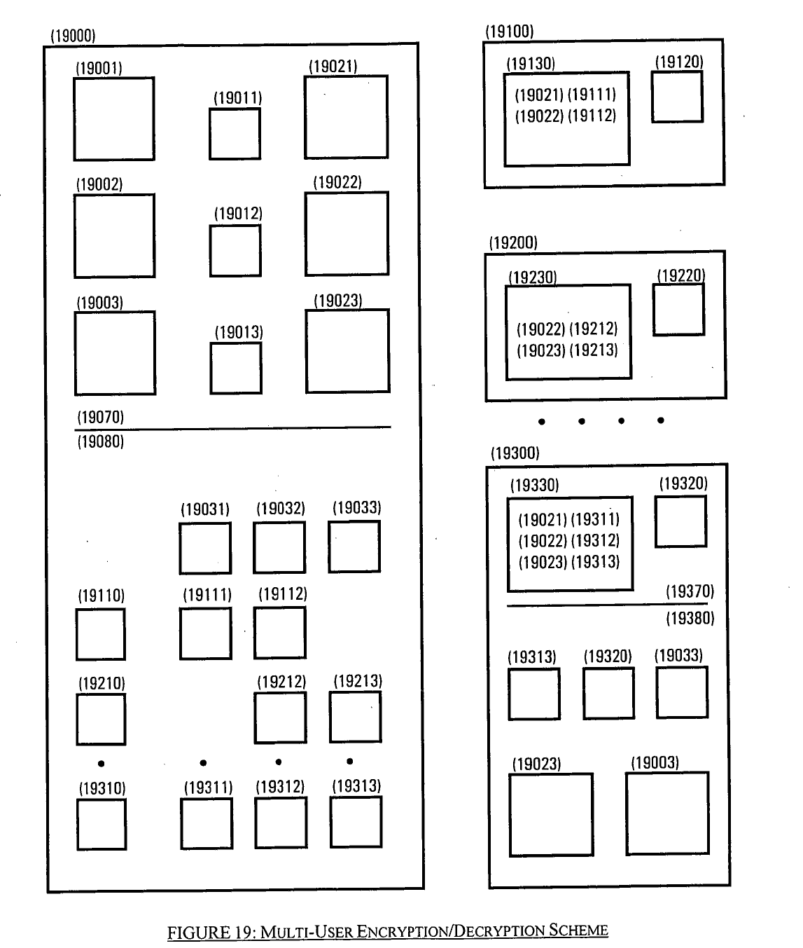

A non-limiting best-of-both-worlds example approach will, optionally, be to: encrypt each item only once, with an item-specific key; and, to give each user a user-specific key. Then, when encrypted items are made available (via deliver, or posting for pick-up or otherwise) to end users, the end users will also be supplied with the keys necessary to decrypt these items. These item-specific-keys, however, will each be encrypted with the user-specific key when made available to the specific user. See, for example, FIG. 19 for additional details. These keys will, optionally, be made available to the instance of the inventive service bureau's software operating on the user system, as opposed to the user's system or user generally, for added security. For example, the keys will, optionally, not be stored on disk, but will need to be downloaded, or re-downloaded, while online and stored only within the memory being used by the inventive player system while it is active. In this way, it will be less likely that such a key will be distributed to other users, or others generally, in an unauthorized way.

Further, since the inventive granular media player or other software will generally be provided by the inventive service (even if it will make substantial use of functions and services which are part of the operating system, web browser or other software present on the user's system) special security mechanisms (1820) will, optionally, be incorporated into the inventive software. Such mechanisms will include, without limitation, that a (near) unique identification code or decryption key will be embedded within the system. Then, if the identification code does not match a complementary identification code supplied with the content, or other delivered information, the inventive software will display a warning, completely refuse to operate, display media in a decimated or hobbled manner, and/or otherwise fail to operate as expected by he user. Alternatively, encrypted. or encoded media, will not decrypt or decode properly without the proper key stored within the specific copy of the inventive software (1821) being available for proper operation.

Since media encrypted for a key stored on a particular instance of the inventive software (1821) there is not necessarily a need to bother the user with login and password mechanisms. Although, if multiple users use the same system, or in other embodiments where users will use web-based or ‘cloud computing’ versions of the service from non-personal systems, it will, optionally, be the practice to have the user login with an optional password to affect identification for personalization and/or accounting and/or eCommerce purposes, independent of the security issues being discussed here. Further, since a given user (or group of users) will be accessing inventive products from multiple platforms (e.g., a laptop system at home; a desktop system at work or school; a smartphone, netbook, or eReader while commuting) the instances or versions of inventive software in each of these systems will, optionally, each contain the same one instance of, or several for a group, security information and mechanism, even if implemented differently on diverse platforms. In that way, the same personally secured content can be obtained and displayed on any and all systems a particular user accesses.

It should be noted that some embodiments of the inventive service will be by paid subscription, rather than advertising supported, so misappropriation of media supplied by the inventive service is not out of the question. However, even if such media is obtained by an unauthorized user, they have two barriers to overcome. First, the material will, optionally, be encrypted or otherwise secured for a different instance of the system software and will not be displayable or otherwise usable on the unauthorized instance of the software. Second, since the content is idiosyncratic, it will, generally, not be of such particular interest to the unauthorized user. Although, it is acknowledged that some particular items of content will have broad appeal, and there is the possibility that selected segments of content will be ‘borrowed’ for wide distribution.

Other such additional functions supporting the operation of some embodiments of the inventive system, or other systems, relate to accounting functions (1830) and, in particular, optional offline and/or asynchronous collection, communication, etc. (1831), of such information. As is discussed elsewhere, and in particular with respect to FIG. 14, there is communication between the end-user audience and advertising clients of the inventive service.

Is should be noted that, as shown, requests (1442) and responses (1443) regarding additional information (which may be for additional content, additional details about advertizing, marketing materials including coupons or other promotional materials, etc.) are between the end user and the inventive service bureau; and, that requests for eCommerce, including coupon redemption, occur between the end user and advertising client (1451, 1452), and/or via the inventive service bureau (1444, 1445, 1461, 1462). In general, in some embodiments, such exchange of any of the information elements communicated between these three parties is, optionally, as shown or, optionally, by any of the arrangements shown (direct, indirect, with or without confirmation, via one-way or two-way communication channels) or otherwise.

In order for the inventive service bureau (1410) to get paid (1463, 1464) by an advertising client (1430) it will generally require that detailed records be kept and presented (i.e., accounted for) regarding deliveries, transactions and/or communications related to advertisements, additional information, coupons or other promotional materials, and eCommerce (including coupon redemption) that is effected by, or enabled to happen directly or indirectly by, the inventive service bureau. Transactions and other exchanges of information that pass through the inventive service bureau can, optionally, be accounted for there. Transactions and other exchanges of information that involve the end user (1420) and/or the advertising client (1430) are, optionally, communicated to the inventive service bureau (1410), via (1445) or (1462) for example. Although those two communication channels are both labeled as being about records of eCommerce, they or similar communication channels not specifically shown or labeled as such, are used to communicate records or confirmation about other such information transactions.

In particular, an end user (1420) that is involved in any such operation for which the inventive service bureau will want to track and account for will, sometimes, be able to directly or indirectly notify the inventive service bureau of that activity. In other circumstances, the end user will not be in contact with the service bureau. In order for the service bureau to later be able to account for and be paid for such transactions, the end user (1420) operating some inventive software component (e.g., 1604, 1615, 1627, 1704, 1715, 1727, etc.) which, optionally, contains functions as shown in (1800) and, in particular, the accounting functions (1830), including optional offline and/or asynchronous collection, communication, etc. (1831). Specifically, the end-user's system, including (1800, 1830, 1831), will keep a record of such transactions, optionally together with any required information such as user or transaction IDs, items purchased, amounts spent, coupons redeemed, etc. This information is then, at a time possible or convenient, e.g., asynchronously, communicated to the service bureau so that it can be accounted (1415) and billed (1463) for, and in general be paid for (1464).

Circumstances that will potentially require such asynchronous accounting include, without limitation, the following examples. In some embodiments, substantial amounts of program content for the invention is already on the user's system, supplied with a new system (as are many such pre-loaded or trial versions of software applications), or delivered to the user on an optical disc or downloaded from a network such as the Internet. Advertisements will, on the other hand, be obtained closer to the time the content is actually displayed, optionally based on the content subject matter, as well as the user's ID and interest profile, and the requests by advertisers for audience meeting particular demographic requirements, or with particular interests, or viewing particular content types. The advertisement will, optionally, be delivered directly from an advertiser, of via some ad brokering operation, or otherwise, in such a way that the service bureau is not directly involved in or aware of the transaction. In this example, the user's system will keep a record of all advertisements, so integrated with the content, and in (near-)real time notify the inventive service bureau or, optionally, as discussed here, will retain and asynchronously communicate such accounting records (1830, 1831) to the inventive service bureau.

In another non-limiting example embodiment, the end user will review additional advertising or marketing information, optionally delivered to the user via email or otherwise, offline; or, redeem coupons or conduct other eCommerce activity directly with an advertising client (optionally via some intervening entity) online, but not while also in synchronous networked contact with the inventive service bureau. Records will be kept (1830) of reception and/or review of such additional advertising and/or promotional materials, and/or redemption and/or eCommerce transactions carried out while not in contact with the service bureau. Such records will, at a later time, be communicated (1831) to the inventive service bureau.

In other embodiments, for yet another non-limiting example, the user will be offline entirely while performing some of these functions (including, for example, eCommerce) which will be done by interacting with some locally run applet or other software mechanism. While the user may appear to be doing online eCommerce (for example) records will be kept and later, by a mechanism similar to (1830, 1831), communicated to the other party or parties to the eCommerce transaction, or other activity. In addition, via (1830, 1831), accounting records of these activities will also be collected and communicated to the inventive service bureau by means, and at a time, that is practical.

Still other such additional functions supporting the operation of some embodiments of the inventive system, or other systems, relate to procuring program content (1840) and/or, optionally, other information. Non-limiting examples of such other information include: advertisements; marketing information; asynchronous, secure, or anonymous communications; system updates; etc. In particular, many embodiments of the inventive system will generally provide display of granular media multiple times each day to any particular user, and there may be many millions of users. Generally, it will not be practical (even if theoretically possible) to respond tens of millions or billions of times daily with response times that are appropriate to carry out delivery of media during a system delay, which will often take place during a period of mere seconds. And, even more particularly, as the delay may, itself, be due to a lag or delay of the same network that would be involved in such responses.

Procurement of content, for example, when initiated by the end-user or client system, rather than the server of the inventive service, will be initiated by the client system in a number of way that will include, without limitation the following. First, the system will, optionally, be programmed to pick up (unilaterally or, optionally, first inquire of the server system if such materials are available) such information on a timed or scheduled basis; for example, hourly, daily, particularly at 3 AM and 7 PM on odd days of the month, or otherwise.

The user's system will also, optionally, check on how much granular (or other) content, advertising and marketing materials, etc. is stored on the system for real-time operation that is, optionally, at least in part locally interactive from stored information rather than network mediated in real time. That is, for example, when the user's system detects that the amount of granular content (or some other information) has fallen below some minimum threshold, the system will request of the inventive service the delivery of a package of more such materials.

Additionally, the user (as opposed to the user's system) will, optionally, have the ability to request new information from the inventive service. For example, if the user has become bored with the current library of content; if the user has heard of some new piece of free or purchasable content (optionally, via a notice from the inventive service) that they desire; if the user just wants to have their system updated with fresh content; if the user knows, for example, that they will be unconnected from the network for some period and wants to ‘stock up’ on content; or, otherwise.

Of course, the three alternatives, above, are in addition to any actions taken by the inventive service or, optionally, their advertising clients, content partners, or other affiliates, to take action to initiate delivery (with, or without, confirmation by the user) of such information to the user.

Further, in at least one of the parent documents, a discussion relevant to an inventive idiomorphic information product named NEWSORT, included a FIG. 12 and accompanying text regarding PROGRAM DELIVERY. All of the techniques and other discussion there also applies to the current situation, modified as needed to take into account various potential differences. For just one limiting example is acknowledged that, generally, NEWSORT content will be relatively large video files, while grains of granular content will, generally be smaller. However, NEWSORT video files will, optionally, be conglomerates of much smaller content portions; and, granular content will, optionally, be delivered as a package of many grains. Thus, the difference between packages as delivered, in practice, may be small. In, general, however, the techniques described in the section of the parent document(s) entitled PROGRAM DELIVERY, or other related techniques, will, optionally, be employed to effect deliveries of content and other information to users in timely fashion, while avoiding to whatever extent possible additional cost or delays for such deliveries; level out server load to reduce peak bandwidth requirements; permit deliveries during overnight hours when the demand on networks, servers, or use of client systems by users will be at a minimum, at least statistically, etc. Any such scheduling will, optionally, be made by any combination of the inventive service, user, or third party's systems; on an individual, group, statistical, semi-or-completely-random, or arbitrary basis; based on user profiles, including the specifics of what content has been downloaded previously and/or history of user activity as a function of time, etc., content or advertising type, or otherwise; automatically, or via a human (e.g., end user, or customer service representative) request; etc.

All of these techniques are also, optionally, applied to the interaction between the inventive service, the user, and, optionally, paying clients, for the exchange of accounting and/or payment and billing information, for example as in (1830) and (1831), (1363) and (1364), etc.

It should be noted that while content will, optionally, be downloaded in advance and stored for later use, advertisements will, optionally, be downloaded in a closer to real-time fashion. Such may be necessary because it will, optionally, be desired to match a segment of content downloaded hours, days or weeks previously, with an advertisement from a particular advertising client. However, the advertisement that the client would have had displayed last week or yesterday (or, even 10 minutes ago) will not necessarily be the same as the one they would have displayed now. Thus, even if not in real time, advertising materials will, optionally, be updated on a more frequent or timely basis than content. Similarly, any eComerce activity, while optionally done in an asynchronous and/or off-line fashion, will, in other situations, require real-time interaction. In some embodiments, large amounts of content and/or other material will be supplied, for example on a DVD-ROM or other medium, or pre-loaded on a system. In that case, fresh content, advertising and marketing materials, and other information will optionally update this library of materials, as above or otherwise.

As illustrated in a non-limiting example in FIG. 19, large media files are encrypted only once, and small decryption key files are encrypted many times, optionally uniquely, for many users (or groups of users). This will reduce the encryption overhead on the inventive service bureau, while still providing security that is user specific, or with such a large number of keys as to be nearly so.

FIG. 19 shows the inventive service bureau (19000), a first client (19100), a second client (19200) and . . . an N^{th} client (19300). In one operational section (19070) of the server (19000), three large media files (19001, 19002 and 19003) are each encrypted by a separate and distinct encryption key (19011, 19012, 19013) respectively, in order to create three encrypted media files (19021, 19022, 19023).

In a second operational section (19080) of the server (19000), a media decryption key corresponding to each (M generally, in this case three) of the media encryption keys (19031, 19032, 19033) are themselves encrypted by encryption keys (19110, 19210 . . . 19310) for each of the end users or clients (C generally, in this case also three). This results is an M×C cross product (in this case 3×3), with each element comprising ‘a media-specific decryption key, encrypted by a client-specific encryption key’ (19111, 19112, [19113]; [19211], 19212, 19213; 19311, 19312, 19313) . Note that, in practice, media/client key pairings, for which a particular media file is not expected to be delivered to a specific user, need not be computed; in this case the two empty keys that would be labeled (19113) and (19211) are such non-computed keys. Also note that, generally, the media encryption keys (19011, 19012, 19013) are distinct from the media decryption keys (19031, 19032, 19033); however in come cases, for example a simple password or certain types of encryption/decryption schemes, the encryption keys are, optionally, the same as the decryption keys.

Each of the client systems (19100, 19200 . . . 19300) has, optionally embedded with the inventive-service-supplied granular player or other software, available to it a client-specific decryption key (19120, 19220, 19230) that is used to decrypt files encrypted by, and which is, generally, distinct from, the corresponding client-specific encryption key (19110, 19210, 19310). Each of the client systems also receives from the service bureau computer, via a network or otherwise, a package of materials (19130, 19230, 19330) respectively. Each such package contains pairs comprising a media file, which has been encrypted by a media-specific encryption key, and which is, generally, the same for each user; and, the corresponding media-specific decryption key needed to decrypt that media file, which decryption key has itself been specifically encrypted with a client-specific encryption key. Package (19130) contains (19021/19111 & 19022/19112); package (19230) contains (19022/19212 & 19023/19213); and, package (19330) contains (19021/19311, 19022/10312 & 19023/19313). Note that only one media file (the second) is delivered to all three client systems shown; and that only one client system (the third) receives all three example media files.

In a second portion (19380) of the third (N^{th}) client system, which is distinct from the portion (19370) corresponding to the depiction of the other two client systems, is shown a single example of how a decrypted media file is reconstructed. This is one example of how the third media file (19003) is recovered by the third (N^{th}) client system (19300) and is representative of how the other six file/client combinations (1/1, 1/3, 2/1, 2/2, 2/3, 3/2) not shown.

In section (19380), the encrypted (by client-specific encryption key (19310)) media-specific decryption key (19313) is decrypted by the corresponding client-specific decryption key (19320) to recover the original media-specific decryption key (19033). In turn, that media-specific decryption key (19033) is applied to the encrypted media file (19023) to recover the original media file (19033) which is then available for immediate display, storage for later use, or otherwise.

It is within the intended scope of the instant invention that any identification, encryption/decryption, encoding/decoding or other security mechanisms, now know or later developed, including without limitation public key/private key encryption or other security schemes are, optionally, utilized for such purposes.

### Meta-Media and Meta-Information

The meaning of the prefix meta- is discussed at the web page http://en.wikipedia.org/wiki/Meta.
“Meta- (from Greek: μεT\acute{α}=‘after’, ‘beyond’, ‘with’, ‘adjacent’, ‘self’), is a prefix used in English (and other Greek-owing languages) to indicate a concept which is an abstraction from another concept, used to complete or add to the latter. . . . The OED cites uses of the meta- prefix as ‘beyond, about’ . . .
In epistemology, the prefix meta is used to mean about (its own category). For example, metadata are data about data (who has produced them, when, what format the data are in and so on). . . . Its use in English is the result of back-formation from the word ‘metaphysics’. . . . The use of the prefix was later extended to other contexts based on the understanding of metaphysics to mean ‘the science of what is beyond the physical’. . . . Note also that this modern meaning [per Quine 1927] allows for self-reference, since if something is about the category to which it belongs, it can be about itself; it is therefore no coincidence that we find Quine, a mathematician interested in self-reference, using it. . . . Douglas Hofstadter, [author of the] 1979 book Gödel, Escher, Bach . . . uses meta as a stand-alone word, both as an adjective and as a directional preposition (“going meta”, a term he coins for the old rhetorical trick of taking a debate or analysis to another level of abstraction, . . . ”

In particular, elements of these defining statements that apply here are that metamedia contain information that is about the media. This is not necessarily limited to optional or typical ‘metadata’ or identifying information such as title, author, format, length, etc; or to the inclusion of interactive elements such as those employed in hypermedia. Metamedia will also, generally but optionally, contain information about the media that can be used to reshape the media into an array of flexible alternative presentations, or for alternative uses, such as those described as idiomorphic in the instant application and parent or related document(s), or otherwise. Such meta structures include, but are not limited to, those described, in the instant application and parent or related document(s), as emulsified, pyramidal, abstracted (for time, content, use preference, or otherwise), tagged, granularized or granulated, or otherwise.

Thus, while metamedia can be displayed in much the same way that standard media are, metamedia can also, optionally, be presented and/or used in flexible customizable or ‘idiomorphic’ fashion, or in other non-standard fashion. The options and techniques for the creating, editing, formatting, structuring, storing, filing, notating, presenting and otherwise processing and managing metamedia, are similarly enhanced and, generally but optionally, involve the enhanced or meta information, which extends beyond mere content, and comprises or is associated with metamedia.

Thus, in this application, the term metamedia means media that comprises “advanced” information, and/or has been “enhanced” to incorporate such information and/or to create an association with such information; and thus will, optionally, be capable of presentation or other processing or management that goes “beyond” that of: simple content-oriented media, the incorporation and use of simple indentifying or metadata, typical hypermedia and/or typical interactive media.

Regarding the processing involved—which will, at times, involve the creation of meta-media from scratch, but which will, more generally, involve the formatting, supplementing, merging, enhancement, reorganization, etc. of more standard media into meta-media—it will often involve, at least conceptually, two phases. Apt analogies can be made to the complementary sub-processes of analysis and synthesis:
“The terms analysis and synthesis come from (classical) Greek and mean literally ‘to loosen up’ and ‘to put together’ respectively. These terms are used within most modern scientific disciplines—from mathematics and logic to economy and psychology—to denote similar investigative procedures. In general, analysis is defined as the procedure by which we break down an intellectual or substantial whole into parts or components. Synthesis is defined as the opposite procedure: to combine separate elements or components in order to form a coherent whole.”{4}4. From the Introduction of “Analysis and Synthesis: On Scientific Method—Based on a Study by Bernhard Riemann” by Dr. Tom Ritchey, Swedish Morphological Society, Stockholm, Sweden. Originally published in Systems Research, 1991, Vol. 8, No. 4, pp 21-41, Thesis Publishers, ISSN 0731. Revised version, 1996. (Downloaded from the Swedish Morphological Society: www.swemorph.com) found at: www.swemorph.com/pdf/anaeng-r.pdf
   or, perhaps more aptly, to metabolism, and its complementary sub-processes of catabolism and anabolism:

“The modern English word ‘metabolism’ comes from the Greek noun metabole, meaning ‘change’, and the Greek verb metaballein, meaning ‘to change. [And, thus, meta-media can also often correctly be thought of as changed or enhanced media.]

According to Medilexicon's medical dictionary, metabolism means ‘1. The sum of the chemical and physical changes occurring in tissue, consisting of anabolism (those reactions that convert small molecules into large), and catabolism (those reactions that convert large molecules into small), including both endogenous large molecules as well as biodegradation of xenobiotics. 2. Often incorrectly used as a synonym for either anabolism or catabolism.’

Catabolism is the breaking down of things . . . Anabolism is the building up of things . . . ” {5}5. Excerpted from “What Is Metabolism? How Do Anabolism And Catabolism Affect Body Weight?” 10 Aug. 2009 Medical News Today, to be found at: http://www.medicalnewstoday.com/printerfriendlynews.php?newsid=8871

Thus, the processing of meta-media, particularly when it involves the transformation of more standard media into meta-media, will often involve: a first phase, where the input media are at least analyzed and, optionally, actually taken to pieces; and, a second phase where the identified, or broken down, components—optionally in combination with other, generally supplemental or auxiliary, elements, such as grain boundaries, various tags, edit decision lists, etc.—are then built up into a coherent whole instance of meta-media.

Alternatively, with such supplements or enhancements as goals, meta-media can be created or constructed from scratch.

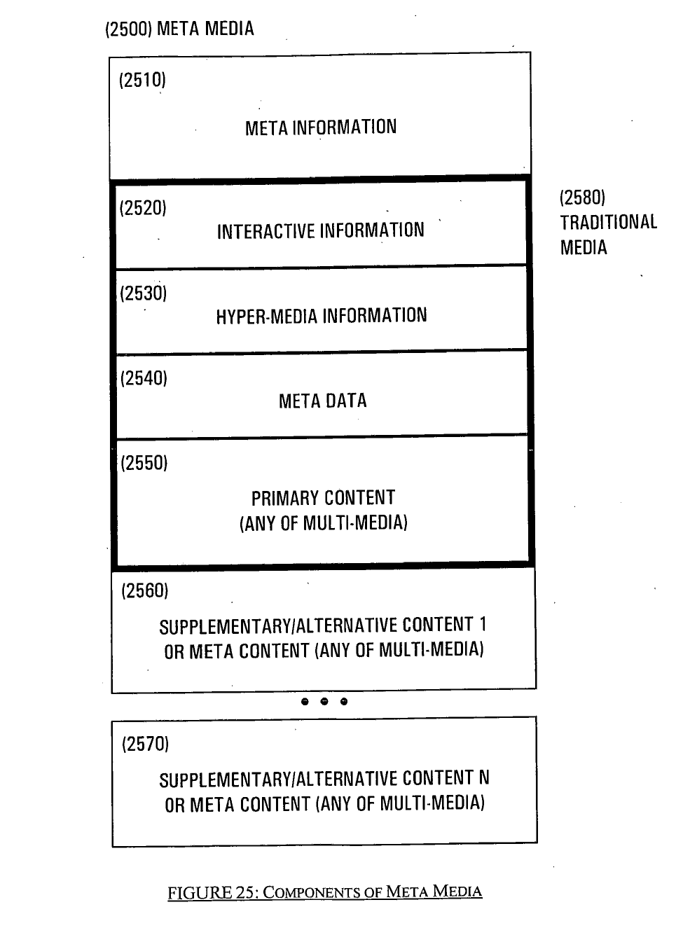

The concept of meta-media (sometimes referred to by related terms metamorphic media or idiomorphic media) has been used extensively throughout the instant application and parent documents—sometime by using these terms explicitly and sometimes not. An explicit description is illustrated in FIG. 25.

A non-limiting example of meta-media (2500) comprises at its figurative core, literally illustrated by the heavy box, an instance of traditional media (2580), generally as digital information. Such traditional digital media (2580) in turn comprise content (2550) which will further comprise any combination of media generally falling under the rubric of multi-media, including, but not limited to: text, audio, still graphics and photographs, animated graphics and motion picture imagery, or otherwise. Such traditional computer media (2580) also frequently contains interactive information (2520), hyper-media information (2530), meta data (2540) and/or other elements not strictly content. Meta data (2540) generally comprises information such as title, author, copyright information, etc., that identifies the media. Hyper-media information (2530) generally comprises data and/or mechanisms for linking or jumping to other locations within the present document, or to other documents. Interactive information (2520) generally comprises data and/or mechanisms to permit user input and document response. Interactive media information is often integrated with hyper-media type information to implement menus, data entry, question/answer interaction, searches, etc.; to implement games or other interactive applications, etc.; but, such is potentially crossing the boundary between media and application program, depending upon one's definitions.

In any event, meta-media (2500) and meta-information (or meta-media-information) (2510) are generally employed to enable additional capabilities. In many preferred embodiments that capability is to enable delivered media to be presented in a multiplicity of optional configurations (sometimes referred to herein as metamorphic or idiomorphic) depending upon a number of factors, generally an interplay between certain portions of the meta-information and information associated with a user (which user related information is, optionally, considered a portion of the meta-media-information).

Meta-information (2510) will comprise, without limitation, information such as:
information about formatting, parsing, segmentation and/or structures, such as granular or pyramidal structures;
edit decision list, or other information, to implement abstraction of media for length;
edit decision list, or other information, to implement abstraction of media for content according to subject matter, potential user interest or preference, potential user age or reading level, potential user identifying characteristics or group membership, etc.; and,
tagging information including that about when, where, how, for what purpose, for what audience(s), and by who, the document was created, edited, clipped, stored, etc.

Further information pertaining to the user (user preference or interest, purpose for accessing the document, identifying characteristics (e.g., age, gender, profession, social and ideological designations, etc., not just—or even necessarily—name, rank and serial number), roll, capabilities, etc.), which will be use in conjunction with the above, in order to implement media presentation options, will also, optionally, be considered part of the meta-information. Although, optionally, this user related information will not be part of the meta-media proper, it will, generally, be utilized in conjunction with the meta-information in order to offer an appropriately structured presentation derived from the meta-media. The meta-information, such as described in the bullets above and/or as pertaining to the user, will, optionally, be stored and/or conveyed with the content and/or other meta-media elements in a single file, or conveyed as a single package of information; elements will originate and/or exist separately in time and/or location, and/or be conveyed separately; or, these various elements will be created, stored, conveyed, integrated, used, etc. in any combination of similar or disparate manners.

In other preferred embodiments, meta-media (2500) and meta-information (2510) are generally employed to enable capabilities that permit media, or selected segments of media, to be associated with meta-information that subsequently permit such media to be stored, retrieved, searched for, or otherwise organized and/or used in ways that permit associative links to be made between the media with such meta-information and other such media, user intent, user recollection, or otherwise. Meta-information is also optionally employed for still other purposes in some preferred embodiments.

Many of the embodiments described, including some described as abstraction, comprise designating multiple subsets of content for various optional presentations. Others describe situations where alternative presentations comprise substituting alternative content information and/or supplying supplemental content information; e.g., replacing X or R rated scenes or dialogue segments that have been ‘abstracted out’ for young or sensitive audiences, with PG or G rated alternative material. Other instances of substitute or supplemental information include, without limitation: further detail and/or research material; material from alternative perspectives; alternative language material; illustrative material; related materials, optionally available on the internet, or otherwise. When such supplementary or alternative materials are not provided as primary content (2550), they are provided as packages of supplementary/alternative content 1 (2560) through N (2570). They will comprise any combination of the forms under the rubric multi-media, or otherwise, and will not necessarily be of the same format as the primary content (2550) or as each other. To whatever extent these packages of supplementary/alternative content are not part of the original traditional media (2580) they fall under the ‘meta’ part of the meta-media, if not actually under the term meta-information. They will generally be designated meta-content.

To some extent, extant capabilities described as interactive information (2520), hyper-media information (2530), meta data (2540) and/or otherwise will seem to, or in fact will, overlap to some degree the capabilities described as meta-media, meta-information, meta-content, etc. as used herein. To whatever extent embodiments described herein utilize novel elements, or use extant elements in novel ways, those embodiments are intended to be within the scope of the instant invention.

### Meta-Media Transformation

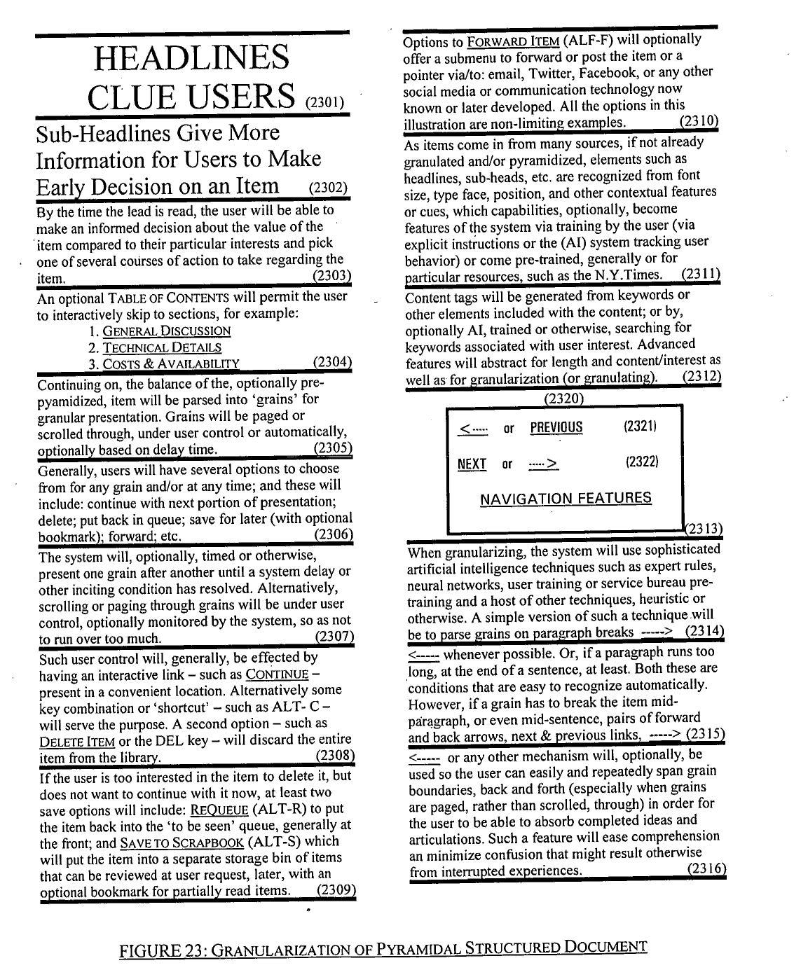

FIG. 23 depicts an example of how meta-media of one type is transformed into meta-media of another type. In particular, in this non-limiting example, a meta-media article of pyramidal format is transformed into granular media. The subject matter of the article is, in fact, just this subject and is incorporated hereby as part of the disclosure as well as a figure. Note that grain boundaries in FIG. 23 are represented by heavy horizontal lines between grains (2301 through 2316), without enumerating for each a separate element number. For visual clarity, grain boundaries are also indicated before grain (2301), both after (2309) and before (2310) because of the columnar format of the figure, and after (2316). In practice, the beginning of the first grain (and the end of the last grain) will not necessarily be offset by a boundary marker; only one grain boundary between (2309) and (2310) is necessary; and, in this case the boundary after (2316) is necessary since the article continues with additional grains, although that is not explicitly shown.

The pyramidal structure comprises various parts that have been parsed out into a series of grains as follows: a title or headline in grain (2301); a sub-headline in grain (2302); a lead in grain (2303); an optional table of contents in grain (2304), which in this case depicts hyper-links to sections labeled General Discussion (2304.1) starting at grain (2305), Technical Details (2304.2) starting at grain (2308), and Costs & Availability (2304.3) starting at some point after grain (2316); with the balance of the article continuing from grain (2305) onward, with a brief general discussion in grains (2305) through (2307), and more detailed information starting at grain (2308). Note that early pyramidal elements (2301 through 2304) with progressively more text are presented in a progressively smaller font size to fill a single grain, and that later progressively larger pyramidal sections are split into three (2305 through 2307) and nine (2308 through 2316) grains respectively to take into account the content limitations of the grain.

Note that grain (2313) comprises a graphic FIG. 2320) of Navigation Features, including those to go back (2321) and forward (2322). Other navigation structures and mechanisms now known or later developed are also substituted for, or incorporated with, these and are considered within the scope of the instant invention. For example, these will optionally include, without limitation: the up arrow, or the right arrow in conjunction with a shift, Ctl, or Alt key will, optionally, skip forward multiple pages, up a level in documents of multi-level formats, or otherwise; speed and/or level of detail controls for abstracted meta-media; download preference controls when obtaining multiple documents; etc.

See the contents of the granular document depicted in FIG. 23 for additional exemplary details of structure, navigation, etc.

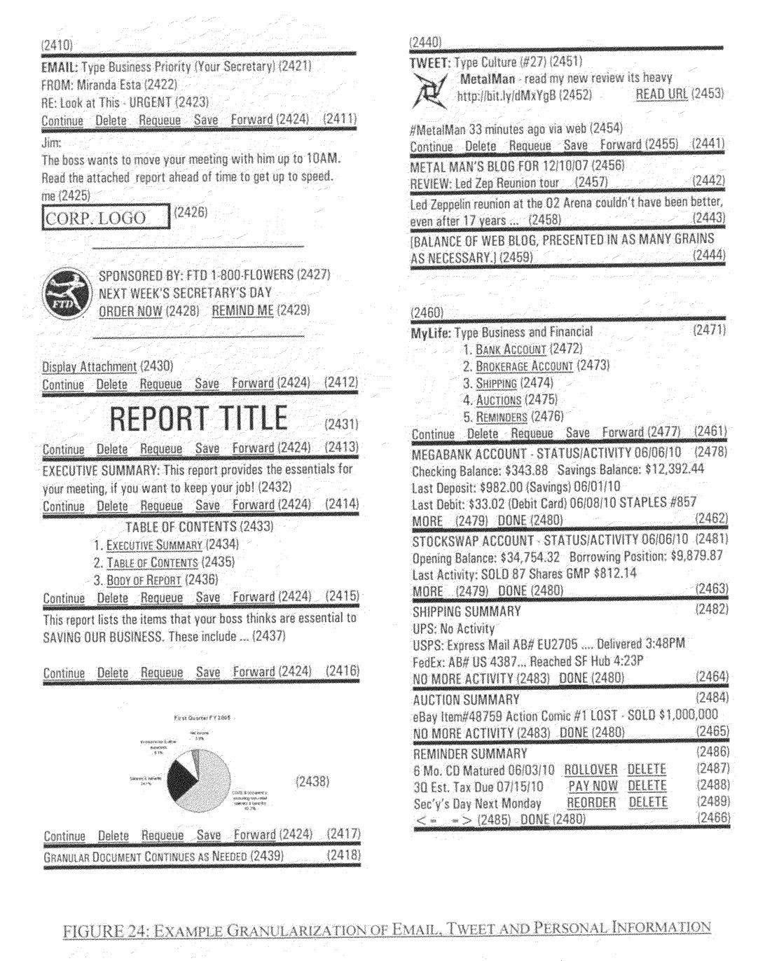

FIG. 24 depicts three additional examples of how media of one type is transformed into meta-media of another type. In particular, in these non-limiting examples, an email message with attachments (2410), a Twitter message with a referenced blog (2440), and an aggregation of personal information (2460), are each transformed into granular media suitable for granular display. For each of these, the same conventions regarding grain boundaries as in FIG. 23 apply. Also, for space requirements, the navigation/action elements (2413, 2455 and 2477) which are repeated for each grain of the email message (2410) are only shown (but are, generally, also repeated) in the first grain of the Tweet (2440) and personal information (2460).

The granulated email (2410) comprises grains (2411 through 2416) and continues as necessary. Grain (2411) is the email header and, for example, comprises notice that this is an EMAIL and the type (2421); the ‘from’ field (2422); the reference line (2423); and, other fields as required or desired (e.g., the date sent, status, etc.).

In addition shown at the bottom of the grain display—but which will optionally be displayed elsewhere, pop up only on roll-over of the lower portion of the grain display, be un-displayed but invoked via key combinations, or otherwise—are an exemplary set of action/navigation functions (2424). These comprise, without limitation: Continue, Delete, Requeue, Save and Forward; which will alternatively, optionally, be invoked, for example, by Alt-C, Alt-D, Alt-Q, Alt-S and Alt-F, respectively. Continue indicates that the user wants to move on to display of the next grain (there may also be a ‘back’ function as well, as shown, for example, in (2321)); Delete indicates that the user wants to discard the entire granular document; Requeue indicates that the user does not want to continue with this document now but, rather, wants it reentered (at the head, tail, or otherwise, choice mechanism not shown) into the queue of items (or, e.g. an unread inbox folder, an ‘in bin’ in a meta-media filing system holding items for review by the granular player, or otherwise) to be presented to the granular player; Save indicates the email is to be saved (to a saved mail folder, a ‘scrapbook’ in a meta-media filing system holding items for general review, a meta-media filing system generally, or otherwise); Forward will invoke imbedded versions of typical email and/or social media forwarding functions, with integrated contact lists and groups. Although, generally, a granular document will be requeued, saved or deleted, an option to eXit (Alt-X) without any of these actions may also be, optionally, provided; as well as other action/navigation options. Similarly a Reply (Alt-R) function (not shown) will invoke a comparable email reply function; or Reply and Forward will, optionally, be integrated into a single combined function. Invocation of any of these functions, but particularly the forward/reply functions will cause additional windows to display in or near the granular content window to manage contact lists, compose reply content, or otherwise. Implementation and system management of such functions within limited displays (e.g., within a granular display window) has become routine with the use of Blackberries, iPhones and similar devices, and is within the ken of those skilled in the appropriate arts.

Next grain (2412) contains the body of the email (2425) including an attached business logo (2426). Grain (2412) also contains a service-supporting advertisement (2427), which itself includes: an advertiser's logo (no separate element number); an order now button or link (2428) which will in practice, optionally be a one click order, invoke a pop-up supplementary order window, or otherwise; and, a remind me button or link which will place the advertisement in the ‘scrapbook’ in a meta-media filing system, or some other action queue, and will, optionally, mark the meta-media with meta-information indication action (reminding, ordering or otherwise) is necessary and, optionally, setting a reminder or alarm function. Also included is an additional action/navigation button/link that will cause the attachment (the report starting at grain (2413)) to display in granular fashion; and the action/navigation links/buttons (2424) already described. In practice, depending upon the length of the body of the email, grain (2412) will be displayed as a sequence of several grains; and, in particular, any advertisement(s) will, optionally, be presented as grain(s) separate from the email body. Also note the synergistic relationship between the advertisement (flowers for “next week's secretaries day” attached to an email sent by a (presumably) efficient secretary) and the sender/recipient relationship.

An action/navigation hyper-link (2430) (or the Continue link) will cause the granular display of the attached report. Grain (2413) comprises a Title (2431); (2414) an Executive Summary (2432); and (2415) a Table of Contents (2433). ToC (2433) in turn has three hyper-links: (2434) that links to grain (2414); (2436) to (2416); and, (2435) that somewhat redundantly links to the present grain (2415). The body of the report itself starts in grain (2416), includes graphic (2438) in grain (2417), and continues in grain (2418) and beyond as long as needed (2439).

Twitter message and referenced document (2440) is converted for granular display with the tweet itself comprising a single grain (2441) displaying a heading/type (2451) and typical tweet elements of message (2452), including a sender's ‘handle’ and an associated avatar image, and a tiny url for a referenced document, a blog; and, a hashtag with how the tweet was sent (2454); also, the action/navigation functions (2455 comparable to 2424). Note that ‘Forward’ here will, optionally, be replaced by a retweet function. There is also a hyper-link (2453) that will cause the document found at the tiny url to be displayed. That document, MetalMan's blog, is displayed starting at grain (2442) and continuing as long as required to display the balance of the blog, but only as long as requested by the user.

An aggregation of personal information (2460) as produced by the inventive service as described elsewhere herein and/or in parent document(s), is converted for display in granular format. The first grain (2461) comprises a Title (2471); five hyper-links (2473 through 2476) in a type of table of contents linking to personal information grains (2462 through 2466, respectively); and, the action/navigation functions (2477, like 2424 and 2455) that are not separately shown in the remaining grains.

In the personal information grains (2462 through 2466), each displays information of a different type (banking, brokerage, shipping, auction and reminders, respectively, in this example). Each has an active “done” link (2480) to return to the table of contents grain (2461). The first two also contain an active “more” link to display additional grains of detailed information beyond that displayed in the summary grain. The next two, instead, display an inactive “no more activity” message (2483) indicating that there is no additional information beyond that which is displayed in the summary grain. And the last, instead, as a pair of active scrolling widgets <= and => (2485) that permit scrolling up and down through the list of reminders (2487 through 2489) with others not shown. Other action/navigation functions or mechanisms, not shown, now known or later developed, are used in substitution for, or in combinations with, those described.

In reminder grain (2466): item (2487) provides two active links to, in an automatic or computer assisted fashion, “rollover” the CD account, or to delete the reminder from the list; item (2488) has links to “pay” the tax due, or delete the reminder; and, item (2489) links to “reorder” the same flowers as last year (see (2428)). Many of the items invoked by the various “more” links will, optionally, include action links such as those shown for reminders (2487 through 2489); or, will invoke supplementary windows or other mechanisms that will permit more complex interaction (e.g., carry out banking or brokerage transactions).

### Social Editing

As described in an earlier section of the instant document entitled Social Publishing, it was discussed how the institutional gatekeepers of quality are being eliminated from the publishing process. In order to overcome this, and related problems—for content creators, to find an audience—for media consumers to find something worthwhile to consume—inventive embodiments are disclosed where customer bases of an inventive service, and/or other social communities, are harnessed to address these problems. In as much as functions such as vetting content for appropriateness and worth, identifying content/audience matches, and editing content, traditionally more often fall under the purview of those carrying the title of editor rather than the publishers they work for, the rubric chosen for the technical details to effect social publishing is social editing.

While traditional editorial functions are generally directed toward modifying the content of media to match the editor's perceived requirements for their audience, a primary additional object of social editing will be to modify a flexible definition of intended audience to better match the media. More particularly, social editing will operate to identify, in a wholly or partially automated fashion, one or more audience segments appropriate for items of media. Social editing is much more than a popularity contest, more than views or likes on YouTube, followers on Twitter, friends on Facebook, or diggs on Digg.

Social editing techniques are particularly well-suited to be carried out in association with information distribution activities implementing the inventive idiomorphic techniques disclosed herein and in the parent document(s). This is because of the, generally, large audience base and highly detailed user demographic (including preferences, history of use, etc.) information about the users available to such a service. Although the following discussion will be carried out in relation to publishing media via inventive services described in the instant document and/or its parent documents, these techniques will have applicability and utility to other purposes including, but not limited to:
modifying the content of, identifying audience segments and/or marketing strategies for, either inventive or other publishing and distribution ventures;
providing guidance regarding modifying the content of, identifying audience segments, and/or marketing strategies for, works of media separate from a specific publishing and distribution activity;
providing guidance regarding modifying, identifying market segments, and/or marketing strategies for, products and services other than works of media, which will optionally be conducted by distribution of media describing the product or service, rather than distributing the product or service itself;
use by an author or other media creator themselves, as part of the creation process, to implement ‘social authoring’ rather than ‘social editing’ by a third party;
assist in the creation, editing and/or publishing of works created by a social community or other group;
implement, enhance or assist other identification of audiences or trending among meme pools ^{TM} or opinion pools™; {6}6. This constitutes a working implementation of a capability foreshadowed by John Brunner in The Shockwave Rider (1975, Harper and Row) long before the public internet and WWW browser.
Etc.

That is to say, generally, that, in addition to providing social editing functions to idiomorphic publishing ventures as described herein and in the parent document(s), the customer base of such ventures (or a comparable member-base) is, optionally, used for many purposes, including providing intelligence and services to other entities without access to such groups and processes.

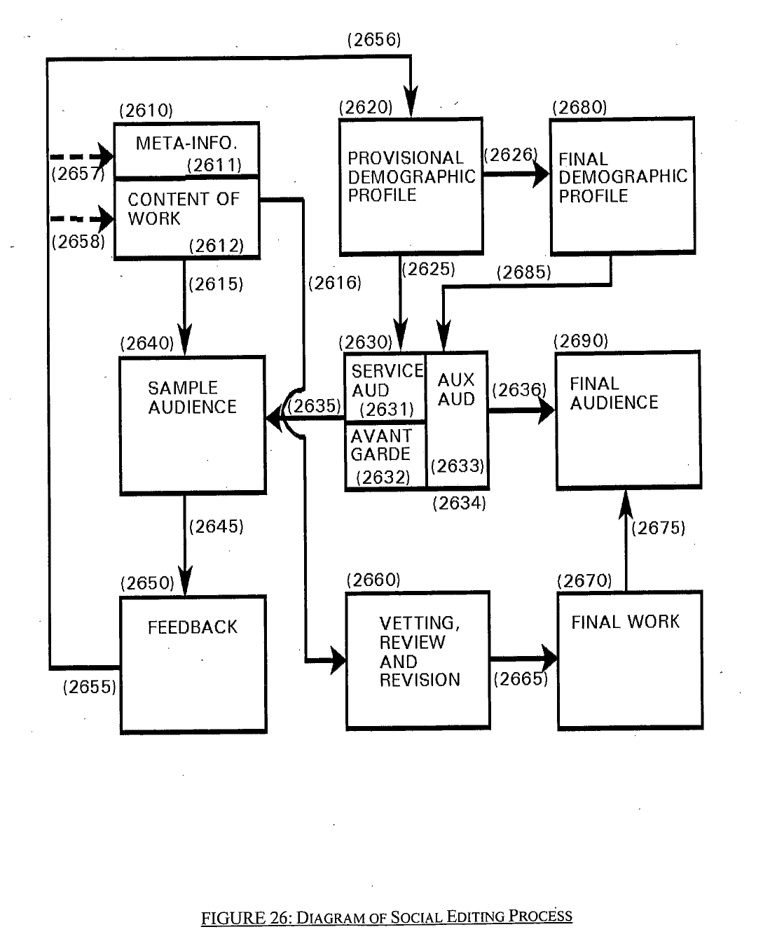

Turning now to FIG. 26, a system diagram is shown that depicts a non-limiting example of how information elements are interrelated, and how information flows between such elements, to perform social editing functions.

It is generally presumed for the sake of the following discussion that there is a significant number of individuals in the particular audience or customer base involved. For example, with a customer-base of 10 million, 50 iterations to collect feedback from completely distinct sample audience pools (2640) of 200 members each will involve just 1% of the entire customer base. Nevertheless, the same principles and processes can be scaled for customer bases of different sizes by adjusting the number of iterations, the size of test audiences, etc.; although it is noted that statistical error increases as sample size decreases. Statistical methods are well known and within the ken of those skilled in the art and will not be dwelled upon further.

The Delphi Pool, Brunner speculated “works, approximately, like this. First you corner a large—if possible, a very large—number of people who, while they've never formally studied the subject you're going to ask them about and hence are unlikely to recall the correct answer, are nonetheless plugged into the culture to which the question relates. Then you ask them, as it might be, to estimate how many people died in the great influenza epidemic which followed World War I . . .

Curiously, when you consolidate their replies they tend to cluster around the actual figure as recorded in almanacs, yearbooks and statical returns. It's rather as though this paradox has proved true: that while nobody knows what's going on around here, everybody knows what's going on around here.

Well, if it works for the past, why can't it work for the future? Three hundred million people with access to the integrated North American data-net is a nice big number of potential consultees.”

A work (2610) that is to be socially edited will comprise a traditional media work or will, optionally, comprise a work of meta-media comprising both content (2612) and meta-information (2611). The process starts with the work (2610) and a provisional starting place to specify the demographic profile (2620) of the audience niche for the work. That provisional demographic profile (2620) is applied to (2625) the potential audience pool (2630) to select a sample audience (2640) the members of which will have generally not yet been exposed to this work. (Alternatively, under some circumstances it will be useful to have some audience members see a work for one or more additional times, optionally, after amendment or editing.)

The audience pool (2630) will, generally, consist of three parts. One comprises the audience members (if any) who have specifically agreed to (or requested to) be part of an Avant Garde segment of the audience (2632) willing to try out un-vetted works; and, which agreement or invitation will, optionally, be limited to specific areas of interest or expertise. The balance of the audience (2531) who are not specifically part of the Avant Garde segment comprises the second. A third comprises an auxiliary audience (2633) who are not generally associated with the audience of the organization carrying out the social editing, the publishing effort, or otherwise; and, which may be drawn from an auxiliary roster; or, from social communities, for example those associated with blogs, YouTube channels, Twitter groups, Facebook friends, or otherwise. Such auxiliary audience members are used in addition to, or in lieu of, the usual in-house audience for any phase of social editing, including for distribution of the final form of the work. Regarding the first two sub-groups (2631) and (2632) it will often be the case that untried, unvetted works will not be distributed to audience members who have not agreed to receive such works; particularly for embodiments and ventures where idiomorphic or personalized customer satisfaction with content is paramount. (Nevertheless, in some circumstances, such an audience segment will be shanghaied for this purpose.) However, it is acknowledged that restricting sample audiences to (2631) may create a Truman/Dewey effect. {7}7. In the 1948 US Presidential election it was famously predicted by pollsters that Thomas Dewey would certainly win the election when, in fact, Harry S Truman did. A post mortem analysis of the poll concluded that, since it was conducted by telephone, the results were heavily skewed in favor of rich, and thus conservative and Republican, voters—the ones who, overwhelmingly, were among those able to afford home phone lines. Similarly, if social editing relies upon those willing to try out the Avant Garde, the population may be skewed left toward the daring intellectually curious, or right toward those eager to function as society's censors. Care will need to be taken to filter out from the process, or account for, such individuals with hidden agendas or outlier tastes—although both are valid audience demographic segments, they are not necessarily representative. It is noted, however, that the operation of social editing does overcome a related problem where groups with hidden, often commercial, agendas would hijack social technology sites (such as Digg, YouTube, Google) by flooding such sites with bogus traffic and endorsements (positive or negative).

Whatever the mix between (2631), (2632) and (2633) for any particular practice or embodiment, it will generally be referred to for discussion purposes as the audience pool (2630), unless the specific distinction between segments is relevant.

The provisional demographic profile (2620) can be initialized or started in many different ways. Some illustrative examples include, without limitation, the following:
An entirely random selection or flat demographic profile touching upon all categories or along all dimensions of age, gender, race, political and social opinions, religion, geographic location, levels of income and education, profession/job, stated interests, past history of system use or reviews or purchasing/consuming, etc. (The process can be conceptualized as operating within an N-dimensional feature space, with the mathematical dimensions corresponding to various demographic categories or ‘dimensions’.) Such a neutral demographic will, optionally, be partially or entirely skewed or limited along one or more of these or other dimensions or categories. For example, adult-oriented content will, generally, not be distributed to children and vice versa. However, such rational expectations can be incorrect; for example, the initial marketing focus of the Harry Potter books as for children only has proved to be massively incorrect. Other such limitations on the provisional demographic can be made on any combination of dimensions or categories (e.g., without limitation, those listed earlier in this bullet) with the same caveat regarding counter-intuitive audience interest. For example, a genre work which unexpectedly has broad appeal, or appeal to an unexpected niche audience.
Because, generally, this process will be conducted iteratively, and the process is expected to refine or hone in on one or more focused audience segments (each potentially defined by a complex demographic profile) there is the potential for ‘the butterfly effect’—that is, a sensitivity to distinct but not dissimilar initial conditions achieving vastly different results, particularly if the sample is small in size or (inadvertently, or otherwise) skewed. This may also be though of as similar to a situation where a hill climbing algorithm (searching for a minimum) becomes trapped within a locally minimum depression within a high plateau. Starting in a sufficiently different neighborhood will avoid this trap. Consequently, whether starting with a random/neutral profile, or one that is limited or skewed, it will be beneficial to, optionally, run the same profile to extract several comparable but diverse subsets, and iterate on each. If several such attempts converge to a stable refined demographic profile then confidence is high. If they diverge, then sampling or statistical error, or algorithmic anomaly would be suspected. In that case additional runs; runs with larger samples (which, optionally, will be runs starting with the combined information of outcomes of multiple smaller runs—but, generally, not revisiting people who have feedback on an item for a second ‘read’); one or more tries with different starting profiles that have significantly different locations (in demographic feature space), spreads or other characteristics, generated by rational (with optional human assist), random, automated or Al algorithmic means.
The starting provisional demographic profile (2620) is, optionally, based in whole or in part by human intuition or research which may be performed by the author/creator of the work, a publisher, the inventive service or otherwise.

It is also possible that rather than audience identification, use of some version of this process will be made to test the acceptance by a specific audience demographic of a work of media or other item. In which case the entity conducting the test will, generally, specify (2620) to limit the sample audience, rather than to specify a starting place. Nevertheless, such a process will, optionally, be conducted iteratively in order to obtain confirmation and confidence, refine the product or questions being asked of the sample audience, or otherwise. In particular initial results will, optionally, cause the entity conducting the test to refine their experiment prior to a subsequent iteration.
A computer using automatic or more sophisticated Al algorithms will, optionally, choose a starting place for (2620) that is ‘appropriate’ rather than random. To the extent appropriate and effective, any of the techniques that are used by the system to refine (2620) prior to each iteration can be used ‘cold’ to initialize (2620). However, since most of these techniques will be based on sample audience (2640 via 2645) feedback (2650 via 2655 through 2658), they may not be usable in the absence of such feedback at the start of the process. Alternative sources to substitute for such system feedback (user feedback from other sources, author/creator or service input, etc.) will, optionally, be used to jump-start such algorithms.

Alternatively, the computer will use any number of ways to computationally deduce an appropriate or expected provisional demographic profile. Examples of these include, without limitation:
an examination of the text (or other content), key words or meta data or meta-information to deduce a user interest profile to use in (2620);
an examination of the text (or other content), key words or meta data or meta-information to deduce what other ‘similar’ documents exist and, from the demographic profiles associated with those other documents, construct a provisional demographic profile (2610);
datamining or related techniques can be applied to identify related documents (as above, or otherwise) and from use records and/or feedback about those documents construct a provisional demographic profile (2620) directly; or, to use such feedback of related documents (as if they were in response to the work under scrutiny) as an input (2656) to ‘iterate’ a start for (2620);
or, otherwise.
By whatever method used to obtain an ‘appropriate’ or ‘expected’ provisional demographic profile (2620) at the start or any stage, it will also, optionally, be the practice to test one or more counter-profiles. These will test what should be ‘inappropriate’ or ‘disinterested’ sample audience segments to confirm their disinterest, active dislike, or other negative response; or, to see if some paradoxical, unexpected, counter-intuitive, or computationally missed audience niche does exist.
If the work under scrutiny (2610) is a work of meta-media, the meta-information (2611) will, potentially, be a source of demographic expectation. Further, if the work of meta-media is of the kind referred to herein and in the parent document(s) as abstracted, different versions of the media will, generally, be delivered to different users based on their personal demographic/preference/user profile. Consequently, social editing of such an abstracted work will be complicated by the fact that different users will be feeding back about different versions of the work. So, in theory, for example, an abstracted work may be hypothetically very well received but, in practice, because it has been abstracted poorly, delivering the ‘wrong’ subset of content to various user-base segments, it will be badly received. Thus, when social editing (particular for the less expected use of the process, for amendment as opposed to audience identification) it will, optionally, be the practice to suppress abstraction features, delivering the same version of the work to everyone in a sample audience; and/or, to separately test reaction to multiple abstracted versions separately, over a broader demographic sample than that particular version would normally go to. Consequently, there is a complex palette of uses of social editing combining elements of: identification of audience demographics (2620 via 2656); amending of content (2612 via 2658); and/or amending of meta-information (2611 via 2657).
The demographic profile for a work distinct from (2610) will, optionally, be used as the initial provisional demographic (2620) as a way to ascertain the expected audience overlap between works as an adjunct to making recommendations to system users, or otherwise.
A first pass, or set of passes will, optionally, be conducted using the Avant Garde (2632) and/or auxiliary (2633) audience segments. That will result in an iterated demographic profile (268 0) for which there is a fair degree of confidence. This will then, optionally, be used on one or more small subsets (2640) of the non-avant garde (2632) (for whom it is reasonably proper to deliver the work to, because it is no longer completely unvetted) or general (2630) audience. Thus, the iterative result (2680) of the first phase of the process will be used to start (2620) the second phase of the process. The first such phase will, optionally, be performed to ascertain if there is sufficient worth and/or interest to justify exposing the work (2610) to the general audience (2631); and, once and if that result is yes, the second phase will use a subset of that general audience to further refine the demographic profile before wide release to the general audience. An optional vetting and tweaking of the work will be conducted some time prior to that wide release.
Any other combination of human or computationally generated, or modified, demographic profiles will, optionally, be used to as input to (2620) for the start, or at any phase, of the social editing process.

As stated previously, the social editing process will, generally, be conducted as an iterative process. A non-limiting example of how one such iteration is conducted as follows:
1. The provisional demographic (2620) which is, in general, refined or updated prior to the start of all iterations subsequent to the first, is applied (2625) to any preferred segments (2631, 2632 and/or 2633) of the audience (2630). Different segments will, optionally, be drawn from for different iterations of phases of operation, as described above or otherwise.
2. Such application (2635) results in a (generally very small fractional) selection of a sample audience (2640). The selection is achieved by matching the provisional demographic profile (2620) with the personal demographic (also including user history and preferences, etc.) or user profile of individual users in the audience (2630). Such matching will, optionally, be conducted randomly, with the first N who sufficiently match being chosen; the N who ‘best fit’ the profile being chosen; or, otherwise. The fit will be defined as an exact match; as a threshold of at least M matches of various dimensions or categories; a more complex definition where some dimensions or categories have a scale of how much the user profile and demographic profile (2620) match for at least some of the categories or dimensions, where various dimensions or categories are weighted, etc.; or otherwise. A match will optionally be defined as binary (match or not); a minimum threshold of matching has been reached; an ordering where a matching value(s) (generally, or for a multiplicity of categories or dimensions) permit the ranking of potential sample audience (2640) members—where ‘best’ worst' or a range of matches (generally, or for a multiplicity of categories or dimensions) are used for audience selection; or, otherwise.
3. However the members of the sample audience for a given iteration (2640) are chosen, they will receive (2615) the current version of the work (2610). If the work is a work of meta-media and, in particular, abstracted, the version delivered to each member of the sample audience will, optionally, be customized.
4. The members of the sample audience (2640) will then provide (2645) feedback (2650) based on their experience with the work. Such feedback will, optionally, be any combination of the following:
   Simple yes/no, thumbs up/down on questions such as ‘did you find the work worth your time?’ would you want another work by this author?', ‘would you want another work on this subject?’, etc.
   Similar questions but with an answer scale, say 0 to 9, representing ‘not at all’ to ‘completely’, or multiple choice, but still easily machine-evaluated.
   More sophisticated questions regarding length, style, level of detail, what elements were liked/disliked, how did it make the user feel, what did the user think about, and so on. Any questions that the entity conducting social editing wants to know about. These will be used (generally, with yes/no, simple scaled, or multiple choice responses) by the system to automatically evaluate user reaction.
   Alternatively, fill-in text or free-form responses will be collected for the edification of a human editor; and/or, optional intelligent automated review and precessing.
   Feedback in the nature of a recommendation or review of the work.
   Additional demographic, preference, history, and other user-related information either not in the particular user profile (which will more likely be the case for auxiliary audience (2633) members) or specifically related to the work under scrutiny. For example, ‘are you a fan of science fiction?’ or ‘have you read any other books by this author previously?’
   Or, otherwise.

While such feedback will, in some regard, seem not dissimilar to that collected for any standard product evaluation; however, the purpose to which it is put is not standard.
5. Such feedback (2650 via 2655) will be used in any combination of (at least) three ways but, it is expected, primarily for the first, as follows:
   a. Via process (2656) to update, refine, focus, prune or otherwise modify the provisional demographic profile (2620) prior to the next iteration; or, if the final iteration, to generate the final demographic profile (2680). This final profile (2680) (or updated iterated profile (2620)) will, optionally, be further updated by a final computer pass, a subsequent phase of the social editing process, by human review and ‘tweaking’, or otherwise (not separately shown) before use.

For one non-limiting example that is simplified (in practice such computations will, optionally, be much more sophisticated and involve many more dimensions or categories within ‘demographic feature space’) for illustrative purposes, consider the following: A work (2610) is exposed to a sample audience (2640) of size 100 composed of a broad demographic swath. Results show that 88 members respond negatively and, of the 12 who respond positively, 9 are teenaged males (of which there are only 10) and the other 3 widely distributed single fans (a 56 year old man, a teen girl, and a 60 year old woman who, based on other elements of the response (e.g., left all default responses), is rejected as a valid responder because it is determined that she may have mis-understood or intentionally mis-answered the automated questionnaire). A second iteration is conducted composed entirely of 100 teenaged boys who are otherwise spread out demographically (in terms of location, race, educational performance, interests, family make up, economic background, etc.). The second iteration indicates that the demographic should be focused more specifically on teen boys who are only children and who are over achievers and who are fans of science fiction films. A third iteration which is so focused, but runs the gamut on other dimensions and/or categories is unable to locate other statistically significant indicators and, so, the iterative process in this example is considered to be complete.
b. Via process (2657) to update, refine, focus, prune or otherwise modify the meta-information (2611) of the work (2610). Instead of reshaping the audience selection to better match the work (as a., above) this alternative essentially is one way to reshape the work to fit the current audience profile. In particular, for abstracted meta-information automated updating is workable.

For one non-limiting example that is simplified for illustrative purposes, consider the following: An article about Bluray videos has been abstracted into 9 versions: the cross-product of three lengths (or levels of detail), short, medium long; and, three focuses of interest general, technical, creative. As per an initial setting of the abstraction information (2611) the medium/general version is sent to all members of a first sample audience. The article is rated as only moderately satisfactory. However, automated analysis (2657) of the data reveals that to a significant extent feedback (2650) indicated: a. males wanted more technical information; b. females wanted more creative or artistic information; c. those over 15 wanted more detail or a longer article; and, d. those under 15 wanted a shorter or less detailed article. The results will be applied (2657) to (which can be implemented relatively automatically if feedback questions are well-designed and tied to abstraction options ahead of time) modify abstraction information (2610) so that, upon a subsequent iteration (generally with a new sample audience but, optionally, with the some or all of the same) boys will receive the short/technical version, girls the short/creative version, men the long/technical version, and women the long/creative version. The result, in this example, is that the article is now reported (2650) to be far more satisfactory to many more members of the second sample audience (2640). What has happened is that feedback about the middle (in both dimensions) version of nine alternatives results in the middle row and middle column being eliminated, and the four extreme corner versions being used for four relatively well-defined demographic groups.

In practice, with many inventive embodiments as described herein and in the parent document(s) described, for example, as idiomorphic abstracted publishing, to an audience for whom detailed user preferences are known, it will be possible to deliver (or have the user system automatically extract) a version best suited to a particular user (e.g., long-medium-short and technical-general-creative); and, this would be independent of their gender or age; or, alternatively, personal preference meta-information, when available, would be used to override a default selection based on factors such as age and gender. However, in other circumstances, for example when delivering to a user for whom only access to a Google profile that has information about age and gender and little else relevant, a statistically good guess of personal preference can be made as a result of the above example. More to the point, however, is that what is determined during the iterative passes of the process is that—even though when a ‘plain vanilla’ version of the article receives mediocre response that would not warrant publishing or distribution—when diverse tailored versions are made available, and even a guess at preferences used for selected distribution, the response does warrant publication.

Social editing is about finding and refining a ‘best fit’ between a work and its audience; and, is not necessarily identical with the choices made and policies set for publishing or distributing the work based on the results received from the social editing process.

It is noted that, as large monolithic media institutions wane, the phenomenon of media events warranting water-cooler conversation (i.e., impressive media experiences shared by so many that discussions about it happens around the water cooler at the work place) do as well. With increasingly fractionated media, the opportunity for massively shared experiences lessens. The above example functions as a ‘water cooler with four spigots’ (metaphorically) encouraging diverse demographic groups to engage in a shared, if personalized, experience.
c. Via process (2658) to update, refine, focus, prune or otherwise modify the content (2612) of the work in question (2610) prior to the next iteration; or, if the final iteration, to generate the final version of the work, via (2616) which will then, optionally be submitted for staff or other vetting and/or tweaking (2660) prior to release (2665) as the final work (2670). This process of content (2612) update (2658) will, more likely than the others, be comprised, in whole or in part, of human guidance or intervention by an author, editor or otherwise.

For one non-limiting example that is simplified for illustrative purposes, consider the following: Free form feedback from a significant number of members of the first sample audience complain that the ending is too ‘sappy’ ‘sugary’ ‘Hallmark’, etc.; but, that they otherwise enjoyed the story. The author—under the guidance of his editor and agent, and pressure from his publisher—revises the story so that, at the end, the kittens use machine guns, rather than balloons, to convince the puppies to join their cause.

Alternatively, in response to a question about the included illustrations—“How did you like the illustrations. Rate from 0 for ‘hated them’ to 9 for ‘loved them’”—the average response was 1.5. The system prepares a revised work (2610) by suppressing images in (2612); and, in the next iteration, the revised work enjoys a greatly improved reception.

Alternatively, during an Al analysis of responses to a not-very-well-received work, it is determined that a particular word—a pejorative term—has a high frequency of occurrence in a fill-in question regarding ‘what didn't you like?’ and/or in proximity to negative words and phrases (hated, didn't like, offended by) in a free-form response area. Optionally using natural language analysis, expert system rules, and/or other Al techniques, the system will determine that the appropriate course of action is to replace each and every occurrence in the work of the offending term with a less-slangy synonym. A next iteration receives greatly improved response. Mission accomplished.

Alternately, a next iteration receives no better (or even worse) response and (again, for example, according to expert rules) the system alerts a human editor to provide creative intervention.

6. With some combination of (2611), (2612) and/or (2620) having been updated, by some combination of automatic, Al and/or human means, the process is repeated.

The iterative process—(2620), (2625), (2630—of 2631, 2632 and/or 2633), (2635), (2640), (2645), (2650), (2655—as 2656 to 2620, 2657 to 2611, and/or 2658 to 2620)—generally will continue until some stop criterium is reached. Without limitation, such criteria include:
1. That a specific number of iterations have been conducted. Then, whatever (best) results have been achieved are available for analysis and use.
2. That one or more populations have been adequately identified, with adequate identification having been specified. That is, that a demographic profile has been determined that separates the sampled audience, with sufficient sharpness, into two groups: those who do, and those who do not. Particularly for idiomorphic media (that is, publication of packages of information personalized to a user's preferences or needs) it will be important to know with a high degree of certainty that the information delivered will be welcomed by the user; and/or, also, that the service does not fail to deliver (limits of time, storage space and bandwidth notwithstanding) to a user items of interest the user would consider it a problem to miss.

For just one specific non-limiting example, such adequate identification criteria can, optionally, include false positive and false negative measurements. Such are expressible, for example as: at least 80% of those who are in the (generally the final, or from the just prior iteration) identified demographic hold a specified opinion or position, leaving no more than 20% false positives; and, no more than 8% of those who are not in identified demographic do hold the specified opinion or position (less than 8% false negatives). False negatives and/or positives are considered as part of the criteria.

Many other statistical criteria (more complex and sophisticated, specifying measurements other than false negatives and false positives, considering multiple opinions or positions, etc.) are known in the art of statistics and related arts and any or all of those are, optionally, used for any particular embodiment or use of the social editing process. These and other statistical techniques, various Al techniques, and other techniques including without limitations, genetic, hill climbing and datamining algorithms; algorithms developed for the Netflix prize; collaborative computing via the internet as is used by SETI; and otherwise, are integrated or used in combination with any aspect of the social editing process.

Generally, such an iterative run will not be open ended. If an adequately identified population is not arrived at within some limit—on the number of iterations, on the percentage of the entire audience (2630) selected for sample audiences (2640)s, or otherwise—the process will be ceased without achieving a defined success state.
3. That one or more populations of adequate size have been identified. That is to say that, particularly with traditional production and delivery of media, if a publisher does not believe there is an audience of adequate size, then the economics of publication and/or distribution may not make sense. Predicted audience size (or percentage) may be sufficient for traditional publishing, with an expectation that a potentially popular work will find its audience, optionally assisted by marketing and advertising.

However, for personalized publishing, both size and audience identification will, optionally, be considered. There is an interplay between population size and adequate identification, generally an inverse relationship. Consider, without limitation, two works. It is projected for the first that 35% of the potential audience will want to purchase or otherwise access this work; however, there has been no criteria found that will identify with any high degree accuracy who will want the work and who will not. It is projected for the second work that only 5% of the potential audience will want this work;

however, a demographic profile has been arrived at that (at least during the late phases of testing) can predict, with 98% accuracy, who will want the work and who will not.

The traditional publisher will generally be more interested in the first work because it will have a projected audience seven times as large and, it is assumed, the audience will find the work; or, will accept the work if exposed to it and they are interested in it, without being offended in any way if they are not interested.

The publisher who offers personalized media, delivering ‘only what the customer wants’ has a different perspective. If this publisher distributes the first work, he will disappoint 65% of his audience, because they are receiving a waste of their time, not what they want. This negative potentially outweighs pleasing 35% of the audience. On the other hand, the second work will only go to 5% of the audience, but 98% of that 5% will be pleased (with only 1/10 of 1% of the audience potentially disappointed); and, the other 95% of the audience will not be annoyed by an unwanted delivery. Such publishers will, generally, be open to and even want works with niche audiences; but, more so, niche works need such publishers.

Just above, the publisher relies on personalized delivery, but knows relatively little (e.g., limited to traditional demographic information such as age, gender etc.) about the audience members. For publishers using embodiments of the instant invention (including truly idiomorphic or other publication where a great deal is known about the audience members, including detailed preference information), the publisher is in a better position for making use of either work. For the first, there may not be a way to predict user interest from traditional demographics. However, this publisher will not only know age and gender, etc.; but will know, for example, that a particular user has a history of reading, purchasing, or positively reacting to, ‘ponderous tomes of fantasy and historical fiction’ and will thus be able to further refine the audience identification for either work. In particular, for the second work, this will likely greatly reduce the 1/10 of 1% who would otherwise receive the work in error; and, it will, perhaps more importantly, likely identify most of the 2% of the audience who would otherwise be missed.
4. That some more complex criteria have been reached with regard to the demographic profile (2620) including, but not limited to, example criteria such as:
   In regard to the discussion, just above, some criterium that combines audience size for the work (that is, the proportion or percentage of the total audience that has been identified as likely interested in the work in question), and the confidence of the accuracy of the demographic profile (as by false positives, false negatives or otherwise, and which will also be, for this example, expressed as a composite percentage of confidence, ranging from 0 to 100%). Thus, for example, if a criterium of a minimum of 0.16 is set for ‘size×confidence’ then: an audience estimated at 80% would be acceptable with a confidence of 20% or higher; an audience estimated at 40% would be acceptable with a confidence of 40% or higher; and. an audience estimated at 20% would be acceptable with a confidence of 80% or higher; etc.
   Criteria are, optionally, defined in terms of some one or more demographic criteria that are important to a particular entity conducting social editing. For, example, a criterium is set that the provisional demographic identify an audience segment (of women, or teen boys, of New York lawyers, or the college educated) that is at least 60% interested in the work.
Criteria are, optionally, defined in terms of a minimum level of diversity among interested audience members with regard to geographic location, age, profession, economic level, etc.
   Or, otherwise.
5. A fixed or flexible (e.g., extended if progress is being made, curtailed in the face of little or less progress) limit is optionally placed on the number of iterations to be run, the percentage of the audience (2630) used as sample audiences (2640), or otherwise. Thus, if sufficient progress toward, or achievement of, some criteria (e.g., expected audience size, confidence level of demographic profile, etc.) is not met, then the process is ended. Optionally, a request for human intervention (at any point in the process, but, particularly prior to termination) to receive a go ahead or stop instruction (or, optionally, any other adjustment in the process) is made under automatic or Al program control. A session of social editing will, optionally, fail due to: failing to find an audience of sufficient size; failing to find a demographic profile of sufficient specificity or confidence; or, failure to meet any other required specification or criteria.

Once the iterative process has run its course, the work (2610) and/or the provisional demographic profile (2620) will be in their sub-final form as updated by the iterative process. (In practice, some or all of the interim forms will also be retained for automatic and/or human review and/or comparison; and, optionally, a composite result is achieved by human and/or computer integration of results from multiple social editing sessions . . . )

The work (2610) will then, optionally, be submitted (2616) for vetting (that is, review of the work for appropriateness, propriety, or otherwise) (2660) by any combination of human, automatic computer, Al or other means. Such vetting will also, optionally, include additional editing, polishing or ‘tweaking’ of the contents (2612) and/or the meta-information (2611) of the work. In particular, for abstracted or idiomorphic works, such meta-information determines how personalized versions of the work are derived from the super-set of the work (either before or after delivery to the user system) will, optionally, be created, updated or refined, based on the results of one or more social editing sessions; other meta-information comprises content tagging information, etc. The result of such vetting and refinement (2660) is delivery (2665) of a final work (2670) which, in practice, will, optionally, be multiple forms of the work each associated with a different (potentially overlapping) demographic profile (2680).

The provisional demographic (2620) will also, optionally, go through a human and/or computer vetting and/or updating process (not shown separately from 2626) similar to that just described for the work (2610, 2616, 2660, 2665, 2670) to yield one or more final demographic profiles (2680). In particular, multiple versions of demographic profile (2680) will, optionally, be used in association with multiple versions of the work (2670) in straightforward or complex manner.

Even more particularly, when multiple works (or other items under scrutiny) undergo scrutiny by the social editing process (separately and/or in combination), an amalgam of demographic profiles will, optionally, be utilized, in order to publish, distribute or market, or otherwise in relation to, multiple works/items in an associated manner. For one non-limiting example, if a book and a film each go through the social editing process separately, and a demographic profile is generated for each, those two profiles are, optionally, computationally combined in order to arrive at a demographic profile for an audience to receive a discounted movie ticket packaged with the book. Additionally, the separate criteria for these two items will optionally, be computationally combined and an additional social editing session will be run using that composite criteria. Here, as elsewhere herein and in the parent document(s), the mathematics of probability, statistics, and related disciplines (used in this example to combine the results from diverse demographic profiles and/or the criteria), are well known to those skilled in those arts.

Finally, under many anticipated instances of the social editing process, the final demographic profile(s) (2680) will be applied to (2685) the audience (2634, shown as same as 2630) to select (2636) a final audience (2690) to which the final work (2670) is published, delivered, distributed, or otherwise exposed to or associated with (2675). It is noted that, as shown, the audience (2634, also consisting of three optional sub-sets 2631, 2632 & 2633) from which the final audience (2690) is selected (2636), is the same audience (2630) from which the social editing sample audiences (2640) were drawn (2635). However, in practice, optionally, these two audiences are completely or partially diverse; and, in particular, audience members who received the in-process work during social editing (i.e., were part of any related sample audience) will, optionally, be removed from any distribution (2675) of the final work (2670) or item.

As generally described above, the social editing process is also, optionally, used for purposes other than editing, audience identification, and analysis of media with regard to publication and distribution. The process is, optionally, run multiple times: to confirm or refine results; track results over time; gather information piecemeal which is combined and utilized in combination otherwise (including via an additional pass of social editing). The social editing process is, optionally, combined with other processes of statistics, analysis, management, editing, marketing, audience identification or otherwise.

In particular, during the operation of the social editing process, a situation may develop where an audience clusters, or splits into multiple reasonably well-defined sub-audiences. For one completely hypothetical example, early in the process of social editing analysis regarding a re-issued series of Wonder Woman comics, not surprisingly, teenaged boys—the traditional audience for super-hero comics—are found to be a large and well-defined audience. However, it also turns out that baby-boomer aged women, who recall the character from the mid-1970s television series as a pop-culture feminist icon, are also strongly interested. Rather than conduct further analysis and refinement on a combined demographic profile that, at a high level, is defined in logical terms as being ((male AND teenaged) OR (female AND baby-boomer aged)), it is, optionally, decided by the computer program controlling the social editing process, and/or a human collaborator in the process, to split the process into two separate social editing processes, each focusing on refining the demographic profile results for one of these two sub-audience segments. Such cluster analysis and other statistical and datamining algorithms are well-developed and within the ken of those skilled in the arts. Clusters can, potentially, be more than two, with an audience generally N-furcated rather than merely bifurcated. The resulting audience will, optionally, be described as a collection of separate populations each described by relatively straightforward demographic profiles; rather than as a single but disjoint audience, described by a demographic profile with a more complex logical or mathematical representation.

During operation of the social editing iterative process, elements of the process will, optionally, be modified iteration to iteration. These include, without limitation, the following examples:
A demographic category or dimension will be sampled at finer resolution (e.g., several samples each from grades 1 though 6 rather than just a few ‘pre-teens’) to determine a finer-resolution discrimination regarding age/preference. Or, alternatively, reducing the number of audience member sample categories in one dimension (i.e., age), by grouping related categories (e.g., the reverse of what was just described), in order to have more latitude to explore the differentiation along other dimensions (e.g., geographic location), or between other categories (gender vs. location vs. economic strata, vs. years of education, etc.).
The criteria (or threshold) for what constitutes a ‘match’ between a particular audience member and the demographic profile will, optionally, be tightened, loosened, or otherwise changed from iteration to iteration. This will, optionally, be in response to the demographic profile approaching (or retreating from, or remaining static) the criteria for success, the results converging or diverging, or otherwise.
The make-up of the audience (2630) from segments (2631, 2632 & 2633) will, optionally, be changed during operation of the social editing process. For example, the process will, optionally: start with the Avant Garde segment (2632) only, who have agreed to be exposed to unvetted works; include segment (2631) once (if) the work has been demonstrated to be of sufficient value; draw from auxiliary segment (2633) once a provisional demographic profile as been refined with sample audiences about which much is known. A demographic profile based on limited demographic knowledge is, optionally, extracted from the profile developed from audiences about which much is known, which will then be tested on an auxiliary segment about which relatively little is known. In particular, a benefit of conducting social editing utilizing audiences from services based on inventions described herein and in the parent document(s), is that highly useful demographic results will be derived from audiences about which much is known. Those results are then computationally flattened to a reduced demographic feature space, for use with publishers (or others) dealing with audiences or customer bases for which the demographic information available is not as rich.
An early phase of iterations will be conducted with one set of operational parameters (e.g., with broader categories, fewer dimensions, more diverse populations) while trying to search for an audience, or audience segments; and, a second set of operational parameters (e.g., with narrower categories, more dimensions, narrower populations) while trying to refine an audience, or audience segments.

Although it is also used to refine or edit the content (2612) or meta-information (2611) of a work (2610), generally, social editing is used to find and refine an audience, as embodied by the demographic profile (2680). As such it functions in some ways as a meritocracy and is akin to a passive word of mouth process. During the process, negative reviews or reactions will not necessarily be a bad result; by pruning, such will help identify and refine the definition of a receptive audience. An item may spend some time working its way through the social editing process. Once a sample audience (2640) is selected and the work (2610) delivered (2615), it may be some time before feedback (2650) arrives. Reminders will, optionally, prompt for feedback but, eventually, there will have to be some cut-off or other mechanism to deal with stragglers. As late feedback arrives, computational results will, optionally, be updated. Similarly, interim results will, optionally, be computed. As such, various iterations and sessions of social editing will, optionally, be conducted in an overlapping and interleaved fashion, as an ongoing process, or otherwise. Results not specifically related to a particular work or item (2610) will, optionally, be used as is or mined for useful trending or other information and will, optionally, be marketed as products, or reapplied as a service. In addition to publishers, authors will, optionally, use this process or service and fees will potentially be charged to enroll a work or author into the social editing process; conduct audience identification or feedback on the work; to conduct follow-up human vetting or editing; as well as to publish and distribute the work. In exchange, in addition to the services provided, if a work is published, particularly via idiomorpic or personalized publishing, micro-payments (micro-publishing) will potentially accrue to such an author for any work so published.

### SCOPE OF INTELLECTUAL PROPERTY

The reader is respectfully directed to the Copyright Notice located near the beginning of this document.

All trademark, service mark, and similar rights in and to any name, term, phrase, logo, graphic, mark or otherwise, appearing herein, including but not limited to those explicitly so marked, that are not the property of others, are hereby reserved to the inventor.

Those who practice the instant invention are those familiar with, and skilled in, arts such as: electrical, electronic, systems, computer, digital, communications (e.g., digital and analog communications network, telephone, cell phone, mobile broadband, audio, video, radio, television, broadcast, cable, etc.) and other related hardware and software engineering and design disciplines; media technology; production, programming and editing of computer media, interactive media, multimedia, computer graphic and animation, video, audio, text and other media; interactive media and human interface design; artificial intelligence, neural networks, expert systems, fuzzy logic, etc.; image processing, sound processing, speech recognition and pattern recognition; etc. Nevertheless, the inventive matter does not constitute these arts in and of themselves, and the details of these arts are within the public domain and the ken of those skilled in the arts.

The instant disclosure will not dwell on the details of system implementation in such arts but will, instead, focus on the novel designs of: systems, data structures, interfaces, processes, functions and program flows, and the novel purposes for which these are utilized.

The instant application relies on the existence of well-known systems and components including, but not limited to: personal computers; multimedia systems; systems used for the production and broadcasting or cablecasting of analog and digital media including television, audio, text, graphics, multimedia and interactive media; the use of VBI, SAP and other ‘piggybacked’ signals; delivery of information via communications networks, including the internet, television, cable, satellite, telephone, cellphone, mobile broadband, etc.; optical and magnetic recording of analog and digital signals, including computer, video and other media and information; settop boxes, advanced, digital and HDTV televisions, multimedia computers, telephones, cellphones, smart phones, PDAs, portable audio, video, eBook and other media players, and other consumer electronic devices including TiVo, Replay, DVRs, video-on-demand, the ‘V-Chip’, etc.; professional and home Intercast (VBI insertion/detection) equipment; ‘digital video library’ and other multimedia access and search systems; systems, software and practice for video editing, database operation, server and client operation, video and media players and displays, communications, wireless telephony, electronic and mobile commerce, etc.; and, other related devices and technologies, and those which may be substituted for them. In fact, off-the-shelf devices, systems and software, now available, such as internet connected computers, video editing and encoding/decoding systems, database systems, wireless telephony equipment, and the like, with little to no modification, provide all the necessary elements, except for some additional software control functions, and system organization and operation, to perform many of the embodiments, as described herein; and, the necessary modifications and/or additions are within those skilled in the appropriate arts.

The intended scope of the instant invention also includes the combination with other related technologies, now in existence or later developed, which may be combined with, or substituted for, elements of the instant invention.

The designs, systems, algorithms, program flows, layouts, organizations, functions and business relationships described and depicted herein are exemplary. Some elements and/or steps may be ordered or structured differently, combined within a single step or element, separated into multiple steps or elements, skipped or omitted entirely, or accomplished in a different manner. However, the elements and embodiments depicted and described herein do work. Substitution of equivalent technologies, or combination with other technologies, now in existence or later developed, are within the scope of the instant invention. Examples, without limitation, include: analog and digital technologies; functional operation implemented in special purpose hardware and general purpose hardware running control software; magnetic and optical recording; computer and television display; various types of telephones, cellphones, smart phones; clickable links, macros, key combinations, key shortcuts, gesture recognition, other interactive widgets and mechanisms; etc.

The details of: engineering, implementation and construction of systems; creation of program, media, video, edit decision list, database, tagging, and auxiliary information; delivery of program and auxiliary information; and, implementation of the operation, and human interface of, various functions; described herein are, generally, not, in and of themselves, the substance of the instant invention. Substitutions of, variations on, and combinations with, other processes, designs and elements, now in use or later developed, is considered to be within the scope of the invention.

The use of various functions, systems, components, processes, steps and other elements, now known or later developed, to: provide support for; provide enhancement of; provide related or equivalent functionality to; or, otherwise be used in combination with or substitution for; the various embodiments, functions, systems, components, processes, steps and other elements described in the instant document and/or its parent documents; is within the scope of the invention.

The use of any combination of the various embodiments, functions, systems, components, processes, steps and other elements described in the instant document and/or its parent documents, in combination with and/or substitution for any other combination of the various embodiments, functions, systems, components, processes, steps and other elements described in the instant document and/or its parent documents, is within the scope of the invention.

The use of the various embodiments, functions, systems, components, processes, steps and other elements described in the instant document and/or its parent documents, for novel purposes and/or in novel situations, other than those specifically described in the instant document and/or its parent documents, is within the scope of the invention.

To some extent, extant capabilities described in the art using various terms will seem to, or in fact will, overlap to some degree the capabilities described herein using concepts or terms including, but not limited to: interactive, hyper-media, meta data, meta-media, meta-information, meta-processing, metamorphic, idiomorphic, social publishing, social editing, data mining, collaborative computing, intelligent computing, granular, granulated, pyramidal, aggregation, abstraction, filter, funnel, emulsified, and/or otherwise. To whatever extent embodiments described herein utilize novel elements, or use extant elements in novel ways, those embodiments are intended to be within the scope of the instant invention.

It will thus be seen that the objects set forth above, among those made apparent from the preceding description, are efficiently attained and certain changes may be made in carrying out the above method and in the construction set forth. Accordingly, it is intended that all matter contained in the above description or shown in the accompanying figures shall be interpreted as illustrative and not in a limiting sense.

Now that the invention has been described, what is claimed as new and desired to be secured by Letters Patent is:

1-14. (canceled)

15. A process for providing a granular presentation comprising:
a. breaking a presentation into segments substantially tailored to the expected length of inciting conditions, such that segment boundaries occur in a manner or at a point that is not cognitively dissonant; and,
b. substantially synchronizing the presentation of segments with inciting conditions.

16. The process of claim 15, wherein said presentation is the presentation of media.

17. The process of claim 16, wherein said presentation comprises at least in part advertising information.

18. The process of claim 15, wherein said presentation is the operation of a computer program.

19. The process of claim 15, wherein said presentation continues with one or more grains, until the end of a last grain, even if the end of said last grain continues beyond the end of said inciting condition.

20. A product comprising the information produced by the process of claim 16 made available via a tangible information bearing medium.

21. A system for providing a granular presentation comprising:
a. a system component capable of sensing the bounds of inciting conditions; and,
b. a system component capable of displaying segments of granular media in a manner substantially synchronized with said inciting conditions.

22. A process for utilizing an interstitial channel by providing segments of a presentation in an intermittent manner that is substantially synchronized with the start and stop of inciting conditions.

23. The process of claim 22, wherein said presentation is a granular presentation.

24. The process of claim 22, wherein said inciting conditions are delays in operation of a user interface on a computer system.

25. The process of claim 22, wherein said inciting conditions are advertisements displayed on a computer system.

26. A system for avoiding audiovisual advertisements on a computer system comprising:
a. a system component capable of sensing the presentation of displayed advertisements; and,
b. a system component capable of providing alternative presentations, comprising at least in part non-advertising granular content, substantially synchronized with said displayed advertisements.

27. The system of claim 26 comprising, in addition:
c. a system component capable of diminishing audio associated with said presentation of displayed advertisements, while presenting a fuller-volume audio presentation associated with said alternatively provided presentations.

28. A process for utilizing meta-media, which itself comprises both content and meta-information, comprising:
a. associating said meta-information with additional information regarding a particular user to create idiomorphic information; and,
b. using said idiomorphic information to selectively present a sub-set of said content to said user.

29. The process of claim 28, wherein:
c. said meta-information comprises at least in part information describing the content of said meta-media;
d. said information regarding a particular user comprises at least in part user information regarding said particular user's interest in particular elements of content; and,
e. said idiomorphic selection results in the presentation of a sub-set of content determined to closely match said particular user's interests.

30. A process for social publishing comprising:
a. creating a provisional target demographic profile;
b. using said provisional target demographic profile to select from a social audience a sample social sub-audience;
c. providing a work to be socially edited to said sample social sub-audience;
d. collecting feedback from said sample social sub-audience regarding said work;
e. using said feedback to update at least some element of said system;
f. conducting at least one additional iteration of steps b through e.

31. The process for social publishing of claim 30, wherein:
g. the at least some element of step e relates to updating said target demographic profile.

32. The process for social publishing of claim 30, wherein:
g. the at least some element of step e relates to updating the content said work.

33. The process for social publishing of claim 30, wherein:
g. the at least some element of step e relates to updating meta-information associated with said work.

34. The process for social publishing of claim 30, further comprising that:
g. said iterations are computationally conducted with the goal of progressively refining said targeted demographic profile to optimize feedback from said sample social sub-audience.

35. The process for social publishing of claim 34, further comprising that:
h. said iterative process is continued until either:
h1. a limit has been reached on the number of iterations conducted without having achieved a sufficiently optimized resulting feedback from said sample social sub-audience; or,
h2. a sufficiently optimized resulting feedback from said sample social sub-audience has been achieved.

36. The process for social publishing of claim 35, further comprising that:
i. in the event that condition h2 is met, one or more socially published versions of said work are offered to the members of a larger social audience who meet a sufficiently matching sub-set of the criteria associated with the target demographic profile associated with a particular version of said socially published work.

37. The process for social publishing of claim 36, further comprising that:
j. at least some of those offered the work in step i, are charged a payment in exchange for accessing said work.
